(19) United States
(12) Patent Application Publication
(10) Pub. No.: US 2024/0400468 A1
(43) Pub. Date: Dec. 5, 2024

(54) Bionutritional Compositions for Plants and Soils

(71) Applicant: EnviroKure, Incorporated, Philadelphia, PA (US)

(72) Inventors: Sushil K Bhalla, Schwenksville, PA (US); Devon K Hooper, Leesburg, NJ (US); Sonia Rae Nofziger-Dasgupta, Philadelphia, PA (US)

(73) Assignee: EnviroKure, Incorporated, Philadelphia, PA (US)

(21) Appl. No.: 18/292,275

(22) PCT Filed: Jul. 27, 2022
(86) PCT No.: PCT/US22/38541

§ 371 Date: Jan. 25, 2024

Related U.S. Application Data
(60) Provisional application No. 63/226,631, filed on Jul. 28, 2021.

(51) Int. Cl. C05F 3/00; C05F 11/08; C05F 17/20

(52) U.S. Cl. CPC C05F 3/00; C05F 11/08; C05F 17/20

(57) ABSTRACT

Bionutritional compositions for plants and soils, such as liquid biostimulant compositions and emulsified compositions or solid biofertilizer compositions, produced from animal manure are disclosed. Also disclosed are processes for manufacturing such bionutritional compositions. The processes include the delivery of pure oxygen or oxygen-enriched air to aqueous animal waste slurry and further include subjecting the aqueous animal waste slurry to an autothermal thermophilic aerobic bioreaction (ATAB). The processes may also include a separation step to separate the digested or decomposed animal waste composition after ATAB into a substantially liquid component and substantially solid component, each capable of being further processed to produce a biostimulant composition and biofertilizer composition, respectively. Also disclosed are methods of using the bionutritional compositions for promoting plant health or conditioning soil.

### CROSS REFERENCE TO RELATED APPLICATIONS

This claims benefit of U.S. Provisional Application No. 63/226,631, filed Jul. 28, 2021, the entire contents of which are incorporated by reference herein.

### FIELD OF THE INVENTION

The present invention relates generally to fertilizers and compositions useful for promoting plant growth and healthy soil structure. In particular, bionutritional compositions containing biofertilizer and biostimulant properties are provided.

### BACKGROUND OF THE INVENTION

Two main categories of crop input products are used in agriculture: fertilizers and pesticides. A fertilizer is typically described as any organic or inorganic material of natural or synthetic origin that is added to supply one or more nutrients essential to the growth of plants. Fertilizers provide, in varying proportions, the macronutrients, secondary nutrients, and micronutrients required or beneficial for plant growth.

During the last century, there has been extensive use of synthetic fertilizers and pesticides in agriculture. It is now well recognized that the use of synthetic fertilizers adversely impacts the biological properties of soil diminishing its ability to support plant productivity. In addition, the adverse impacts of these chemicals on environment and humans are being recognized (see, e.g., Weisenberger, D. D., 1993, “Human Health Effects of Agrichemical Use,” Hum. Pathol. 24 (6): 571-576). Moreover, numerous studies have shown that as soil carbon declines, significant increases in chemical fertilizers are needed to maintain yields, while leaving an estimated 67% of seed potential unrealized (see, e.g., Mulvaney R. L., et al., 2009, J. Environ. Qual. 38 (6): 2295-2314; Tollenaar, M., 1985, Proceedings of the Conference on Physiology, Biochemistry and Chemistry Associated with Maximum Yield Corn, Foundation for Agronomic Research and Potash and Phosphate Institute. St. Louis, MO, 11-12; NASS Crop Production 2017 Summary (U.S.D.A. 2018)). Accordingly, the recognition of the often-detrimental effect of synthetic fertilizers and pesticides on soil ecology has provided impetus for expanding interest in sustainable and regenerative crop production, including the use of fertilizers, soil stimulants, and pesticides of natural and/or biological origin. Thus, the need for improvements in agriculture and crop protection is apparent in both the organic and conventional agriculture sectors and highlights the need for biologic treatments that can replace or supplement conventional synthetic fertilizers or be used in combination with conventional chemical herbicides/pesticides to maximize crop yield while maintaining soil integrity.

One class of materials being considered for use in the agricultural industry as an alternative and/or supplement to synthetic fertilizers are agricultural biologics, such as biostimulants, biofertilizers, and biopesticides. Biofertilizers and biostimulants are used in the agricultural industry to add nutrients to plants and soil through the natural processes of nitrogen fixation, phosphorus solubilization, and plant growth stimulation through the synthesis of growth-promoting substances. Broadly, biostimulants comprise substances that stimulate existing biological and chemical processes in the plants or soil, whereas biofertilizers are materials of biological origin that contain sufficient levels of plant nutrients. Biostimulants are products that reduce the need for chemical fertilizers and increase plant growth, resistance to drought as well as biotic and abiotic stresses. In small concentrations, these substances are efficient, favoring the good performance of the plant's vital processes, and allowing high yields and good quality products. In addition, biostimulants applied to plants enhance nutrition efficiency, biotic stress tolerance, abiotic stress tolerance, and/or plant quality traits, regardless of its nutrient contents. Likewise, biofertilizers can also be expected to reduce the use of chemical fertilizers and pesticides and, in conventional farming, be used in combination with pesticides to reduce, e.g., chemical-induced stress on the plants themselves. The microorganisms in biofertilizers restore the soil's natural nutrient cycle to improve nutrient availability for plants and build soil organic matter. Through the use of biofertilizers, healthy plants can be grown, while enhancing the sustainability and the health of the soil. In addition, certain microorganisms referred to as plant growth promoting rhizobacteria (PGPR) are extremely advantageous in enriching soil fertility and fulfilling plant nutrient requirements by supplying the organic nutrients through microorganisms and their byproducts.

In addition to conferring benefits to the soil and rhizosphere, PGPRs can influence the plant in a direct or indirect way. For instance, they can increase plant growth directly by supplying nutrients and hormones to the plant. Examples of bacteria which have been found to enhance plant growth, include certain mesophiles and thermophiles, including thermophilic members of genera such as Bacillus, Ureibacillus, Geobacillus, Brevibacillus and Paenibacillus, all known to be prevalent in poultry manure compost. Mesophiles reported to be beneficial for plant growth, include those belonging to the genera Bacillus, Serratia, Azotobacter, Lysinibacillus and Pseudomonas.

PGPRs are also able to control the number of pathogenic bacteria through microbial antagonism, which is achieved by competing with the pathogens for nutrients, producing antibiotics, and the production of anti-fungal metabolites. Besides antagonism, certain bacteria-plant interactions can induce mechanisms in which the plant can better defend itself against pathogenic bacteria, fungi and viruses. One mechanism is known as induced systemic resistance (ISR), while another is known as systemic acquired resistance (SAR) (see, e.g., Vallad, G. E. & R. M. Goodman, 2004, Crop Sci. 44:1920-1934). The inducing bacteria trigger a reaction in the roots that creates a signal that spreads throughout the plant, resulting in the activation of defense mechanisms, such as reinforcement of the plant cell wall, production of antimicrobial phytoalexins and the synthesis of pathogen related proteins. Some of the components or metabolites of bacteria that can activate ISR or SAR include lipopolysaccharides (LPS), flagella, salicylic acid, and siderophores. Thus, there remains a need for nutrient- and PGPR-rich biofertilizers.

In addition to containing PGPR, biofertilizers may contain other types of bacteria, algae, fungi, or a combination of these microorganisms and include nitrogen fixing microorganisms (e.g., Azotobacter, Clostridium, Anabaena, Nostoc, Rhizobium, Anabaena azollae, and Azospirillum), phosphorous solubilizing bacteria and fungi (e.g., Bacillus subtilis, Psuedomonas striata, Penicillium sp., Aspergillus awamori), phosphorous mobilizing fungi (e.g., Glomus sp., Scutellospora sp., Laccaria sp., Pisolithus sp., Boletus sp., Amanita sp., and Pezizella ericae), and silicate and zinc solubilizers (e.g., Bacillus sp.). However, while biofertilizers may increase the availability of plant nutrients and contribute to soil maintenance as compared to conventional chemical fertilizers, finding cost-effective ways to produce biofertilizers enriched with a suitable population of beneficial microorganisms that are free from microbial contamination and other contaminants and that can be used with existing application methods and technology remains a relatively unmet need in the industry.

One particular source of biofertilizer and biostimulant compositions is animal waste. Indeed, animal manure and, in particular, nutrient- and microbe-rich poultry manure, has been a subject of extensive research regarding its suitability as a biofertilizer. It has been shown through academic research and on-farm trials that poultry manure can provide all the macro and micronutrients required for plant growth, as well as certain plant growth promoting rhizobacteria. However, these benefits are contingent on the elimination of plant and human pathogens that are associated with chicken manure. Moreover, significant concerns from the use of raw manure include increased potential for nutrient run off and leaching of high soil phosphorous, as well as transmittal of human pathogens to food. Importantly, U.S. producers and farmers alike must ensure that their manure-based biofertilizers meet the stringent safety regulations for unrestricted use of a manure-based input promulgated by the FDA. See, for example, 21 C.F.R. § 112.51 (2016).

Another issue negatively impacting the agricultural industry is field contamination by weed seeds. Further, manure-based application, especially raw manure application, may actually contribute to weed seed contamination as undigested weed seeds may be present in the animal waste (see Katovich J. et al., “Weed Seed Survival in Livestock Systems,” U. Minn. Extension Servs. & U. Wis. Extension, available at https://www.extension.umn.edu/agriculture). Weed seed contamination often leads to reduced crop yields prompting the need for increased application of chemical herbicides, which may have a negative impact on both plant and human health. Weed seed contamination is especially problematic in the organic agriculture industry where the application of synthetic herbicides is not permitted forcing famers to rely on mechanical cultivators to control weed growth. As composting has been shown to reduce the total volume of runoff and soil erosion as well as the potential for pathogen and weed seed contamination, many states now require poultry manure to be composted prior to field application, leading to advances in composting processes.

Composting can be described as the biological decomposition and stabilization of organic material. The process produces heat via microbial activity, and produces a final product that is stable, substantially free of pathogens and weed seeds. As the product stabilizes, odors are reduced and pathogens eliminated, assuming the process is carried to completion. Most composting is carried out in the solid phase.

The benefits of composting include: (1) enriching soil with PGPR, (2) reduction of microbial and other pathogens and killing of weed seeds; (3) conditioning the soil, thereby improving availability of nutrients to plants; (4) potentially reducing run-off and soil erosion; (5) stabilizing of volatile nitrogen into large protein particles, reducing losses; and (6) increasing water retention of soil. However, the process is time consuming and labor intensive. Moreover, composting is not without significant obstacles including: (1) the requirement for a large surface area for efficient composting; (2) the need for heavy equipment to “turn” piles for thorough composting for commercial use; (3) difficulty in maintaining consistent, proper carbon to nitrogen ratios; (4) the need for uniform heating; (5) transportation of the bulky final product; and (6) the lack of consistency in the product and its application. Additionally, because nutrients are applied in bulk prior to planting, there is a significant potential for nutrients to be lost through run-off. There is also a significant potential for inconsistent decomposition and incomplete pathogen destruction. Furthermore, uneven nutrient distribution in field application is a concern. Lastly, solid compost cannot be used in hydroponics and/or through drip irrigation.

With regard to this last drawback, organic and conventional growers alike have utilized compost leachate (compost tea) as a liquid biostimulant. The leachate is produced by soaking well-composted material in water and then separating the solid from the liquid fraction. While such liquid material can be utilized in drip irrigation or foliar application, its production remains time-consuming and labor intensive, and the liquid product suffers from the same drawbacks as solid compost in that it may still contain pathogenic organisms and its nutrient content is inconsistent. Thus, any residual pathogenic organisms present in the compost tea presents a risk for pathogen replication and contamination and thus may not pass muster under the applicable and stringent federal health and safety regulations.

Some organic fertilizers include fish-based and plant protein-based fertilizers. Fish emulsion products are typically produced from whole salt-water fish and carcass products, including bones, scales and skin. The fish are ground into a slurry, then heat processed to remove oils and fish meal. The liquid that remains after processing is referred to as the fish emulsion. The product is acidified for stabilization and to prevent microbial growth. Fish hydrolysate fertilizers are typically produced from freshwater fish by a cold enzymatic digestion process. While fish fertilizers can provide nutritional supplementation to plants and soil microorganisms, they are difficult to use, in part due to their high acidity and oil-based composition in some instances, which can clog agricultural equipment. Plant protein-based fertilizers are typically produced by hydrolysis of protein-rich plant materials, such as soybean, and are an attractive alternative for growers and gardeners producing strictly vegan products, for instance. However, due to their sourcing, these products can be expensive. Organic fertilizers produced from seaweed are lacking in macronutrients. Furthermore, none of the above-described fertilizers is naturally biologic: beneficial microorganisms must be added to them.

Nutrient rich liquid and solid biofertilizers can be produced from poultry manure by utilizing aerobic microorganisms that break down the undesired organic materials, such as the processes described in U.S. Pat. No. 9,688,584 B2 and international patent application publication No. WO 2017/112605 A1. However, existing methods of processing poultry manure to produce biofertilizers suffer from a number of drawbacks that include incomplete decomposition of organic matter resulting in poor stability and excess foaming of the bioreactor equipment. The latter causes significant disruption of airflow and subsequent incomplete decomposition of organic material, which typically results in a liquid fertilizer product that clogs sprayers and other field application equipment thereby disrupting farming program operations and increasing costs. In addition, incomplete decomposition of organic material results in final bionutritional products with decreased microorganisms/growth-promoting compounds. Moreover, prior techniques using ATAB followed by centrifugation (e.g., U.S. Pat. No. 9,688,584 B2 and international patent application publication Nos. WO 2017/112605 A1 and WO 2020/028403 A1) produce solid fertilizer products with insufficient microorganisms/growth promoting-compounds to be classified as a biofertilizer.

Thus, there remains a need in the art for more efficient processes for the manufacture of biologically-derived products in both liquid and solid form, which can provide superior plant nutrition, biostimulation, soil conditioning, and improve soil biodiversity while at the same time being safe, easy to use and cost-effective. Such bionutritional compositions would provide highly advantageous alternatives to synthetic products currently in use, such as diammonium phosphate, monoammonium phosphate, and urea-ammonium nitrate, and would satisfy growers' requirements for standardization and reliability.

### SUMMARY OF THE INVENTION

Described herein are bionutritional compositions for application to plants and soils. In particular, these compositions are produced by subjecting an animal waste slurry to an autothermal thermophilic aerobic bioreaction (ATAB) and, optionally separating into a liquid fraction and a solid fraction to produce a liquid biostimulant and solid biofertilizer, respectively. The resulting liquid biostimulant also exhibits biofertilizer properties, while the biofertilizer exhibits biostimulant properties. The resulting bionutritional compositions will exhibit increased amounts of macronutrients, micronutrients, metabolic compounds, and diverse microorganisms supportive of plant growth and soil health as compared to products current being produced using existing methods.

One aspect of the invention features a composition for application to plants and soils. This composition comprises an autothermal thermophilic aerobic bioreaction product produced from a solid or liquid fraction of poultry manure, wherein the composition endogenously comprises at least one plant growth-promoting microorganism and a total microbial biomass comprising at least about 20% Gram positive bacteria. In some embodiments, the composition contains a ratio of Gram positive to Gram negative bacteria of about 10:1. In other embodiments, the total microbial biomass of the composition comprises at least about 20% fungi. In one exemplary embodiment, the total microbial biomass comprises at least about 20% fungi and at least about 30% gram positive bacteria. The composition may also contain a total biomass of at least about 10% saprophytic fungi.

In one embodiment, the composition is a liquid biostimulant composition, which may endogenously comprise at least about 12% dry wt Total Kjeldahl nitrogen and at least about 2% by wt carbon. In another embodiment, the composition endogenously comprises at least about 4% dry wt organic nitrogen and at least about 10% dry wt potash. In yet another embodiment, the liquid biostimulant composition comprises less than about 5% dry wt P₂O₅.

In another embodiment, the composition is a solid biofertilizer composition. The solid biofertilizer composition may endogenously comprise at least about 7% dry wt Total Kjeldahl nitrogen and at least about 2% by wt carbon, or at least about 2% dry wt organic nitrogen and at least about 3% dry wt potash. In yet another embodiment, the solid biofertilizer composition endogenously comprises less than about 8% dry wt P₂O₅.

In some embodiments, the at least one plant growth-promoting microorganism is one or more of Actinomycetota, Bacteroidetes, Firmiicutes, Proteobacteria, Gammaproteobacteria, Thermotogae, Spirochaetes, Verrucomicrobia, Deinococcus or a combination thereof, and may have minimal concentration of these microorganisms, such as, but not limited to Actinomycetota bacteria in a concentration of at least about 1% by wt, Bacteriodetes bacteria in a concentration of at least about 0.5% by wt, Firmiicutes bacteria in a concentration of at least about 30% by wt, Proteobacteria bacteria in a concentration of at least about 1% by wt, Gammaproteobacteria bacteria in a concentration of at least about 1% by wt, Thermotogae bacteria in a concentration of at least about 0.5% by wt, Spirochaetes bacteria in a concentration of at least about 0.25% by wt, and/or Verrucomicrobia bacteria in a concentration of at least about 0.25%.

In another embodiment, the at least one plant growth-promoting microorganism is one or more of Bacillus, Clostridium, Thermoanaerobacter, Pseudomonas, Acidobacterium, Actinomyces, Enterobacteriaceae, or any combination thereof, and may have minimal concentration of these microorganisms, such as, but not limited to Bacillus bacteria in a concentration of at least about 25% by wt, Clostridium bacteria in a concentration of at least about 25% by wt, Thermoanaerobacter bacteria in a concentration of at least about 1% by wt, Pseudomonas bacteria in a concentration of at least about 0.1% by wt, Acidobacterium bacteria in a concentration of at least about 0.05% by wt, Actinomyces bacteria in a concentration of at least about 1% by wt, and/or Enterobacteriaceae bacteria in a concentration of at least about 0.5% by wt. In a particular embodiment, the at least one plant growth promoting microorganism is selected from the group consisting of Bacillus butanolivorans, Bacillus cellulosilyticus, Bacilus coagulans, Bacillus foraminis, Bacillus thuringiensis, Bacillus polymyxa, Bacillus sp Pc3, Bacillus cereus C1L, Bacillus ligininiphilus, Bacillus aryabhattai, Bacillus glycinifermentans, Bacillus mycoides, Geobacillus kaustophius, Clostridium novyi NT, Clostridium tyrobutyricum, Clostridium indolis, Clostridium sticklandii, Actinomyces howellii, Actinomyces gaoshouyii, Azospirillum thiophilum, Azospirillum brasilense, Azotobacter chroococcum, Streptomyces adustus, Streptomyces aegyptia, and/or Streptomyces amphotericinicus, and any combination thereof.

The compositions provided herein may also comprise one or more compounds selected from the group consisting of N-acetylhistamine, L-Valine, tetramethyl-2,5-dihydro-1H-pyrrole-3-carboxamide, 1-(4-aminobutyl) urea, isopelletierine, 1-(4-aminobutyl) urea, 3-amino-2-piperidinone, acetophenone, L-alanyl-L-proline, Alanine-Proline dipeptide, Proline-Proline dipeptide, uric acid, methylguanidine, 3-hydroxy-2-methylpyridine, δ-valerolactam, O-ureido-D-serine, nicotinyl alcohol, (R,S)-anatabine, carnitine, 10-nitrolinoleate, N-methylhexanamide, N6-methyl lysine, dehydroascorbic acid, glutamic acid, malic acid, N-acetyl-L-glutamic acid, Serine-Serine dipeptide, moniliformin, cinnamic acid, citric acid, nicotinamide, chrysin, juvabione, orotic acid, resolvin D1, diprogulic acid, curacin A, putrescine, abscisic acid, dihydroxyphenylalanine, anticapsin, prohydrojasmon, 2-methylcitric acid, 1,3-nonanediol acetate, 2-O-ethyl ascorbic acid, Leucine-Leucine dipeptide, vitamin C, 3-sulfolactic acid, 4-nitrocatechol, itaconic acid, and any combination thereof. In some aspects, the compound is present in the composition at a peak area of at least about 1×10³ as measured by hydrophilic interaction liquid chromatography followed by mass spectroscopy.

Another aspect of the invention features a method of improving health or productivity of a selected plant or crop, which includes the steps of: a) selecting a plant or crop for which improved health or productivity is sought; b) treating the plant or crop with the composition described above; c) measuring at least one parameter of health or productivity in the treated plant or crop; and d) comparing the at least one measured parameter of health or productivity in the treated plant or crop with an equivalent measurement in an equivalent plant or crop not treated with the composition. With this method, an improvement in the at least one measured parameter in the treated, as compared to the untreated, plant or crop is indicative of improving the health or productivity of the selected plant or crop.

In some embodiments of the method, the at least one parameter of health or productivity in the plant or crop is selected from germination rate, germination percentage, robustness of germination, root biomass, root structure, root development, total biomass, stem size, plant height, leaf size, flower size, crop yield, structural strength/integrity, photosynthetic capacity, time to crop maturity, yield quality, resistance or tolerance to stress, resistance or tolerance to pests or pathogens, and any combination thereof. In other embodiments, the plant or crop is grown in accordance with an organic program and the composition is approved for use in the program.

In another aspect, a method of conditioning a selected soil is provided that includes the steps of: a) selecting a soil for which conditioning is sought; b) treating the soil with the composition described above; c) measuring at least one parameter of conditioning in the treated soil; and d) comparing the at least one measured parameter of conditions in the treated soil with an equivalent measurement in an equivalent soil not treated with the composition, or before treatment with the composition. In this method, an improvement in the at least one measured parameter in the treated, as compared with the untreated soil, or with the soil prior to treatment, is indicative of conditioning the selected soil. In some embodiments, the selected soil is one in which plants or crops are or will be planted.

Other features and advantages of the invention will be apparent by references to the drawings, detailed description and examples that follow.

### BRIEF DESCRIPTION OF THE DRAWINGS

FIG. 1 is a block-diagram of an exemplary embodiment of bionutritional composition production process. The dotted lines indicate optional steps.

FIG. 2 are Principal Component Analysis (PCA) biplots comparing the Gen2-T113 liquid biostimulant composition with the Gen1 liquid biostimulant composition for both HILIC positive mode (panel A) and negative mode (panel B).

FIG. 3 is a bar graph showing the total bacterial DNA content in raw manure, the Gen1 liquid biostimulant composition, and the Gen2-T113 liquid biostimulant composition. The y-axis represents ng of DNA/gram of composition.

FIG. 4 is a graph showing the bacterial CFU per gram of soil over time. The x-axis shows the time after application of either water (dotted line), the Gen2-T113 liquid biostimulant composition (solid line), or Glucose solution (light gray line). The no treatment control is depicted as the dashed line. The application rate is 5 gallons per acre. The y-axis represents bacterial CFU per gram of soil.

FIG. 5A is a bar graph showing the bacterial CFU for Flavobacterium (light gray bar), Pseudomonas (slightly darker gray bar), Bacillus (dark gray bar), and Clostridium (black bar) in soil after treatment with water (left) or 5 gallons per acre of the Gen2-T113 liquid biostimulant composition (right). The y-axis represents bacterial CFU per gram of soil.

FIG. 5B is a bar graph showing the bacterial CFU for Azotobacter in soil after treatment with water (gray bar) or 5 gallons per acre of the Gen2-T113 liquid biostimulant composition (black bar). The y-axis represents bacterial CFU per gram of soil.

FIG. 5C is a bar graph showing the bacterial CFU for Rhizobium in soil after treatment with water (gray bar) or 5 gallons per acre of the Gen2-T113 liquid biostimulant composition (black bar). The y-axis represents bacterial CFU per gram of soil.

FIG. 5D is a bar graph showing the bacterial CFU for Azospirillium in soil after treatment with water (gray bar) or 5 gallons per acre of the Gen2-T113 liquid biostimulant composition (black bar). The y-axis represents bacterial CFU per gram of soil.

FIG. 5E is a bar graph showing the bacterial CFU for Streptomyces in soil after treatment with water (gray bar) or 5 gallons per acre of the Gen2-T113 liquid biostimulant composition (black bar). The y-axis represents bacterial CFU per gram of soil.

FIG. 6 is a line graph showing the acid phosphatase activity over time in soil treated with water (dashed line) or 5 gallons per acre of the Gen2-T113 liquid biostimulant composition (black line). The y-axis represents the micromoles of pNP detected, whereas the x-axis represents the number of days following treatment.

FIG. 7 is a bar graph showing radish height after four days of treatment with slurry centrate (no ATAB treatment), Gen 1 liquid biostimulant composition, commercial seaweed fertilizer, slurry centrate (1 hour ATAB), solid biofertilizer, and the Gen2 liquid biostimulant composition. The first round of experiments are shown by the black bars, while the second round of experiments are shown by the white bars. The y-axis represents height in inches. For each data set, n=25.

### DETAILED DESCRIPTION OF THE INVENTION

Described herein are liquid and solid bionutritional compositions having biostimulant and biofertilizer properties. In general, the liquid compositions described herein can be referred to as biostimulants with biofertilizer properties, whereas the solid compositions described herein can be referred to as biofertilizers (i.e., high content of plant nutrients) with biostimulant properties. Therefore, while the terms “biostimulant” and “biofertilizer” are used herein to identify the liquid compositions and solid compositions, respectively, it should be understood that both the liquid and solid compositions of the invention have biostimulant and biofertilizer properties.

These compositions described herein may be produced from animal manure and related waste products as a starting material. Moreover, the present disclosure provides a production process capable of generating an emulsified biofertilizer as well as microbial- and nutrient-rich liquid biostimulant and solid biofertilizer compositions that are environmentally safe and fully compatible across all precision agricultural application systems for use in the organic, conventional, and regenerative agricultural industries. In turn, the compositions produced by the processes described herein include biofertilizers and biostimulants that allow for enhanced recycling of nutrients and the regeneration of soil carbon sources as compared to chemical fertilizers.

In particular embodiments, the starting material comprises poultry manure. The process described herein includes subjecting an animal waste slurry to an autothermal thermophilic aerobic bioreaction (ATAB) with the delivery of pure oxygen or oxygen-enriched air to the liquid stream or component. The inventors have discovered a process to subject an animal waste slurry to microbial digestion/decomposition without first having to separate the slurry into liquid and solid streams while still achieving sufficient decomposition of the waste material. Importantly, the ability to subject the entire slurry to the ATAB process and maintain sufficient thermophilic conditions for a sufficient period of time (e.g., at least 72 hours at a temperature of at least about 55° C.) enables the production of both solid and liquid products that meet the requirements of the National Organic Program and FDA Produce Food Safety requirements.

Moreover, the inventors have combined this innovation with replacement of conventional aeration or other methods that utilize atmospheric sources of oxygen with a pure or enriched-oxygen source reduces the production of foam during the ATAB. The use of pure or enriched-oxygen allows for enhanced oxygen utilization during the ATAB, thereby reducing evaporation, which in turn results in reduced thermal losses, increased operating temperature range, and higher operating temperature thereby increasing organic material decomposition that results in a liquid fertilizer product with increased stability and shelf-life that is less likely to clog or plug spray devices during field application and increased production of plant growth-promoting microbial compounds. Additionally, the injection of pure oxygen or oxygen-enriched air into the animal waste composition during initial mixing and stabilization prior to separation prevents formation of undesired compounds formed from microbial anaerobic fermentation, including the toxic and odor-causing hydrogen sulfide, typically found in animal wastes. Thus, the inventors have integrated enhanced oxygen delivery and more efficient microbial digestion/decomposition of a homogenized animal waste slurry to enable the production of a variety of bioorganic products.

To illustrate further, after subjecting the animal waste slurry to ATAB, the digested animal slurry material can then be further processed into a general-purpose emulsified biofertilizer or, alternatively, separated into a liquid fraction and a solid fraction to produce specialty liquid biostimulants and solid biofertilizers, respectively. The inventors have discovered that subjecting the animal waste slurry to the ATAB prior to any separation allows for the production of a general-purpose emulsified biofertilizer with increased shelf-life, micro/macro nutrients, plant and soil beneficial aerobic bacteria, and metabolic compounds as compared to only subjecting a separated liquid fraction to ATAB. Moreover, in some situations, additional steps of degritting and particle size reduction prior to the ATAB enhances the efficiency of the microbial digestion of the animal waste composition during the ATAB process. Further, the digested animal waste slurry can be separated following digestion to produce both a liquid biostimulant product as well as a solid biofertilizer product, each with higher levels of plant and soil beneficial aerobic bacteria, Gram positive bacteria, beneficial fungi, Nitrogen, and other plant nutrients and metabolic compounds for enhancing biostimulant activity in plants as compared to the products made with processes currently existing in the art.

An exemplary animal waste suitable for use herein is avian manure and, in particular, poultry manure. Avian manure tends to be very high in nitrogen, phosphorous, and other nutrients, as well as comprising a robust microbial community, that plants require for growth and is therefore suitable for use in embodiments of the present invention. Shown in Table 1 is a comparison of typical nutrient and microbial content contained in manure from several different poultry species.

TABLE 1
Poultry manure nutrients analysis (source: Biol. & Agric. Eng. Dept. NC State University,
January 1994; Agronomic Division, NC Dept of Agriculture & Consumer Services)

| | Unit | Chicken | | | | | |
|---|---|---|---|---|---|---|---|
| Parameter | (mean) | Layer | Broiler | Breeder | Turkey | Duck | Range |
| Moisture | % wet basis | 75 | 21 | 31 | 27 | 63 | 25-79 |
| Volatile | % dry basis | 74 | 80 | 43 | 73 | 66 | 43-80 |
| Solids | | | | | | | |
| TKN | lb/ton | 27 | 71 | 37 | 55 | 17 | 17-71 |
| NH₃N | % TKN | 25 | 17 | 21 | 22 | 22 | 17-27 |
| P₂O₅ | lb/ton | 21 | 69 | 58 | 63 | 21 | 21-69 |
| K₂O | lb/ton | 12 | 47 | 35 | 40 | 13 | 12-47 |
| Ca | lb/ton | 41 | 43 | 83 | 38 | 22 | 22-83 |
| Mg | lb/ton | 4.3 | 8.8 | 8.2 | 7.4 | 3.3 | 3.3-14 |
| S | lb/ton | 4.3 | 12 | 7.8 | 8.5 | 3 | 3-12 |
| Na | lb/ton | 3.7 | 13 | 8.3 | 7.6 | 3 | 3-13 |
| Fe | lb/ton | 2 | 1.2 | 1.2 | 1.4 | 1.3 | 1.2-2 |
| Mn | lb/ton | 0.16 | 0.79 | 0.69 | 0.8 | 0.37 | 0.16-.8 |
| B | lb/ton | 0.055 | 0.057 | 0.034 | 0.052 | 0.021 | 0.021-0.057 |
| Mo | lb/ton | 0.0092 | 0.00086 | 0.00056 | 0.00093 | 0.0004 | 0.0004-0.0092 |
| Zn | lb/ton | 0.14 | 0.71 | 0.62 | 0.66 | 0.32 | 0.14-0.71 |
| Cu | lb/ton | 0.026 | 0.53 | 0.23 | 0.6 | 0.044 | 0.026-0.6 |
| Crude Protein | % dry basis | 32 | 26 | | 18 | | 18-32 |
| Total | col/100 gm | 7.32E+11 | 1.06E+11 | | 5.63E+11 | | |
| Bacteria | | | | | | | |
| Aerobic | col/100 gm | 6.46E+10 | 1.58E+09 | | | | |
| Bacteria | | | | | | | |

TKN, Total Kjeldahl Nitrogen (organic nitrogen, ammonia, and ammonium)

Thus, manure from domestic fowl, or poultry birds, may be especially suitable for use in the present manufacturing methods as they tend to be kept on farms and the like, making for abundant and convenient sourcing. In particular embodiments, the poultry manure is selected from chickens (including Cornish hens), turkeys, ducks, geese, and guinea fowl.

In preferred embodiments, the raw manure used in the present manufacturing process comprises chicken manure. Chicken farms and other poultry farms may raise poultry as floor-raised birds (e.g., turkeys, broilers, broiler breeder pullets) where manure is comprised of the animal feces or droppings as well as bedding, feathers, and the like. Alternatively, poultry farms may raise poultry as caged egg layers that are elevated from the ground and where manure consists mainly of fecal droppings (feces and uric acid) that have dropped through the cage. In particular aspects, the chicken manure is selected from the group consisting of egg layer chickens, broiler chickens, and breeder chickens. In a more particular embodiment, the manure comprises egg layer manure.

A typical composition of chicken manure is shown in Table 2 (analysis in percentage of total composition or ppm). The moisture content can vary from 45% to 70% moisture. In addition to macro and micronutrients, the manure contains a diverse population of microorganism which have a potential of being PGPR and also pathogenic characteristics. The manufacturing process is designed to reduce or eliminate the pathogenic organisms and cultivate beneficial organisms, including PGPR.

TABLE 2
Raw Chicken Manure Nutrients Analysis

| Nutrient | Average | Range |
|---|---|---|
| Ammonium Nitrogen | 0.88% | 0.29-1.59% |
| Organic Nitrogen | 1.89% | 0.66-2.96% |
| TKN | 2.78% | 1.88-3.66% |
| P₂O₅ | 2.03% | 1.33-2.93% |
| K | 1.40% | 0.89-3.01% |
| Sulfur | 0.39% | 0.13-0.88% |
| Calcium | 3.56% | 1.98-5.95% |
| Magnesium | 0.36% | 0.22-0.60% |
| Sodium | 0.33% | 0.10-0.88% |
| Copper | 90 ppm | >20 ppm-309 ppm |
| Iron | 490 ppm | 314 ppm-911 ppm |
| Manganese | 219 ppm | 100 pm-493 ppm |
| Zinc | 288 ppm | 97 ppm-553 ppm |
| Moisture | 51.93% | 31%-71% |
| Total Solids | 49.04% | 69%-29% |
| pH | 7.60 | 5.5-8.3 |
| Total Carbon | 17.07% | 9.10%-29.20% |
| Organic Matter | 22.32% | 15%-30% |
| Ash | 19.00% | 15-25% |
| Chloride | 0.39% | 0.19%-0.80% |

In certain embodiments, the selected poultry manure comprises between about 17 lb/ton and about 71 lb/ton (i.e., between about 0.85% and about 3.55% by weight) total Kjeldahl nitrogen (TKN), which is the total amount of organic nitrogen, ammonia, and ammonium. In particular aspects, the manure comprises about 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, or 71 lb/ton TKN.

The compositions of the invention are produced from the animal waste by a process that combines physical (e.g., mechanical, thermal), chemical, and biological aspects that reduce or eliminate pathogens while promoting the growth of a diverse microbial population and generating metabolic products of those microorganisms, all of which act together to promote plant and soil health, as described in detail below. In this regard, the inventors control the time, temperature, moisture levels, oxidation reduction potential value, dissolved oxygen content, and/or pH in various stages of the process and can alter the microbial and biochemical profile of the compositions. Further, using a pure or enriched source of oxygen at various stages of the process have additional benefits that include preventing excessive foaming, improving oxygen flow to allow for more complete microbial-mediated decomposition of organic material, eliminating odor-causing contaminants, and increasing stability and shelf-life of the finished product.

While not wishing to be bound by theory, the metabolites in the compositions act as precursor building blocks for plant metabolism and can enhance regulatory function and growth. In one aspect, the bacteria in the compositions can produce allelochemicals that can include, for example, siderophores, antibiotics, and enzymes. In another aspect, precursor molecules for the synthesis of plant secondary metabolites can include flavonoids, allied phenolic and polyphenolic compounds, terpenoids, nitrogen-containing alkaloids, and sulfur-containing compounds.

All percentages referred to herein are percentages by weight (wt %) unless otherwise noted. The terms “dry weight” or “dry wt” refer to a percentage of the total weight percentage of a given component after substantially all of the moisture/water has been removed from the composition prior to analysis.

Ranges, if used, are used as shorthand to avoid having to list and describe each and every value within the range. Any value within the range can be selected, where appropriate, as the upper value, lower value, or the terminus of the range.

The term “about” refers to the variation in the numerical value of a measurement, e.g., temperature, weight, percentage, length, concentration, and the like, due to typical error rates of the device used to obtain that measure. In one embodiment, the term “about” means within 5% of the reported numerical value; preferably, it means within 3% of the reported numerical value.

As used herein, the singular form of a word includes the plural, and vice versa, unless the context clearly dictates otherwise. Thus, the references “a”, “an”, and “the” are generally inclusive of the plurals of the respective terms. Likewise, the terms “include”, “including” and “or” should all be construed to be inclusive, unless such a construction is clearly prohibited from the context. Similarly, the term “examples,” particularly when followed by a listing of terms, is merely exemplary and illustrative and should not be deemed to be exclusive or comprehensive.

The term “comprising” is intended to include embodiments encompassed by the terms “consisting essentially of” and “consisting of”. Similarly, the term “consisting essentially of” is intended to include embodiments encompassed by the term “consisting of”.

As used herein, “animal waste” refers to any material that contains animal manure, including litter, bedding, or any other milieu in which animal manure is disposed. In one aspect, “animal waste” comprises avian or fowl manure, more particularly poultry manure (e.g., chicken, turkey, duck, goose, guinea fowl). In particular, “animal waste” comprises chicken manure, for example, from broilers or layers. In other aspects, “animal waste” can refer to waste from other animals, such as, for example, hogs, cattle, sheep, goats, or other animals not specifically recited herein. In yet another aspect, “animal waste” can refer to a mixture of waste products from two or more types of animals, for instance, two or more types of poultry.

The terms “enhanced effectiveness,” “improved effectiveness,” or “increased effectiveness” are used interchangeably herein to refer to enhanced ability of a biostimulant, biofertilizer, synthetic fertilizer, chemical pesticide/herbicide, and other compounds to improve plant health, crop or seed yield, nutrient uptake or efficiency, disease resistance, soil integrity, plant response to stress (e.g., heat, drought, toxins), resistance to leaf curl, etc. For instance, an additive or supplement may be added to a biostimulant, biofertilizer, synthetic fertilizer, or chemical pesticide/herbicide that confers “improved effectiveness” as compared to the equivalent biostimulant, biofertilizer, synthetic fertilizer, or chemical pesticide/herbicide in the absence of that additive. In particular, the biostimulants produced by the methods disclosed herein can be admixed with a synthetic fertilizer or herbicide/pesticide to confer an improvement in plant health, crop or seed yield, nutrient uptake or efficiency, disease resistance, soil integrity, plant response to stress (e.g., heat, drought, toxins), resistance to leaf curl, etc. when compared to an equivalent plant or rhizosphere treated with the synthetic fertilizer or herbicide/pesticide in the absence of the biostimulant. The foregoing plant and soil traits can be objectively measured by the skilled artisans using any number of art-standard techniques suitable for such measurements.

“Poultry litter” refers to the bed of material on which poultry are raised in poultry rearing facilities. The litter can comprise a filler/bedding material such as sawdust or wood shavings and chips, poultry manure, spilled food, and feathers.

“Manure slurry” refers to a mixture of manure and any liquid, e.g., urine and/or water. Thus, in one aspect, a manure slurry can be formed when animal manure and urine are contacted, or when manure is mixed with water from an external source. No specific moisture and/or solids content is intended to be implied by the term slurry.

The term “autothermal thermophilic aerobic bioreaction,” or “ATAB,” is used herein to describe the bioreaction to which the animal waste slurry is subjected in order to produce the liquid and/or solid bionutritional compositions of the present invention. As described below, the term refers to an exothermic process in which the animal waste slurry is subjected to elevated temperature (generated endogenously at least in part) for a pre-determined period of time. Organic matter is consumed by microorganisms present in the original waste material, and the heat released during the microbial activity maintains thermophilic temperatures.

In this regard, a “bioreaction” is a biological reaction, i.e., a chemical process involving organisms or biochemically active substances derived from such organisms. “Autothermal” means that the bioreaction generates its own heat. In the present disclosure, while heat may be applied from an outside source, the process itself generates heat internally.

The term “mesophile” is used herein to refer to an organism that grows best at moderate temperatures typically between about 20° C. and about 45° C.

“Thermophilic” refers to the reaction favoring the survival, growth, and/or activity of thermophilic microorganisms. As is known in the art, thermophilic microorganisms are “heat loving,” with a growth range between 45° C. and 80° C., more particularly between 50° C. and 70° C., as described in detail herein. “Aerobic” means that the bioreaction is carried out under aerobic conditions, particularly conditions favoring aerobic microorganisms, i.e., microorganisms that prefer (facultative) or require (obligate) oxygen.

“Anaerobic” means that the conditions favor anaerobic microorganisms, i.e., microorganisms that are facultative anaerobes, aerotolerant, or are harmed by the presence of oxygen. “Anaerobic” compounds are those that are produced by microorganisms during anaerobic respiration (fermentation).

The term “pure oxygen” as used herein refers to gas that is at least about 96% oxygen and typically in the range from about 96% to about 98% oxygen.

The term “oxygen-enriched air” as used herein refers to air or gas that is at least about 30% oxygen.

The terms “ambient air” or “atmospheric oxygen” are sometimes used interchangeably herein and refer to air in its natural state as found on Earth. “Ambient air” or “atmospheric oxygen” is readily understood by the skilled artisan to mean air that is about 21% oxygen.

The term “endogenous” as used herein refers to substances or processes arising from within—for instance, from the starting material, i.e., the animal waste, or from within a component of the manufacturing process, i.e., the digested animal waste or the separated liquid and solid components, or from within a product of the manufacturing process, i.e., a nutritional composition as described herein. A composition may contain both endogenous and exogenous (i.e., added) components. In that regard, the term “endogenously comprising” refers to a component that is endogenous to the composition, rather than having been added.

The terms “biocontrol agent” and “biopesticide” are used interchangeably herein to refer to pesticides derived from natural materials, such as animals, plants, bacteria, and certain minerals. For example, canola oil and baking soda have pesticidal applications and are considered biopesticides. “Biopesticides” include biochemical pesticides, microbial pesticides, and plant-incorporated-protectants (PIPs). “Biochemical pesticides” are naturally occurring substances that control pests by non-toxic mechanisms. “Microbial pesticides” are pesticides that contain a microorganism (e.g., bacteria, fungus, virus, or protozoan) as the active ingredient. For example, in some embodiments, Bacillus thuringiensis subspecies and strains are used as a “microbial pesticide.” B. thuringiensis produces a mix of proteins that target certain species of insect larvae depending on the particular subspecies or strain used and the particular proteins produced. “PIPs” are pesticidal substances that plants produce from genetic material that has been added to the plant. For instance, in some embodiments, the gene for the B. thuringiensis pesticidal protein is introduced into the plant genome, which can be expressed by the plant to that protein.

As used herein, a “biostimulant” refers to a substance or microorganism that, when applied to seeds, plants, or the rhizosphere, stimulates natural processes to enhance or benefit nutrient uptake, nutrient efficiency, tolerance to abiotic stress (e.g., drought, heat, and saline soils), tolerance to biotic stress, or crop quality and yield. “Biostimulants” that include one or more primary nutrients (e.g., nitrogen, phosphorus, and/or potassium) and at least one living microorganism are also biofertilizers or referred to as having biofertilizer properties. “Biostimulants” reduce the need for fertilizers and increase plant growth, resistance to water and abiotic and biotic stresses. In small concentrations, these substances are efficient, favoring the good performance of the plant's vital processes, and allowing high yields and good quality products. In addition, “biostimulants” applied to plants enhance nutrition efficiency, abiotic stress tolerance and/or plant quality traits, regardless of its nutrient contents. Other “biostimulants” may include plant growth regulators, organic acids (e.g., fulvic acid), humic acid, and amino acids/enzymes.

As used herein, the term “biofertilizer” refers to a substance which contains one or more primary nutrients (e.g., nitrogen, phosphorus, and/or potassium) and living microorganisms, which, when applied to seeds, plant surfaces, or soil, colonize the rhizosphere or the plant structure and promote growth by increasing the availability of primary nutrients to the host plant. “Biofertilizers” may also have biostimulant properties. “Biofertilizers” include, but are not limited to, plant growth promoting rhizobacteria (PGPR), compost/compost tea, and certain fungi (e.g., mycorrhizae). Examples of bacteria which have been found to enhance plant growth, include both mesophilic bacteria and thermophilic bacteria. Specific thermophilic bacteria that have been shown to enhance plant growth include members of genera such as Bacillus, Ureibacillus, Geobacillus, Brevibacillus, and Paenibacillus, all known to be prevalent in poultry manure compost. Mesophiles reported to be beneficial for plant growth, include those belonging to the genera Bacillus, Serratia, Azotobacter, Lysinibacillus, and Pseudomonas.

The term “organic fertilizer” typically refers to a soil amendment from natural sources that guarantee, at least the minimum percentage of nitrogen, phosphate, and potash. Examples include plant and animal byproducts, rock powder, seaweed, inoculants, and conditioners. If such fertilizers meet criteria for use in organic programs, such as the NOP, they also can be referred to as registered, approved, or listed for use in such programs.

“Plant growth promoting rhizobacteria” and “PGPR” are used interchangeably herein to refer to soil bacteria that colonize the roots of plants and enhance plant growth.

“Plant growth regulator” and “PGR” are used interchangeably herein to refer to chemical messengers (i.e., hormones) for intercellular communication in plants. There are nine groups of plant hormones, or PGRs, recognized currently in the art: auxins, gibberellins, cytokinins, abscisic acid, ethylene, brassinosteriods, jasmonates, salicylic acid and strigolactones.

The term “organic agriculture” is used herein to refer to production systems that sustain the health of soils and plants by the application of low environmental impact techniques that do not employ chemical or synthetic products that could affect both the final product, the environment, or human health.

The term “conventional agriculture” is used herein to refer to production systems which include the use of synthetic fertilizers, pesticides, herbicides, genetic modifications, and the like.

The term “regenerative agriculture” is used herein to refer to a system of farming principles and practices that increases biodiversity, enriches soil, improves watersheds, and enhances ecosystem services.

The term “rhizosphere” as used herein refers to the region of soil in the vicinity of plant roots in which the chemistry and microbiology is influenced by their growth, respiration, and nutrient exchange.

As used herein, a “soil conditioner” is a substance added to soil to improve the soil's physical, chemical, or biological qualities, especially its ability to provide nutrition for plants. Soil conditioners can be used to improve poor soils, or to rebuild soils which have been damaged by improper management. Such improvement can include increasing soil organic matter, improving soil nutrient profiles, and/or increasing soil microbial diversity.

Various publications, including patents, published applications and scholarly articles, are cited throughout the specification. Each of these publications is incorporated by reference herein in its entirety.

### Process:

The manufacturing process for producing the bionutritional compositions of the instant disclosure generally comprises the following steps: (1) preparation of the starting material (the animal waste, also referred to herein as “feedstock material”) to produce an animal waste slurry; (2) allowing for the components of the animal slurry to remain in contact for a period of time and include one or more of aeration, mixing, and heating of the animal waste slurry; (3) optional removal of at least a portion of the inorganic solids from the animal waste slurry; (4) optional reduction of particle size; and (5) subjecting the animal waste material to an autothermal thermophilic aerobic bioreaction (ATAB) to produce a digested animal waste composition. In some embodiments, the mixing step and the ATAB step can be carried out in a single apparatus, such as a mixing tank modified as an aerobic bioreactor. In such embodiments, the intervening steps 3 and/or 4 are not carried out. Further still, the mixing tank can be adapted for both removal of inorganic solids (e.g., grit removal) as discussed below and ATAB.

At this point, the digested animal waste composition can be cooled, stored, and optionally formulated with additional organic nutrients and/or stabilized with, e.g., humic acid, to produce a general-purpose emulsified biofertilizer or, alternatively, the digested animal waste composition can be separated into a substantially solid component and a substantially liquid component each of which can be further processed to produce a solid biofertilizer and liquid biostimulant, respectively. The liquid biostimulant can be cooled, optionally formulated with additional organic nutrients, stabilized, and stored. On the other hand, the solid biofertilizer can be dried, dehydrated or granulated at low temperatures at low temperatures to preserve microbial content, It can also be optionally formulated with additional organic nutrients. Finally, the liquid biostimulant products are typically subjected to filtration and/or screening prior to shipping or packaging.

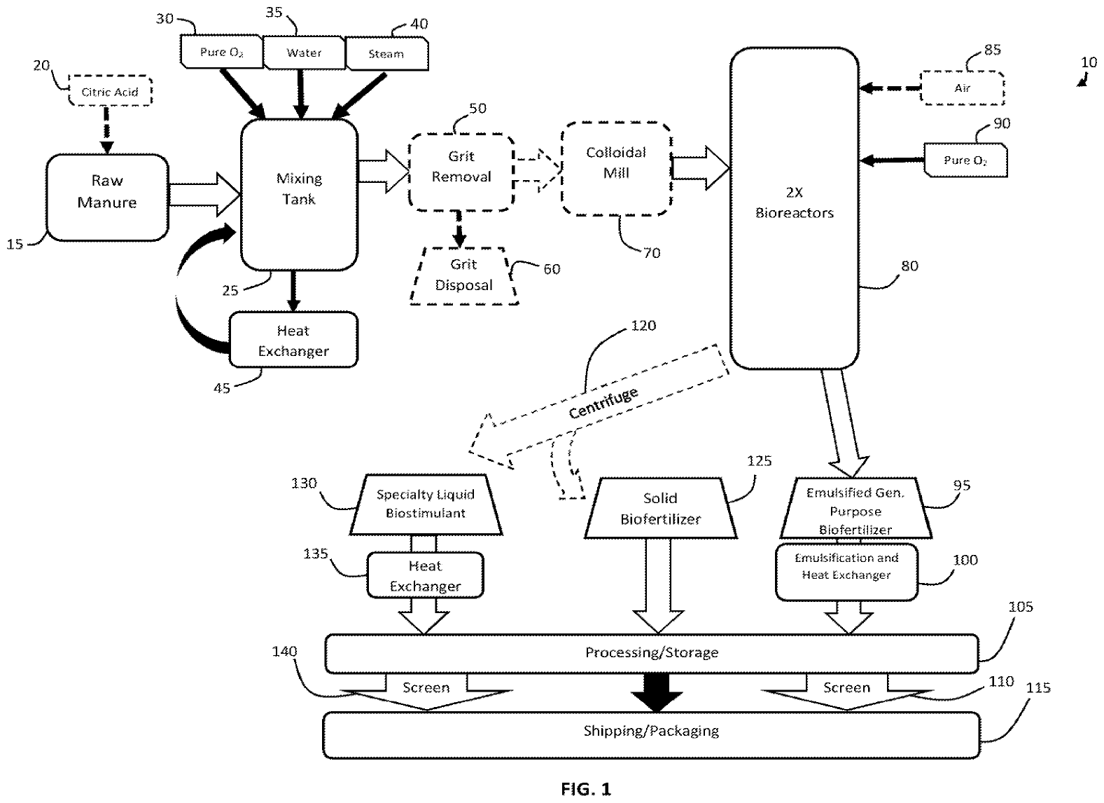

A schematic diagram depicting an exemplary embodiment of the manufacturing process applied to raw manure, such as egg layer chicken manure is shown in FIG. 1 and described further below. If manure is supplied as poultry litter, e.g., from broiler chickens, the bedding is removed prior to initiation of the above-summarized process.

In general, the manufacturing process disclosed herein may include an oxygen supply or delivery system for introducing to various steps in the process pure oxygen or oxygen-enriched air having an oxygen concentration of at least about 30%, e.g., at least about 30%, 31%, 32%, 33%, 34%, 35%, 36%, 37%, 38%, 39%, 40%, 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, 74%, 75%, 76%, 77%, 78%, 79%, 80%, 81%, 82%, 83%, 84%, 85%, 86%, 87%, 88%, 89%, 90%, 91%, 92%, 93%, 94%, 95%, 95.5%, 96%, 96.5%, 97%, 97.5%, 98%, 98.5%, 99%, 99.1%, 99.2%, 99.3%, 99.4%, 99.5%, 99.6%, 99.7%, 99.8%, or 99.9%. A suitable oxygen supply system can be installed in mixing tanks, bioreactors, and the like. Such oxygen supply systems can be installed in place of typical nozzle mixers and aeration systems supplying atmospheric oxygen (or ambient air). In general, atmospheric oxygen is air or gas that has an oxygen content of about 21%, which is significantly lower than the oxygen supply provided in the present process. Pure oxygen or oxygen-enriched air can be introduced into the slurry preparation step and/or the ATAB step.

As one skilled in the art would understand, gasses can be delivered or injected into liquids using a variety of delivery devices, such as an aspirator, venturi pump, sparger, bubbler, carbonator, pipe or tube, tank/cylinder, and the like. In particular embodiments, the gas delivery device is a sparger. A sparger suitable for use with the oxygen supply systems disclosed herein may consist of a porous construction of any art-standard plastic (such as polyethylene or polypropylene) or metal (such as stainless steel, titanium, nickel, and the like). Pressurized gas (e.g., oxygen) can be forced through the network of pores in the sparger and into an aqueous mixture, such as a slurry or liquid fraction. Pore grades suitable for use herein range from about 0.1 microns to about 5 microns, e.g., about 0.1, 0.2, 0.3, 0.4, 0.5, 0.6, 0.7, 0.8, 0.9, 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, 4.0, 4.1, 4.2, 4.3, 4.4, 4.5, 4.6, 4.7, 4.8, 4.9, or 5.0 microns; preferably, between about 1 and 3 microns. In a particular embodiment, the sparger pore size is from about 1.5 microns to about 2.5 microns. For instance, in one embodiment, the oxygen supply system includes 2-micron sintered stainless steel spargers.

### Slurry Preparation

In the preparation step, the feedstock material is first adjusted for moisture content and, optionally, pH. While in some embodiments the process can be conducted at any pH, it is preferable that the pH be maintained within a desired pH range as described below. In some aspects, an adjustment of pH is necessary and occurs at the slurry stage or even later in the process. The pH of the feedstock material and/or slurry may be adjusted to neutral or acidic through the addition of a pH adjusting agent, it being understood that the pH can be adjusted prior to or after the adjustment of the moisture. Alternatively, the pH and moisture adjustments can occur simultaneously. In other embodiments, the feedstock pH and/or slurry does not need to be adjusted (i.e., the pH of the feedstock material and/or is already within the desired pH range). Typically, however, the pH of the feedstock material and/or slurry may need to be adjusted. In particular embodiments, the feedstock/slurry is adjusted to a pH of between about 4 and about 8, or more particularly to between about 5 and about 8, or even more particularly to between about 5.5 and about 8 or between about 5.5 and about 7.5. In preferred embodiments, the pH of the slurry is at least about 6.0, or about 6.1, or about 6.2, or about 6.3, or about 6.4, or about 6.5, or about 6.6, or about 6.7, or about 6.8, or about 6.9, or about 7.0, or about 7.1, or about 7.2, or about 7.3, or about 7.4, or about 7.5, or about 7.6, or about 7.7, or about 7.8, or about 7.9. In some embodiments, the slurry is adjusted to a pH of less than about 8, more preferably less than about 7.5. For instance, in one particular embodiment, the feedstock material and/or slurry is adjusted to a pH of about 5.5 or about 7.5. Acidification of an otherwise non-acidic (i.e., basic) feedstock is important to stabilize the natural ammonia in the manure into non-volatile compounds, e.g., ammonium citrate. Thus, the pH adjustment step produces a stabilized animal waste composition or animal waste slurry. The pH of the stabilized animal waste slurry is maintained within the desired range, e.g.; between about 5 to about 8, or between about 5.5 and about 8, or between about 5.5 and about 7.5, or between about 6 and about 7.8, or about 7 or about 7.5; throughout the entire manufacturing process. In some embodiments, the pH of the finished product is adjusted to a pH of between about 5 and about 6, e.g., about 5.5, prior to storage/packaging/shipping.

An acid is typically used to adjust the pH of the animal waste feedstock and/or slurry. In certain embodiments, the acid is an organic acid, though an inorganic acid may be used or combined with an organic acid. Suitable organic acids include, but are not limited to formic acid (methanoic acid), acetic acid (ethanoic acid), propionic acid (propanoic acid), butyric acid (butanoic acid), valeric acid (pentanoic acid), caproic acid (hexanoic acid), oxalic acid (ethanedioic acid), lactic acid (2-hydroxypropanoic acid), malic acid (2-hydroxybutanedioic acid), citric acid (2-hydroxypropane-1,2,3-tricarboxylic acid), and benzoic acid (benzenecarboxylic acid). Preferably, the acid is one typically used to adjust the pH of food or feed. A preferred acid is citric acid. For instance, in some embodiments, citric acid may be used to maintain the pH of the animal waste feedstock and/or slurry within the desired range throughout the entire process.

As noted above, the preparation step also involves adjusting the moisture content of the animal waste material to produce a slurry. The moisture content is adjusted by adding a liquid to form an aqueous slurry that is sufficiently liquid to be flowable from one container to another, e.g., via pumping through a hose or pipe. The liquid may be water or some other liquid supplied from an external source or may be recycled liquid from another step in the process. In certain embodiments, the aqueous animal waste slurry has a moisture content of at least about 80%. More particularly, the aqueous animal waste slurry has a moisture content of at least about 81%, or at least about 82%, or at least about 83%, or at least about 84%, or at least about 85%, or at least about 86%, or at least about 87%, or at least about 88%, or at least about 89%, or at least about 90%, or least about 91%, or at least about 92%, or at least about 93%, or at least about 94%, or at least about 95%, or at least about 96%, or at least about 97%, or at least about 98%, or at least about 99%, with the understanding that about 99% moisture is an upper limit. In particular embodiments, the slurry has a moisture content of between about 80% to about 95%, even more particularly between about 84% and about 88%, or between about 80% and about 92%.

The animal waste slurry preparation may also include the delivery of oxygen to create a more aerobic environment to both prevent formation of anaerobic contaminants produced during microbial fermentation in oxygen depleted conditions and to oxidize anaerobic contaminants. One of these undesirable compounds is hydrogen sulfide, which can result from the anaerobic microbial breakdown of organic matter, such as manure. Hydrogen sulfide is poisonous, corrosive, and flammable with a characteristic odor of rotten eggs. Substantial reduction or elimination of the toxic and odor-causing hydrogen sulfide during the production of the liquid and solid fertilizer products is highly desired. Odor-causing hydrogen sulfide can be oxidized by gaseous oxygen.

In slurry or liquid components, hydrogen sulfide is dissociated into its ionic form illustrated by Equation 1:

$${H}_{2} S \to 2 {H}^{+} + {S}^{- 2} \qquad Equation 1$$

The sulfide ion is then free to react with oxygen according to Equation 2:

$$2 {H}_{2} S + {O}_{2} \to 2 {H}_{2} O + 2 S \qquad Equation 2$$

The reaction ratio of hydrogen sulfide oxidation is around 1.0. For instance, 1 mg/kg (ppm) of oxygen is required for each ppm of hydrogen sulfide. In some embodiments, the residual dissolved oxygen in the slurry or liquid component is at least about 0.5 ppm, e.g., 0.5, 0.6, 0.7, 0.8, 0.9, 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3.0, or more ppm. In a preferred embodiment, the residual dissolved oxygen level in the slurry or liquid component is at least about 1 ppm, more preferably at least about 2 ppm. However, typical slurry mixing tanks supply atmospheric oxygen to the system to reduce the production of compounds formed by the microorganisms' anaerobic metabolism. Atmospheric oxygen sources may provide insufficient oxygen for the elimination of hydrogen sulfide contaminant. Thus, a more efficient oxygen delivery system is desired.

Therefore, to oxidize hydrogen sulfide and other contaminants in the mixing tank during slurry preparation, the preparation step may include an oxygen supply or delivery system for injecting pure or oxygen-enriched air into the slurry, which provides a substantial increase in oxygen delivery as compared to existing aeration systems delivering atmospheric oxygen. The oxygen supply or delivery system may include any suitable means for delivering or injected the oxygen into the slurry, such as one or more spargers, venturi pumps, bubblers, carbonators, pipes, etc. In a particular embodiment, the oxygen supply or delivery system includes a plurality of spargers. In some embodiments, the oxygen is delivered to the mixing tank of the preparation step and/or directly injected into the slurry at a rate of about 0.1 CFM to about 3 CFM per 10,000 gallons of material, e.g., 0.1, 0.2, 0.3, 0.4, 0.5, 0.6, 0.7, 0.8, 0.9, 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, or 3.0 CFM. In a preferred embodiment, the delivery rate is between about 0.25 CFM and about 1.5 CFM per 10,000 gallons of material. For instance, in one particular embodiment, the oxygen is delivered to the mixing tank of the preparation step and/or directly injected into the slurry at a rate of about 0.25 CFM per 10,000 gallons of material. Thus, the oxygen supply or delivery system disclosed herein increases the residual dissolved oxygen content to meet the desired threshold described above.

The slurry preparation system is designed to prepare a homogeneous slurry in an aqueous medium at a pH of 4 to 8, preferably 5 to 8 and at an elevated temperature. The temperature may be elevated at this stage for several purposes, including (1) to promote mixing and flowability of the slurry, (2) to kill pathogens and/or weed seeds, and/or (3) to initiate growth of mesophilic bacteria present in the feedstock. The temperature can be elevated by any means known in the art, including but not limited to conductive heating of the mixing tank, use of hot water to adjust moisture content, or injection of steam, to name a few. In certain embodiments, the slurry is gradually heated to at least about 40° C., or at least about 41° C., or at least about 42C, or at least about 43° C., or at least about 44° C., or at least about 45° C., or at least about 46° C., or at least about 47° C., or at least about 48° C., or at least about 49° C., or at least about 50° C., or at least about 51° C., or at least about 52° C., or at least about 53° C., or at least about 54° C., or at least about 55° C., or at least about 56° C., or at least about 57° C., or at least about 58° C., or at least about 59° C., or at least about 60° C., or at least about 61° C., or at least about 62° C., or at least about 63° C., or at least about 64° C., or at least about 65° C. Typically, the temperature does not exceed about 65° C., or more particularly, it is less than about 65° C., or less than about 60° C. In certain embodiments, the temperature of the slurry is preferably maintained within a temperature range of between about 40° C. and about 65° C.; more preferably between about 40° C. and about 45° C. To ensure pathogen destruction, the fully homogenized slurry may be further heated to 65° C. for a minimum of 1 hour. Alternatively, the fully homogenized slurry can be heated to a lower temperature for a longer period of time to kill pathogens, such as between about 46° C. and 55° C. for a period of at about 24 hours to about 1 week, depending on the temperature. For instance, particular time/temperatures can be about 55° C. for about 24 hours or about 46° C. for about 1 week.

The pH-adjusted aqueous animal manure slurry is maintained at the elevated temperature for a time sufficient to break the manure down into fine particles, fully homogenizing the slurry for further processing, and activating the native mesophilic bacteria. In this manner, the various components of the animal waste slurry remain in contact for this period of time. For instance, in certain embodiments, the animal waste slurry is held at the elevated temperature for at least about one hour and up to about 4 hours, e.g., about 1, 1.5, 2, 2.5, 3, 3.5, or 4 hours. In some embodiments, the slurry is subjected to chopping, mixing, and/or homogenization during this phase. In certain embodiments, the preparation step as outlined above is segregated from subsequent steps of the process to reduce the likelihood that downstream process steps could be contaminated with raw manure.

In an exemplary embodiment, the slurry system consists of a tank (e.g., a steel tank or stainless-steel tank), equipped with a chopper/homogenizer (e.g., a macerator or chopper pump), an oxygen supply system (e.g., sparger), pH and temperature controls, and a biofiltration system for off-gases.

An exemplary process consists of charging the tank with water, heating it to about 45° C. or higher, lowering the pH to about 7 or lower, preferably to a pH range of about 5 to about 7, with citric acid. The chopper pump, oxygen supply system (e.g., via spargers), and off gas biofiltration systems are turned on before introducing the feedstock to ensure a moisture content of, e.g., 85 to 90%. It is a batch operation and, in various aspects, can take one to four hours to make a homogeneous slurry. The operation ensures that each particle of the manure is subjected to temperatures of 45° C. or higher for a period of at least one hour to initiate mesophilic decomposition. Further, the injection of pure oxygen or oxygen enriched air reduces or eliminates toxic and odor-causing contaminants, such as hydrogen sulfide, produced by anaerobic fermentation.

In certain embodiments, the aqueous animal waste slurry prepared as described above is transferred from a slurry tank by pumping, e.g., using a progressive cavity pump. Progressive cavity pumps are particularly suitable devices for moving slurries that can contain extraneous materials such as stones, feathers, wood chips, and the like. The transfer line can be directed into a vibratory screen where the screens can be either vibrating in a vertical axial mode or in a horizontal cross mode. The selected vibratory screen will have appropriately sized holes to ensure that larger materials are excluded from the slurry stream. In one embodiment, the screens exclude materials larger than about ⅛ inch in any dimension.

The slurry stream can then be pumped either directly to the next step in the process, or alternatively into storage tanks, which may be equipped with pH and temperature controls and/or an agitation system. In particular embodiments, the storage tanks may also be equipped with an oxygen supply system. In such embodiments, the slurry is kept under aerobic conditions by injecting pure oxygen or oxygen-enriched air at a rate of from about 0.1 CFM to about 3 CFM per 10,000 gallons of slurry, e.g., 0.1, 0.2, 0.3, 0.4, 0.5, 0.6, 0.7, 0.8, 0.9, 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, or 3.0 CFM per 10,000 gallons of slurry. Preferably, the pure oxygen or oxygen-enriched air is delivered to the slurry at about 0.25 CFM to about 1.5 CFM per 10,000 gallons of slurry, more preferably at about 0.5 CFM per 10,000 gallons of slurry. In some embodiments, the oxygen is delivered via a plurality of spargers such as those described above. By keeping the slurry under aerobic conditions, the formation of anaerobic compounds is avoided. Optionally, the off-gases are subjected to bio-filtration or other means of disposal.

### Degritting

Contained within animal waste feedstock and the aqueous animal waste slurry are various inorganic particles, such as sand, stone, and other grit. Grit can increase wear of the bioreactors, pumps, mixing equipment, centrifuges, and other equipment that may be included in the manufacturing process. As such, removal of grit protects this equipment from wear and reduces energy and maintenance costs. Moreover, the removal of these inorganic particles also enhances the surface availability of the organic components thus increasing the efficiency of microbial digestions/decomposition and improving the quality of the final products. Thus, in some embodiments of the process disclosed herein, the aqueous animal waste slurry stream from the mixing tank or storage tank is sent to a system configured for removal of at least a portion of the grit and other course and fine inorganic solids; preferably, the majority of grit and other inorganic solids are removed from the aqueous animal waste slurry.

A variety of grit removal systems can be used with the invention. In some embodiments, the slurry preparation mixing tank is fitted with mesh screens configured for grit capture. Suitable mesh screens range from 18 mesh to 5 mesh (i.e., about 1 mm to about 4 mm), e.g., 18, 16, 14, 12, 10, 8, 7, 6, or 5 mesh; preferably, the mesh screen is 12 mesh to 8 mesh (i.e., about 1.68 mm to about 2.38 mm). For instance, a slurry preparation tank configured for removal of grit may utilize gravity with 10 mesh screens for grit capture and removal.

Other grit washing and removal systems include hydraulic vessels that control the flow of the slurry in such a manner to produce an open free vortex, which, in turn, results in high centrifugal forces with a thin fluid boundary. Grit is then forced to the outside perimeter where it falls by gravity and can be discharged. The animal waste slurry then exits the vessel through a hydraulic valve. In such embodiments, the animal waste slurry is pumped into the hydraulic vessel tangentially at a rate of about 150 gpm to about 1,200 gpm (about 9.5 L/s to about 75.7 L/s), e.g., about 150 gpm, 200 gpm, 250 gpm, 300 gpm, 350 gpm, 400 gpm, 450 gpm, 500 gpm, 550 gpm, 600 gpm, 650 gpm, 700 gpm, 750 gpm, 800 gpm, 850 gpm, 900 gpm, 950 gpm, 1,000 gpm, 1,050 gpm, 1,100 gpm, 1,150 gpm, or 1,200 gpm; preferably, the rate is from about 200 gpm to about 1,000 gpm (about 12.6 L/s to about 63.1 L/s); more preferably, the rate is from about 250 gpm to about 800 gpm (about 15.8 L/s to about 50.5 L/s). For instance, in one particular embodiment, the animal waste slurry is pumped into the grit removal vessel at a rate of about 300 gpm (about 18.9 L/s). This system eliminates the need for a rotating drum filter prior to bioreactor loading while still capturing, washing, and classifying grit as small as about 95 μm, or about 90 μm, or about 85 μm, or about 80 μm, or about 75 μm, or about 70 μm from the animal waste slurry.

Hydraulic systems are available in the art, such as the SLURRYCUP grit washing system from Hydro International (Hillsboro, Oregon, USA). In some embodiments, two or more hydraulic vessels are configured in a series to provide for multiple rounds of grit washing of the animal waste slurry flow. In yet other embodiments, the system can be used with a belt escalator that captures and dewaters the grit output thus reducing solids handling and disposal costs (e.g., GRIT SNAIL, Hydro International, Hillsboro, Oregon, USA).

From the grit removal step, the aqueous animal waste slurry stream can be directed into storage tanks, such as the storage tanks described above. As noted above, these storage tanks are equipped with pH and temperature controls, an agitation system, and/or an oxygen supply system. In such embodiments, the slurry is kept under aerobic conditions by injecting pure oxygen or oxygen-enriched air at a rate of from about 0.1 CFM to about 3 CFM per 10,000 gallons of slurry, e.g., 0.1, 0.2, 0.3, 0.4, 0.5, 0.6, 0.7, 0.8, 0.9, 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, or 3.0 CFM per 10,000 gallons of slurry. Preferably, the pure oxygen or oxygen-enriched air is delivered to the slurry at about 0.25 CFM to about 1.5 CFM per 10,000 gallons of slurry, more preferably at about 0.5 CFM per 10,000 gallons of slurry. In some embodiments, the oxygen is delivered via a plurality of spargers such as those described above.

In some embodiments, the animal waste slurry can be further processed to reduce particle size, thereby increasing the surface area and supporting more thorough aerobic digestion of the animal waste composition, including animal waste slurries with lower moisture content. Suitable size-reduction equipment includes, but is not limited to, a colloidal mill, a homogenizer, a macerator, or a dispersing grinder. In one embodiment, the present method employs a homogenizer that forces the slurry material through a narrow space while imparting cavitation, turbulence, or some other force at high pressure to create a consistent and uniform animal waste slurry. In another embodiment, a colloidal mill is used. As one having ordinary skill in the art would appreciate, a colloidal mill includes a rotor that rotates at high velocity on a stationary stator containing many small slots. The rotor-stator mixer pushes the slurry through the slots of the stator, thereby reducing particle sizes to less than about 1.5 microns, e.g., 1.5 microns, 1.4 microns, 1.3 microns, 1.2 microns, 1.1 microns, 1 micron, 0.9 microns, 0.8 microns, 0.7 microns, 0.6 microns, 0.5 microns, 0.4 microns, or less; preferably less than about 1 micron. In a preferred embodiment, the process includes a size reduction step that includes a macerator or a colloidal mill for reducing the size of the organic particles to less than about 1 micron.

### Autothermal Thermophilic Aerobic Bioreaction

The next step involves subjecting the animal waste slurry to an autothermal thermophilic aerobic bioreaction (ATAB). ATAB is an exothermic process in which the animal waste composition with finely suspended solids is subjected to elevated temperature for a pre-determined period of time. Organic matter is consumed by microorganisms present in the original waste material, and the heat released during the microbial activity maintains mesophilic and/or thermophilic temperatures thereby favoring the production of mesophilic and thermophilic microorganisms, respectively. ATAB produces a biologically stable product, which contains macro- and micronutrients, PGPR, secondary metabolites, enzymes, and PGR/Phytohormones

In previously existing methods, after mixing/homogenization, the slurry is typically subjected to solid/liquid separation. In these processes, the liquid component contains only about 4% to about 6% of the animal waste, which is then subjected to ATAB step. In addition, the solid material being produced by these methods does not meet NOP standards without inclusion of a drying step, which destroys the beneficial bacteria. Accordingly, this separation step removes valuable, plant important, nonwater-soluble nutrients from the liquid component. Moreover, such a process allows only for efficient ATAB digestion of the liquid stream. As such, only about 15% to about 25% of the aqueous animal waste slurry is subjected to the ATAB step. In turn, the solid material being produced is a nutrient rich fertilizer and soil amendment, but not a higher value biostimulant or biofertilizer. As such, the inventors having developed the present system that does not require separation prior to ATAB and may include the degritting and/or size reduction steps described above to allow efficient microbial decomposition of the entire aqueous animal waste slurry during the ATAB step. In this manner, and as explained below, both liquid biostimulant and solid biofertilizer products can be produced with adequate nutrients and metabolic compounds according to meet commercial needs and the NOP standards.

In certain embodiments, the elevated temperature conditions are between about 45° C. and about 80° C. More particularly, the elevated temperature conditions are at least about 46° C., or 47° C., or 48° C., or 49° C., or 50° C., or 51° C., or 52° C., or 53° C., or 54° C., or 55° C., or 56° C., or 57° C., or 58° C., or 59° C., or 60° C., or 61° C., or 62° C., or 63° C., or 64° C., or 65° C., or 66° C., or 67° C., or 68° C., or 69° C., or 70° C., or 71° C., or 72° C., or 73° C., or 74° C., or 75° C., or 76° C., or 77° C., or 78° C., or 79° C. In particular embodiments, the elevated temperature conditions are between about 45° C. and about 75° C., more particularly between about 45° C. and about 70° C., more particularly between about 50° C. and about 70° C., more particularly between about 55° C. and about 65° C., and most particularly between about 60° C. and about 65° C. In certain embodiments, the animal waste slurry is maintained in the ATAB under gentle agitation (e.g., full turnover occurs about 10 to about 60 times per hour).

In general, the temperature of the ATAB gradually increases to the mesophilic phase and then to the thermophilic phase. It being understood by one having ordinary skill in the art that the mesophilic phase is at a temperature range in which mesophiles grow best (e.g., about 20° C. to about 45° C.). As the temperature increases above 20° C. to about 40° C., the animal waste slurry enters a mesophilic phase thereby enriching for mesophiles. In some embodiments, the mesophilic phase temperature is between about 30° C. and about 40° C., e.g., about 30° C., 31° C., 32° C., 33° C., 34° C., 35° C., 36° C., 37° C., 38° C., 39° C., or 40° C. In other embodiments, the mesophilic phase temperature is about 35° C. to about 38° C. In such embodiments, the animal waste slurry is maintained at mesophilic phase temperatures for a period of 1 hour to several days, e.g., at least about 1 hour, 2 hours, 3 hours, 4 hours, 5 hours, 6 hours, 7 hours, 8 hours, 9 hours, 10 hours, 11 hours, 12 hours, 13 hours, 14 hours, 15 hours, 16 hours, 17 hours, 18 hours, 19 hours, 20 hours, 21 hours, 22 hours, 23 hours, 1 day, 2 days, 3 days, 4 days, or 5 days. In preferred embodiments, the animal waste slurry is maintained at mesophilic phase temperatures for a period of about 1 to 4 days; more preferably, about 1 to 3 days. For instance, in one particular embodiment, the animal waste slurry is maintained at mesophilic phase temperatures for about 3 days. As the temperature continues to increase, the animal waste slurry enters a thermophilic phase thereby enriching for thermophiles. It being understood by one having ordinary skill in the art that the thermophilic phase is at a temperature range in which thermophiles grow best (e.g., about 40° C. to about 80° C.). In some embodiments, the thermophilic phase temperature is between about 45° C. and about 80° C., e.g., about 45° C., 46° C., 47° C., 48° C., 49° C., 50° C., 51° C., 52° C., 53° C., 54° C., 55° C., 56° C., 57° C., 58° C., 59° C., 60° C., 61° C., 62° C., 63° C., 64° C., 65° C., 66° C., 67° C., 68° C., 69° C., 70° C., 71° C., 72° C., 73° C., 74° C., 75° C., 76° C., 77° C., 78° C., 79° C., or 80° C. In other embodiments, the thermophilic phase temperature is about 50° C. to about 70° C. In yet other embodiments, it is preferred that the thermophilic phase temperature is at least about 55° C.; more preferably, the animal waste slurry is maintained at a temperature range of between about 60° C. and about 65° C. for at least a portion of time.

In certain embodiments, the animal waste slurry is maintained at the elevated temperature for a period of several hours to several days. A range of between 1 day and 14 days is often used. In certain embodiments, the conditions can be maintained for 1, 2, 3, 4, 5, 6, 7, 8, 9, or more days; preferably, 1 to 8 days. For purposes of guidance only, the bioreaction is maintained at the elevated temperature for a longer period, e.g., three or more days, to ensure suitable reduction of pathogenic organisms, for instance to meet guidelines for use on food portions of crops. For instance, NOP standards require that the animal waste slurry has been subjected to temperatures of at least about 55° C. for a period of 72 hours or more. However, inasmuch as the length of the bioreaction affects the biological and biochemical content of the bio-reacted product, other times may be selected, e.g., several hours to one day or two days. In particular embodiments, after being maintained at the elevated temperature suitable for thermophilic bacteria, the temperature of the animal waste slurry gradually decreases into the mesophilic temperature range where it is maintained at mesophilic phase temperatures until the liquid component is flash pasteurized or run through a heat exchanger to rapidly drop the temperature, either of which, in many cases, causes the bacteria to produce spores.

One challenge in operating under aerobic thermophilic conditions is to keep the process sufficiently aerobic by meeting or exceeding the oxygen demand while operating at the elevated temperature conditions. One reason this is challenging is that as the process temperature increases, the saturation value of the residual dissolved oxygen decreases. Another challenge is that the activity of the mesophilic and thermophilic micro-organisms increases within increasing temperature, resulting in increased oxygen consumption by the microorganisms. Because of these factors, greater amounts of oxygen, in various aspects, should be imparted into the biomass-containing solutions.

As described in WO 2017/112605 A1, the content of which is incorporated herein in its entirety, existing bioreactors use aeration devices, such as jet aerators, to deliver atmospheric oxygen to the bioreactor due to high oxygen transfer efficiency, the capability for independent control of oxygen transfer, superior mixing, and reduced off-gas production. However, atmospheric oxygen causes excess foaming inside the bioreactor thereby impeding the efficiency of the oxygen supply and causing frequent shut down of the air supply. In some instances, for example, the level of foaming can exceed several feet, e.g., 1, 2, 3, 4, 5, 6, 7, 8 feet or more when atmospheric air is supplied. In turn, the inadequate air supply and reaction disruption results in incomplete decomposition of undesirable organic material. What is more, an increase in undecomposed solids suspended in the substantially liquid stream is difficult to remove and frequently results in liquid fertilizer that plugs spray equipment during field application thereby halting field operations. Moreover, undecomposed solids that are present in the final bionutritional composition products decreases stability and shelf-life.

Thus, to overcome these obstacles, in a particular embodiment pure oxygen or oxygen-enriched air is delivered to the bioreactor and injected or otherwise delivered into the animal waste slurry at a rate of from about 0.1 CFM to about 5 CFM per 1,000 gallons of liquid component, e.g., 0.1, 0.2, 0.3, 0.4, 0.5, 0.6, 0.7, 0.8, 0.9, 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, 4.0, 4.1, 4.2, 4.3, 4.4, 4.5, 4.6, 4.7, 4.8, 4.9, or 5.0 CFM per 1,000 gallons of animal waste slurry. In preferred embodiments, the pure oxygen or oxygen-enriched air is delivered to the bioreactor and injected or otherwise delivered into the animal waste slurry at a rate of from about 0.5 CFM to about 1.5 CFM per 1,000 gallons of animal waste slurry, more preferably the rate is about 1.0 CFM per 1,000 gallons of animal waste slurry.

In particular embodiments, pure oxygen or oxygen-enriched air is delivered to the bioreactor by using a plurality of spargers as described above. For instance, one or more 2-micron sintered stainless steel spargers may be used to inject pure oxygen or oxygen-enriched air into the animal waste slurry during ATAB. Keeping the animal waste slurry under aerobic conditions will cultivate and enrich for aerobic, mesophilic and thermophilic bacteria. In particular embodiments, the initial decomposition of the organic material in the animal waste slurry is carried out by mesophilic organisms, which rapidly break down the soluble and readily degradable compounds. The heat the mesophilic organisms produce causes the temperature during ATAB to increase rapidly thereby enriching for thermophilic organisms that accelerate the breakdown of proteins, fats, and complex carbohydrates (e.g., cellulose and hemicellulose). As the supply of these high-energy compounds become exhausted, the temperature of the animal waste slurry gradually decreases, which promotes mesophilic organisms once again resulting in the final phase of “curing” or maturation of the remaining organic matter in the animal waste slurry. Thus, the replacement of atmospheric oxygen supply with a pure oxygen or oxygen-enriched supply substantially reduced the amount of foam produced in the bioreactor during ATAB. The reduction in foam, in turn, allowed for more efficient air supply, more consistent bioreactor operation, and a more robust aerobic environment thereby resulting in a substantial reduction in undecomposed organic material and a more stable and cost-efficient final product.

In some embodiments, the animal waste slurry is homogenized in a mixing tank and then transported to a separate aerobic bioreactor for the ATAB step. However, it should be understood that the mixing tank can be adapted to carry out the ATAB step such that the mixing tank and the aerobic bioreactor are the same.

The ATAB conditions described herein allow for the growth and enrichment of several thermophilic and mesophilic microorganisms for use as PGPR. Beneficial thermophilic and mesophilic microorganisms that can be isolated from the animal waste slurry include, but are not limited to, Bacillus sp. (e.g., B. isronensis strain B3W22, B. kokeshiiformis, B. licheniformis, B. licheniformis strain DSM 13, B. paralicheniformis, B. paralicheniformis strain KJ-16), Corynebacterium sp. (e.g., C. efficiens strain YS-314), Idiomarina sp. (e.g., I. indica strain SW104), Oceanobacillus sp. (e.g., O. caeni strain S-11), Solibacillus sp. (e.g., S. silvestris strain HR3-23), Sporosarcina sp. (e.g., S. koreensis strain F73, S.luteola strain NBRC 105378, S. newyorkensis strain 6062, S. thermotolerans strain CCUG 53480), and Ureibacillus sp. (e.g., U. thermosphaericus). In turn, these bacteria produce various phytohormones and other secondary metabolites that function as plant growth regulators as summarized in Table 3 below.

TABLE 3
Phytohormones/secondary metabolites and their function

| Category | Name | Function - Literature |
|---|---|---|
| Hormone | Indole-acetic Acid | Induces cell elongation and cell division supporting |
| | | plant growth and development |
| Hormone | Gibberellin GA1 | stimulate stem elongation, germination, and flowering |
| Hormone | Gibberellin GA12 | stimulate stem elongation, germination, and flowering |
| Hormone | Gibberellin GA20 | stimulate stem elongation, germination, and flowering |
| Hormone | Gibberellin GA51 | stimulate stem elongation, germination, and flowering |
| Hormone | Gibberellin GA53 | stimulate stem elongation, germination, and flowering |
| jasmonate | 12-oxophytodienoic | Promotes plant wound healing and induces resistance to |
| metabolite | Acid | pathogens and pests |
| Hormone | Jasmonic Acid | Signals in resistance to certain bacterial and fungal |
| | | pathogens and against insect and nematode pests |
| Hormone | Salicylic Acid | Critical for plant defense against broad spectrum of |
| | | pathogens. SA is also involved in multi-layered |
| | | defense responses |
| metabolite | Indole 3-acetyl- | Stimulates root production and elongation; Indole-3- |
| | aspartic Acid | acetyl-L-aspartic acid is a naturally occurring auxin |
| | | conjugate that regulates free IAA levels in various plant |
| | | species |
| formal | Jasmonyl Isoleucine | Stimulates plant defensive mechanisms against |
| condensation | | herbivore and pathogen attack |
| of carboxy | | |
| group of | | |
| (3R)-jasmonic | | |
| acid with | | |
| the amino | | |
| group of L- | | |
| isoleucine | | |
| Hormone | Abscisic Acid | Functions in many plant developmental processes, |
| | | including protection of buds during dormancy; a plant |
| | | hormone which promotes leaf detachment, induces seed |
| | | and bud dormancy, and inhibits germination |
| α-amino | Pipecolinic Acid | Regulates plant systemic acquired resistance and basal |
| acids | | immunity to bacterial pathogen infection |
| Wound | Traumatic Acid | stimulates cell division near a trauma site to form a |
| healing | | protective callus and to heal the damaged tissue |
| agent | | |
| Hormone | 3-Indolepropionic Acid | Plant hormone with numerous cell growth functions |
| (auxin) | | including cell division, elongation, autonomal loss of |
| | | leaves, and the formation of buds, roots, flowers, and |
| | | fruit. |
| Hormone | Indole 3 acetate | Induces cell elongation and cell division supporting |
| (auxin) | | plant growth and development |
| main | 5-hydroxy-3- | phytoserotonin serves many functions including |
| metabolite | indoleacetic | modulation of plant growth and development, |
| of serotonin | | photosynthesis, reproduction, and responses to biotic |
| | | and abiotic stress |
| | 6-hydroxynictinic acid | a versatile building block chiefly in the synthesis of |
| | | modern insecticides |
| Enzyme | galactinol | accumulates in plant in response to bacterial |
| | | inoculation, is involved in the induced systemic |
| | | resistance to phytopathogens |
| Vitamin B5 | Panthothenic acid | Cell metabolism cofactor |
| Metabolite | Citramalic acid | Soil Phosphorus solubilization |
| of yeast | | |
| D-enantiomer | D-Leucine | biosynthesis of proteins |
| of Leucine | | |

In one aspect, a well configured oxygen supply system should maintain dissolved oxygen levels of between about 1 mg/L and about 8 mg/L, e.g., about 1, 1.1, 1.2, 1.3, 1.4, 1.5, 1.6, 1.7, 1.8, 1.9, 2, 2.1, 2.2, 2.3, 2.4, 2.5, 2.6, 2.7, 2.8, 2.9, 3, 3.1, 3.2, 3.3, 3.4, 3.5, 3.6, 3.7, 3.8, 3.9, 4, 4.1, 4.2, 4.3, 4.4, 4.5, 4.6, 4.7, 4.8, 4.9, 5.0, 5.1, 5.2, 5.3, 5.4, 5.5, 5.6, 5.7, 5.8, 5.9, 6.0, 6.1, 6.2, 6.3, 6.4, 6.5, 6.6, 6.7, 6.8, 6.9, 7.0, 7.1., 7.2, 7.3, 7.4, 7.5, 7.6, 7.7, 7.8, 7.9. or 8.0 mg/L. In a preferred embodiment, the oxygen supply system should maintain dissolved oxygen levels of between about 2 mg/L and about 6 mg/L; more preferably, between about 3 mg/L and about 4 mg/L. In certain embodiments, oxygenation of the bioreaction is measured in terms of oxidation-reduction potential (ORP). Typically, the ORP of the bioreaction is maintained between about −580 mV to about +70 mV. More particularly, it is maintained within a range of between −250 mV and +50 mV; more preferably, it is maintained within a range of between −200 mV and +50 mV.

To monitor the temperature, pH, and oxygenation parameters of the ATAB, the bioreactor can be equipped with automated controllers to control such parameters. In some embodiments, the bioreactor is equipped with a programmable logic controller (PLC) that effectively controls pH, ORP, and other parameters by adjusting oxygen air supply and feed rate of a pH adjuster to the bioreactor. In fact, the delivery of oxygen to any of the process steps disclosed herein can be controlled using a PLC in this manner.

### Optional Separation and Formulation

The digested animal waste composition after the ATAB can be further processed to produce a general-purpose emulsified biofertilizer or a separated solid biofertilizer and liquid biostimulant. For production of the general-purpose emulsified biofertilizer, the digested animal waste composition is pumped from the ATAB bioreactor(s) and emulsified, cooled, and stored. The emulsifying can be carried out using art standard means. For instance, in one embodiment, the digested animal waste composition is processed through a colloidal emulsifier. Likewise, the cooling can be facilitated by any art standard means, such as by way of a heat exchanger. The digested animal waste composition is cooled to a temperature in the range from about 25° C. to about 45° C., e.g., 25° C., 26° C., 27° C., 28° C., 29° C., 30° C., 31° C., 32° C., 33° C., 34° C., 35° C., 36° C., 37° C., 38° C., 39° C., 40° C., 41° C., 42° C., 43° C., 44° C., or 45° C.; preferably from about 30° C. to about 40° C. For instance, in one embodiment, the digested animal waste composition is cooled to about 35° C. Further, the pH is adjusted to a pH of about 5 to about 6.5; preferably, the pH is about 5.5. Suitable acids for pH adjustment include formic acid (methanoic acid), acetic acid (ethanoic acid), propionic acid (propanoic acid), butyric acid (butanoic acid), valeric acid (pentanoic acid), caproic acid (hexanoic acid), oxalic acid (ethanedioic acid), lactic acid (2-hydroxypropanoic acid), malic acid (2-hydroxybutanedioic acid), citric acid (2-hydroxypropane-1,2,3-tricarboxylic acid), and benzoic acid (benzenecarboxylic acid). Preferably, the acid is citric acid. In another embodiment, the digested animal waste composition can be stabilized with humic acid.

In some embodiments, it is desired to separate the digested animal waste composition into a substantially solid component and a substantially liquid component. Thus, following ATAB, the digested animal waste composition is pumped from the bioreactor(s) to a separation system (e.g., a centrifuge or belt filter press) for the next step of the process. The solid-liquid separation system can include, but is not limited to, mechanical screening or clarification. Suitable separation systems include centrifugation, filtration (e.g., via a filter press), vibratory separator, sedimentation (e.g., gravity sedimentation), and the like. In some embodiments, a two-step separation system may be used, e.g., a centrifugation step followed by a vibratory screen separation step.

In a non-limiting exemplary embodiment, the method employs a decanter centrifuge that provides a continuous mechanical separation. The operating principle of a decanter centrifuge is based on gravitational separation. A decanter centrifuge increases the rate of settling through the use of continuous rotation, producing a gravitational force between 1,000 to 4,000 times that of a normal gravitational force. When subjected to such forces, the denser solid particles are pressed outwards against the rotating bowl wall, while the less dense liquid phase forms a concentric inner layer. Different dam plates are used to vary the depth of the liquid as required. The sediment formed by the solid particles is continuously removed by the screw conveyor, which rotates at different speed than the bowl. As a result, the solids are gradually “ploughed” out of the pond and up the conical “beach”. The centrifugal force compacts the solids and expels the surplus liquid. The compacted solids then discharge from the bowl. The clarified liquid phase or phases overflow the dam plates situated at the opposite end of the bowl. Baffles within the centrifuge casing direct the separated phases into the correct flow path and prevent any risk of cross-contamination. The speed of the screw conveyor can be automatically adjusted by use of the variable frequency drive (VFD) in order to adjust to variation in the solids load. In some embodiments, polymers may be added to the separation step to enhance separation efficiency and to produce a drier solids product. Suitable polymers include polyacrylamides, such as anionic, cationic, nonionic, and Zwitterion polyacrylamides.

Thus, the separation process results in formation of a substantially solid component and a substantially liquid component of the digested animal waste composition. The term “substantially solid” will be understood by the skilled artisan to mean a solid that has an amount of liquid in it. In particular embodiments, the substantially solid component may contain, e.g., from about 40% to about 64% moisture, often between about 48% and about 58% moisture, and is sometimes referred to herein as “solid,” “cake,” or “wet cake.” Likewise, the term “substantially liquid” will be understood to mean a liquid that has an amount or quantity of solids in it. In particular embodiments, the substantially liquid component may contain between about 2% and about 15% solids (i.e., between about 85% and about 98% moisture), often between about 4% and about 7% solids, and is sometimes referred to herein as “liquid,” “liquid component,” or “centrate” (the latter if the separation utilizes centrifugation).

The substantially solid component may be stabilized to produce the biomass/biofertilizer product by adjusting the pH to a pH of about 5 to about 6.5; preferably, the pH is about 5.5. Suitable acids for pH adjustment include formic acid (methanoic acid), acetic acid (ethanoic acid), propionic acid (propanoic acid), butyric acid (butanoic acid), valeric acid (pentanoic acid), caproic acid (hexanoic acid), oxalic acid (ethanedioic acid), lactic acid (2-hydroxypropanoic acid), malic acid (2-hydroxybutanedioic acid), citric acid (2-hydroxypropane-1,2,3-tricarboxylic acid), and benzoic acid (benzenecarboxylic acid). Preferably, the acid is citric acid. In another embodiment, the solid biofertilizer can be stabilized with humic acid. Importantly, performing the separation after ATAB produces a solid biofertilizer with metabolic compounds leading to enhanced biostimulant activity as compared to a separated solid biofertilizer product without having been subjected to ATAB. Finally, the final solid biofertilizer is supplemented with additional organic nutrients as described below. In some embodiments, the final solid biofertilizer product is further dried/dehydrated at low temperature to preserve the microbial and biostimulatory components and facilitate storage and handling/shipping (lower weight without water). For instance, the substantially solid component typically has a moisture content of between about 40% about 75%, preferably between about 55% and about 65%, following the separation step. The substantially solid component is subjected to dehydration at a temperature of less than about 100° C. (e.g., 60° C., 65° C., 70° C., 75° C., 80° C., 85° C., 90° C., or 99° C.) for a period of time ranging from about 15 minutes to about 6 hours or until the final moisture content of the final solid biofertilizer is about 10% to about 20%. Suitable dehydration apparatus include, but are not limited to, a rotary drum, fixed fluid bed, or vacuum drier.

The substantially liquid component can be further processed (e.g., cooled and acidified) to produce a liquid biostimulant. As with the general-purpose product discussed above, the cooling of the substantially liquid component can be facilitated by any art standard means, such as by way of a heat exchanger. The substantially liquid component is cooled to a temperature in the range from about 25° C. to about 45° C., e.g., 25° C., 26° C., 27° C., 28° C., 29° C., 30° C., 31° C., 32° C., 33° C., 34° C., 35° C., 36° C., 37° C., 38° C., 39° C., 40° C., 41° C., 42° C., 43° C., 44° C., or 45° C.; preferably from about 30° C. to about 40° C. For instance, in one embodiment, the substantially liquid component is cooled to about 35° C. Further, the pH may be adjusted to a pH of about 5 to about 6.5; preferably, the pH is about 5.5. Suitable acids for pH adjustment include formic acid (methanoic acid), acetic acid (ethanoic acid), propionic acid (propanoic acid), butyric acid (butanoic acid), valeric acid (pentanoic acid), caproic acid (hexanoic acid), oxalic acid (ethanedioic acid), lactic acid (2-hydroxypropanoic acid), malic acid (2-hydroxybutanedioic acid), citric acid (2-hydroxypropane-1,2,3-tricarboxylic acid), and benzoic acid (benzenecarboxylic acid). Preferably, the acid is citric acid. In another embodiment, the substantially liquid component can be stabilized with humic acid. Finally, the final liquid biostimulant composition may be supplemented with additional organic nutrients as described below.

The base products (i.e., the general-purpose emulsified biofertilizer, solid biofertilizer, and the liquid biostimulant) can also be further formulated to produce products, sometimes referred to herein as “formulated products,” “formulated compositions,” and the like, for particular uses. In certain embodiments, additives include macronutrients, such as nitrogen and potassium. Products formulated by the addition of macronutrients such as nitrogen and potassium are sometimes referred to as “formulated to grade,” as would be appreciated by the person skilled in the art. In exemplary embodiments comprising a bio-organic nutritional composition prepared from chicken manure, the base composition is formulated to contain about 1.5% to about 3% nitrogen and about 3 to 5% potassium to produce a biofertilizer product suitable for use in the either the organic or the conventional agriculture industry. For conventional agriculture use only, an exemplary embodiment may comprise a base composition formulated to contain about 7% nitrogen, about 22% phosphorus, and about 5% zinc for use as a starter fertilizer to optimize plant growth and development.

In other embodiments, additives include one or more micronutrients as needed or desired. Though the base composition already contains a wide range of micronutrients and other beneficial substances as described in detail below, it is sometimes beneficial to formulate the composition with such additives. Suitable additives for both organic and conventional agriculture include, but are not limited to, blood meal, seed meal (e.g., soy isolate), bone meal, feather meal, humic substances (humic acid, fulvic acid, humin), microbial inoculants, sugars, micronized rock phosphate and magnesium sulfate, to name a few. For conventional agriculture only, suitable additives may also include, but are not limited to, urea, ammonium nitrate, UAN-urea and ammonium nitrate, ammonium polyphosphate, ammonium sulfate, and microbial inoculants. Other materials that are suitable to add to the base product will be apparent to the person of skill in the art.

In some embodiments, the materials added to the base composition are approved for use in conventional farming only. In other embodiments, the materials added to the base composition are themselves approved for use in an organic farming program, such as the USDA NOP, and can thus be used in conventional, organic, or regenerative farming programs. In particular embodiments, nitrogen is added in the form of sodium nitrate, particularly Chilean sodium nitrate approved for use in organic farming programs. In other embodiments, potassium is added as potassium sulfate. In yet other embodiments, potassium is added as potassium chloride, potassium magnesium sulfate, and/or potassium nitrate. In specific embodiments, the base composition may be formulated to grade either as 1.5-0-3 or 3-0-3 (N-P-K) by adding sodium nitrate and potassium sulfate. Alternatively, the base composition may be formulated to grade as 0-0-5-2S (N-P-K) by adding potassium sulfate for use by both conventional and organic farmers.

The base composition can be formulated any time after it exits the bioreactor (or, in the case of the specialty liquid biostimulant and solid biofertilizer products, after they are separated, e.g., exit the centrifuge) and before it is finished for packaging. In one embodiment, the product is formulated with macronutrients prior to any subsequent processing steps. In this embodiment, the product stream is directed into a formulation product receiving vessel where the macronutrients are added. Other materials can be added at this time, as desired. The formulated product receiver can be equipped with an agitation system to ensure that the formulation maintains the appropriate homogeneity.

In some embodiments, the based products are directed into storage tanks, which may be equipped with pH and temperature controls and/or an agitation system. In particular embodiments, the storage tanks may also be equipped with an oxygen supply system. In such embodiments, the post ATAB general-purpose emulsified biofertilizer and/or the post separation liquid biostimulant, are kept under aerobic conditions by injecting pure oxygen or oxygen enriched air at a rate of from about 0.1 CFM to about 3 CFM per 10,000 gallons of liquid, e.g., 0.1, 0.2, 0.3, 0.4, 0.5, 0.6, 0.7, 0.8, 0.9, 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, or 3.0 CFM per 10,000 gallons of liquid. Preferably, the pure oxygen or oxygen-enriched air is delivered to the post ATAB liquid product at about 0.25 CFM to about 1.5 CFM per 10,000 gallons of liquid, more preferably at about 0.5 CFM per 10,000 gallons of liquid. In some embodiments, the oxygen is delivered via a plurality of spargers such as those described above. By keeping the post ATAB product under aerobic conditions, the formation of anaerobic compounds is avoided.

Prior to packaging and/or shipping the fluid compositions discussed above (i.e., the general purpose emulsified biofertilizer or the liquid biostimulant) can also be subjected to one or more filtration steps to remove suspended solids. The solids retained by such filtration processes can be returned to the manufacturing process system, e.g., to the aerobic bioreactor.

Filtration can involve various filter sizes. In certain embodiments, the filter size is 100 mesh (149 microns) or smaller. More particularly, the filter size is 120 mesh (125 microns) or smaller, or 140 mesh (105 microns) or smaller, or 170 mesh (88 microns) or smaller, or 200 mesh (74 microns) or smaller, or 230 mesh (63 microns) or smaller, or 270 mesh (53 microns) or smaller, or 325 mesh (44 microns) or smaller, or 400 mesh (37 microns) or smaller. In particular embodiments, the filter size is 170 mesh (88 microns), or 200 mesh (74 microns), or 230 mesh (63 microns), or 270 mesh (53 microns). In certain embodiments, a combination of filtration steps can be used, e.g., 170 mesh, followed by 200 mesh, or 200 mesh followed by 270 mesh filtrations.

Filtration is typically carried out using a vibratory screen, e.g., a stainless mesh screen, drum screen, disc centrifuge, pressure filter vessel, belt press, or a combination thereof. Filtration typically is carried out on products cooled to ambient air temperature, i.e., below about 28° C.-30° C.

Packaging of the finished product can include dispensing the product into containers from which the material can be poured. In certain embodiments, filled containers may be sealed with a membrane cap (“vent cap,” e.g. from W. L. Gore, Elkton, MD) to permit air circulation in the headspace of the containers. These membranes can be hydrophobic and have pores small enough that material cannot leak even in the event the containers are completely inverted. Additionally, the pores can be suitably small (e.g., 0.2 micron) to eliminate the risk of microbial contamination of the container contents.

### Compositions:

As already mentioned in detail above, the process described herein can be carried out to produce three useful compositions from animal waste. As mentioned above, an emulsified biofertilizer composition can be produced by subjecting the animal waste slurry to ATAB, followed by emulsification and cooling. Alternatively, the digested animal waste composition is subjected to a further separation step to produce a substantially solid component and a substantially liquid component, can be referred to herein as the solid biofertilizer composition and liquid biostimulant composition, respectively. The process steps employed to produce these three products are described in detail above. Each of the resulting compositions will have a pH of about 5 to about 6.5, e.g., about 5 to about 6, or about 5.5 to about 6; preferably, the pH is about 5.5.

The base products (i.e., the general-purpose emulsified biofertilizer, solid biofertilizer, and the liquid biostimulant) produced by the methods described herein include a significant increase in nutrients, minerals, and microorganisms beneficial to plant health/growth and soil health as compared to existing biofertilizer/biostimulant products, including biofertilizers produced from subjecting animal waste to ATAB that existed in the art prior to the innovative process described above. As discussed in more detail elsewhere herein, the present method allows for subjecting an emulsified slurry of animal waste to ATAB prior to separation to enable the production of both a liquid biostimulant composition and a solid biofertilizer composition that contain increased plant beneficial nutrients and microorganisms. Surprisingly, the liquid biostimulant composition produced by the instant method comprises increased macronutrients and microorganisms even as compared to existing liquid biostimulants produced using ATAB techniques. The plant-promoting macro/micronutrient and microorganism content of the present bionutritional compositions will now be described in additional detail.

For instance, the compositions described herein will contain at least one phytohormone or metabolite group selected from the group consisting of indole-acetic acid, gibberellin GA1, gibberellin GA12, gibberellin GA20, gibberellin GA51, gibberellin GA53, 12-oxophytodienoic acid, Jasmonic acid, salicylic acid, indole 3-acetyl-aspartic acid, Jasmonyl isoleucine, abscisic acid, pipecolinic acid, traumatic acid, 3-indolepropionic acid, indole 3 acetate, 5-hydroxy-3-indoleacetic, 6-hydroxynictinic acid, galactinol, panthothenic acid, citramalic acid, and D-Leucine. In one embodiment, the compositions described herein will have one or more phytohormone or metabolites, such as, but not limited to, N-acetylhistamine, L-Valine, tetramethyl-2,5-dihydro-1H-pyrrole-3-carboxamide, 1-(4-aminobutyl) urea, isopelletierine, 1-(4-aminobutyl) urea, 3-amino-2-piperidinone, acetophenone, L-alanyl-L-proline, Alanine-Proline dipeptide, Proline-Proline dipeptide, uric acid, methylguanidine, 3-hydroxy-2-methylpyridine, δ-valerolactam, O-ureido-D-serine, nicotinyl alcohol, (R,S)-anatabine, carnitine, 10-nitrolinoleate, N-methylhexanamide, N6-methyl lysine, dehydroascorbic acid, glutamic acid, malic acid, N-acetyl-L-glutamic acid, Serine-Serine dipeptide, moniliformin, cinnamic acid, citric acid, nicotinamide, chrysin, juvabione, orotic acid, resolvin D1, diprogulic acid, curacin A, putrescine, abscisic acid, dihydroxyphenylalanine, anticapsin, prohydrojasmon, 2-methylcitric acid, 1,3-nonanediol acetate, 2-O-ethyl ascorbic acid, Leucine-Leucine dipeptide, vitamin C, 3-sulfolactic acid, 4-nitrocatechol, and/or itaconic acid. The phytohormone or metabolites herein may be quantified by suitable techniques in the art. For instance, the metabolites may be detected and quantified by hydrophilic interaction liquid chromatography (HILIC) followed by mass spectroscopy and measured by peak area percentage in either positive mode or negative mode. The phytohormone or metabolites detected and quantified in positive mode may include, but are not limited to, one or more of N-acetylhistamine, L-Valine, tetramethyl-2,5-dihydro-1H-pyrrole-3-carboxamide, 1-(4-aminobutyl) urea, isopelletierine, 1-(4-aminobutyl) urea, 3-amino-2-piperidinone, acetophenone, L-alanyl-L-proline, Alanine-Proline dipeptide, Proline-Proline dipeptide, uric acid, methylguanidine, 3-hydroxy-2-methylpyridine, 8-valerolactam, O-ureido-D-serine, nicotinyl alcohol, (R,S)-anatabine, carnitine, 10-nitrolinoleate, N-methylhexanamide, and/or N6-methyl lysine. The phytohormone or metabolites detected and quantified in negative mode may include, but are not limited to, one or more of dehydroascorbic acid, glutamic acid, malic acid, N-acetyl-L-glutamic acid, Serine-Serine dipeptide, moniliformin, cinnamic acid, citric acid, nicotinamide, chrysin, juvabione, orotic acid, resolvin D1, diprogulic acid, curacin A, putrescine, abscisic acid, dihydroxyphenylalanine, anticapsin, prohydrojasmon, 2-methylcitric acid, 1,3-nonanediol acetate, 2-O-ethyl ascorbic acid, Leucine-Leucine dipeptide, vitamin C, 3-sulfolactic acid, 4-nitrocatechol, and/or itaconic acid. The peak area of any of the above phytohormone or metabolites may be at least about 1×10³, preferably, the peak area will be at least about 1×10⁴, more preferably, at least about 1×10⁵, or at least about 1×10⁶, or at least about 1×10⁷, or at least about 1×10⁸. In other aspects, the biofertilizer or biostimulant products produced herein will contain at least two phytohormones or metabolites, preferably, they will contain at least three phytohormones or metabolites or at least four phytohormones or metabolites.

In addition, the bionutritional compositions described herein will contain a high concentration of macro and micronutrients beneficial for plant and soil health. For instance, a typical but non-limiting example of the chemical composition of the liquid biostimulant composition produced by the above-described process will have a macronutrient content of at least about 5% dry wt Total Kjeldahl Nitrogen (TKN), e.g., 5%, 6%, 7%, 8%, 9%, 10%, 11%, 12%, 13%, 14%, 15%, or more TKN; or of at least about 5% dry wt ammoniacal nitrogen, e.g., 5%, 6%, 7%, 8%, 9%, 10%, 11%, 12%, 13%, 14%, 15%, or more ammoniacal nitrogen; or of at least about 3% dry wt organic nitrogen, e.g., 3%, 4%, 5%, 6%, 7%, 8%, 9%, 10%, or more organic nitrogen; or of at least about 1.5% by wt total carbon, e.g., 1.5%, 1.6%, 1.7%, 1.8%, 1.9%, 2.0%, 2.1%, 2.2%, 2.3%, 2.4%, 2.5%, or more total carbon; or of at least about 5% dry wt potassium, e.g., 5%, 6%, 7%, 8%, 9%, 10%, or more potassium; or of at least about 0.5% dry wt sulfur, e.g., 0.5%, 0.6%, 0.7%, 0.8%, 0.9%, 1.0%, 1.1%, 1.2%, or more sulfur; or of at least about 2% dry weight calcium, e.g., 2%, 3%, 4%, 5%, or more calcium; or of at least about 0.5% dry wt magnesium, e.g., 0.5%, 0.6%, 0.7%, 0.8%, 0.9%, 1.0%, or more magnesium; or of at least about 5% dry weight potash (K₂O), e.g., 5%, 6%, 7%, 8%, 9%, 10%, 11%, 12%, 13%, 14%, 15% or more potash. In other embodiments, the liquid biostimulant composition produced by the above-described process will have less than about 6% dry wt P₂O₅, e.g., 6%, 5%, 4%, 3%, 2%, 1%, or less P₂O₅. In preferred embodiments, the liquid biostimulant composition will have a macronutrient content of at least about 12% dry wt TKN, and/or at least about 4% dry wt organic nitrogen, and/or at least about 9% dry wt ammoniacal nitrogen, and/or at least about 10% dry wt potash, and/or at least about 2% by wt total carbon, and/or less than about 5% dry wt P₂O₅. Advantageously, the liquid biostimulant composition will have very little phosphate (P₂O₅), which is helpful in instances where phosphate excess in soil or phosphate runoff is of concern.

The liquid biostimulant composition produced herein may have a micronutrient content of at least about 0.1% dry wt iron, or of at least about 0.04% dry wt manganese, or of at least about 0.05% dry wt zinc, and/or of at least about 0.008% dry wt copper.

The solid biofertilizer compositions produced by the present method will also comprise increased macronutrients and micronutrients that are beneficial to plant growth/health and soil health. For example, a typical but non-limiting example of the chemical composition of the solid biofertilizer composition produced by the above-described process will have a macronutrient content of at least about 4% dry wt Total Kjeldahl Nitrogen (TKN), e.g., 4%, 5%, 6%, 7%, 8%, 9%, 10%, or more TKN; or of at least about 3% dry wt ammoniacal nitrogen, e.g., 3%, 4%, 5%, 6%, 7%, 8%, 9%, 10%, or more ammoniacal nitrogen; or of at least about 1% dry wt organic nitrogen, e.g., 1%, 2%, 3%, 4%, 5%, 6%, 7%, 8%, or more organic nitrogen; or of at least about 1.5% by wt total carbon, e.g., 1.5%, 1.6%, 1.7%, 1.8%, 1.9%, 2.0%, 2.1%, 2.2%, 2.3%, 2.4%, 2.5%, or more total carbon; or of at least about 2% dry wt potassium, e.g., 2%, 3%, 4%, 5%, 6%, 7%, or more potassium; or of at least about 0.3% dry wt sulfur, e.g., 0.3%, 0.4%, 0.5%, 0.6%, 0.7%, 0.8%, 0.9%, 1.0%, or more sulfur; or of at least about 8% dry weight calcium, e.g., 8%, 9%, 10%, 11%, 12%, 13%, 14%, 15%, or more calcium; or of at least about 0.5% dry wt magnesium, e.g., 0.5%, 0.6%, 0.7%, 0.8%, 0.9%, 1.0%, 1.1%, 1.2%, 1.3%, 1.4%, 1.5%, or more magnesium; or of at least about 2% dry weight potash (K₂O), e.g., 2%, 3%, 4%, 5%, 6%, 7%, 8%, 9%, 10%, 11%, 12% or more potash. In other embodiments, the solid biofertilizer composition produced by the above-described process will have less than about 8% dry wt P₂O₅, e.g., 8%, 7%, 6%, 5%, 4%, 3%, 2%, 1%, or less P₂O₅. In preferred embodiments, the solid biofertilizer composition will have a macronutrient content of at least about 7% dry wt TKN, and/or at least about 2% dry wt organic nitrogen, and/or at least about 4% dry wt ammoniacal nitrogen, and/or at least about 3% dry wt potash, and/or at least about 2% by wt total carbon, and/or less than about 8% dry wt P₂O₅.

The solid biofertilizer composition produced herein may have a micronutrient content of at least about 0.2% dry wt iron, or of at least about 0.07% dry wt manganese, or of at least about 0.08% dry wt zinc, and/or of at least about 0.01% dry wt copper.

It should be understood that the bionutritional compositions of the present invention endogenously contain the above-described macro and micronutrients. In other words, the macronutrient and micronutrient content is present in the base compositions after the manufacturing process without the need for exogenous supplementation or amendment.

In addition to their macro- and micronutrient chemical composition, the bionutritional compositions produced by the above-described process will have increased biomass content compared to existing bioorganic fertilizers and biostimulants, which biomass includes various microbial species known to benefit plants and soils. For instance, the compositions include the following classes of organisms as assessed by standard measuring techniques, e.g., phospholipid fatty acid analysis (PFLA): Actinobacteria (Actinomycetes), Gram negative bacteria, Gram positive bacteria, fungi, arbuscular mycorrhizal fungi, and protists. The microbial communities of the compositions after subjection to ATAB will tend to have a high concentration of Gram positive bacteria, which are much larger in size, have thicker cell walls, negative charges on the outside cell wall surface and tend to resist water stress (Dick, R., 2009). Moreover, Gram-positive bacteria are important in such activities as bioremediation, biocontrol, plant growth, symbiotic-mutualistic, commensalistic, trophobiotic interactions, control of soil-borne pathogens, and support of host plant defense against environmental stress (Ryan et al., 2008). Importantly, the compositions of the instant invention will preferably have a Gram positive microbial biomass of at least about 25% of the total biomass in the composition, e.g., about 25%, 30%, 35%, 40%, or more of the total biomass comprising Gram positive bacteria. In more preferred embodiments, the compositions of the instant invention comprise a Gram positive biomass of at least about 30% of the total biomass; most preferably, at least about 35% of the total biomass. In other embodiments, the compositions of the instant invention will have a ratio of Gram positive bacteria to Gram negative bacteria of at least about 10:1, or at least about 15:1.

In addition to certain bacterial biomass, fungi have an important role in plant and soil health related to water dynamics, nutrient cycling, and disease suppression. As such, the bionutritional compositions described herein may include a total fungi biomass of at least about 15%, e.g., 15%, 20%, 25%, 30%, or more of the total biomass in the composition. In a preferred embodiment, the bionutritional compositions will comprise a total biomass that is at least about 20% fungi. In particular, the bionutritional composition may comprise a total biomass that is at least about 10% saprophytic fungi, e.g., 10%, 11%, 12%, 13%, 14%, 15%, 16%, 17%, 18%, 19%, 20%, or more saprophytic fungi. In other embodiments, the compositions will comprise a total biomass that is at least about 20% fungi and at least about 35% Gram positive bacteria. In another example, the compositions will comprise at least about 16% saprophytic fungi. As with the nutrient content, the biomass content of the bionutritional compositions following the manufacturing process described above is endogenously present in the base compositions.

In some embodiments, particular bacteria species beneficial to plant and soil health have been identified in the bionutritional compositions. As discussed elsewhere herein, the ATAB step facilitates the enrichment of certain mesophilic and thermophilic bacteria. Among other advantages, these mesophiles and thermophiles are important for the mineralization of nitrogen, phosphorus and sulfur, increasing the availability of those nutrients to plants. Additionally, some of the bacteria cultivated in the products are also known for their nitrogen fixation (e.g., Rhizobium) and probiotic properties, while others are known as natural pesticides, including but not limited to Bacillus firmus (nematicidal), Bacillus pumilus (fungicidal) and Paenibacillus popilliae (effective against Japanese Beetle larvae). Other thermophiles may include (Ureibacillus spp. (including (J. thermosphaericus), Bacillus spp., Geobacillus spp. (including G. stearothermophilus), Brevibacillus spp., and Paenibacillus spp. Geobacillus species are known generally to degrade hydrocarbons and are therefore useful in environmental remediation; they are known to degrade nitrogen compounds as well. More specifically, (1) G. stearothermophilus can improve waste treatment of metal-polluted water and soil, and can facilitate cellulose breakdown; (2) G. thermoleovorans is known for denitrification; (3) G. thermocaternuiatus can facilitate cadmium ion biosorption; and G. thermodenitrificans is a denitrification organism that reduces NO₃ to NO₂.

Within the genus Bacillus, (1) B. licheniformis can degrade feathers; (2) B. subtilis possesses several beneficial attributes, including biocontrol, plant growth promotion, Sulphur(S) oxidation, phosphorus (P) solubilization and production of industrially important enzymes (amylase and cellulose). Strains of B. subtilis have been shown to inhibit the in vitro growth of the fungi Fusarium oxysporum (25-34%) and Botryodiplodia theobromae (100%), isolated from the postharvest rots of yam (Dioscorea rotundata) tubers. Other than biocontrol, B. subtilis is known to promote root elongation in seedlings up to 70-74% as compared to untreated seeds. B. subtilis is also known to oxidize elemental S to sulfate and has shown distinct P-solubilization activity in vitro. (3) B. pumilus has been shown to be an agricultural fungicide in that of the bacterium on plant roots prevents Rhizoctonia and Fusarium spores from germinating; (4) B. arnyloliquelaciens synthesizes a natural antibiotic protein, barnase, a widely studied ribonuclease that forms a tight complex with its intracellular inhibitor barstar, and plantazolicin, an antibiotic with selective activity against Bacillus anthracis; (5) B. firmus-possesses nematicidal activity and is used to protect roots from nematode infestation when applied directly to the soil, foliar treatment to turf, and as seed treatments (for these uses, B. firmus 1-1582 is classified as a biological nematode suppressant); and (6) B. azotoformans can reduce nitrite to molecular nitrogen.

Members of the genus Ureibacillus are known for their ability to break down soil organic matter and other cellulosic and ligneous material, and to mineralize crop residues. Various isolates of (U. thermosphaericus have been used in biological detoxification.

Species of Brevibacillus are known for their antibiotic properties, with certain species having additional functionality, e.g., (1) some strains of Br. agri are capable of oxidizing carbon monoxide aerobically; (2) Br. Borsteinensis degrades polyethylene; (3) Br. levickii—metabolizes specific amino acids; and (4) Br. thermoruber is involved in reduction of nitrates to nitrites and then to molecular nitrogen.

Various Paenibacillus spp. also produce antimicrobial substances that affect a wide spectrum of micro-organisms such as fungi, soil bacteria, plant pathogenic bacteria and even important anaerobic pathogens as Clostridium botulinum. More specifically, several Paenibacillus species serve as efficient plant growth promoting rhizobacteria (PGPR). PGPR competitively colonize plant roots and can simultaneously act as biofertilizers and as antagonists (biopesticides) of recognized root pathogens, such as bacteria, fungi and nematodes. They enhance plant growth by several direct and indirect mechanisms. Direct mechanisms include phosphate solubilization, nitrogen fixation, degradation of environmental pollutants and hormone production. Indirect mechanisms include controlling phytopathogens by competing for resources such as iron, amino acids and sugars, as well as by producing antibiotics or lytic enzymes. With respect to particular species, (1) P. granivorans dissolves native soil starches; (2) P. cookii is a P solubizer; (3) P. borealis is a nitrogen fixing organism and suppresses soil-borne pathogens; (4) P. popilliae is a bio pesticide effective against Japanese Beetle larvae; and (5) P. chinjuensis is an exopolysaccharide-producing bacterium.

The bionutritional compositions produced by the instant method will comprise one or more of these beneficial microorganisms. For instance, the compositions may comprise one or more Bacillus or Brevibacillus bacterial species. In one embodiment, Bacillus megaterium and Brevibacillus borstelensis are present in the compositions. In another embodiment the compositions comprise one or more Staphylococcus or Micrococcus bacterial species, such as, but not limited to Staphylococcus pasteuri and/or Micrococcus luteus. For instance, in one particular embodiment, a liquid biostimulant composition or solid biofertilizer composition is produced by the above-described method wherein the resulting composition comprises Bacillus megaterium, Staphylococcus pasteuri, Brevibacillus borstelensis, Micrococcus luteus, or any combination thereof.

In another embodiment, the liquid biostimulant composition or solid biofertilizer composition will comprise one of more genera of bacteria that are beneficial to plants and/or soils, such as, but not limited to Bacillus, Geobacillus, Streptomyces, Azobacter, Clostridium, Actinomyces, Azosprillum, and/or Psuedomonas. In some aspect, the liquid biostimulant composition or solid biofertilizer composition will comprise one or more bacterial families that are beneficial to plants and/or soils, such as, but not limited to, Bacillus, Clostridium, Thermoanaerobacter, Pseudomonas, Acidobacterium, Actinomyces, and/or Enterobacteriaceae. These bacterial families may be present in the compositions at a concentration of at least about 1%, e.g., 1%, 2%, 3%, 4%, 5%, 6%, 7%, 8%, 9%, 10%, 15%, 20%, 25%, 30%, 35%, 40%, 45%, 50%, 55%, 60%, by wt or higher. For instance, a liquid biostimulant composition or solid biofertilizer composition produced by the methods described herein may contain Bacillus bacteria in a concentration of at least about 25% by wt, or at least about 30% by wt, or at least about 35% by wt; or contain Clostridium bacteria in a concentration of at least about 25% by wt, or at least about 30% by wt, or at least about 35% by wt; or contain Thermoanaerobacter bacteria in a concentration of at least about 1% by wt, or at least about 2% by wt, or at least about 5% by wt; or contain Pseudomonas bacteria in a concentration of at least about 0.1% by wt; or contain Acidobacterium bacteria in a concentration of at least about 0.05% by wt, or at least about 0.1% by wt; or contain Actinomyces bacteria in a concentration of at least about 1% by wt, or at least about 2% by wt, or at least about 4% by wt; or contain Enterobacteriaceae bacteria in a concentration of at least about 0.5% by wt, or at least about 1% by wt. In another aspect, the liquid biostimulant composition or solid biofertilizer composition will comprise one or more of phyla of bacteria that are beneficial to plants and/or soils, such as, but not limited to, Actinomycetota, Bacteroidetes, Firmiicutes, Proteobacteria, Gammaproteobacteria, Thermotogae, Spirochaetes, Verrucomicrobia, and/or Deinococcus. These bacterial phyla may be present in the compositions at a concentration of at least about 1%, e.g., 1%, 2%, 3%, 4%, 5%, 6%, 7%, 8%, 9%, 10%, 15%, 20%, 25%, 30%, 35%, 40%, 45%, 50%, 55%, 60%, by wt or higher. For instance, a liquid biostimulant composition or solid biofertilizer composition produced by the methods described herein may contain Actinomycetota bacteria in a concentration of at least about 1% by wt, or at least about 2% by wt, or at least about 5% by wt; or contain Bacteriodetes bacteria in a concentration of at least about 0.5% by wt, or at least about 1% by wt, or at least about 1.2% by wt; or contain Firmiicutes bacteria in a concentration of at least about 30% by wt, or at least about 40% by wt, or at least about 50% by wt; or contain Proteobacteria bacteria in a concentration of at least about 1% by wt, or at least about 5% by wt, or at least about 10% by wt; or contain Gammaproteobacteria bacteria in a concentration of at least about 1% by wt, or at least about 2% by wt, or at least about 2.5% by wt; or contain Thermotogae bacteria in a concentration of at least about 0.5% by wt, or at least about 1% by wt, or at least about 2% by wt; or contain Spirochaetes bacteria in a concentration of at least about 0.25% by wt, or at least about 0.5% by wt, or at least about 1% by wt; or contain Verrucomicrobia bacteria in a concentration of at least about 0.25% by wt, or at least about 0.5% by wt.

In some embodiments, bacterial species are detected in the liquid biostimulant composition or solid biofertilizer compositions that are not present in other bionutritional compositions existing in the art. For instance, bacterial species that may be unique to the liquid biostimulant composition or solid biofertilizer composition of the instant invention as compared to bionutritional compositions existing in the art (e.g., as described in WO 2020/028403 A1) include, but are not limited to, Bacillus butanolivorans, Bacillus cellulosilyticus, Bacilus coagulans, Bacillus foraminis, Bacillus thuringiensis, Bacillus polymyxa, Bacillus sp Pc3, Bacillus cereus C1L, Bacillus ligininiphilus, Bacillus aryabhattai, Bacillus glycinifermentans, Bacillus mycoides, Geobacillus kaustophius, Clostridium novyi NT, Clostridium tyrobutyricum, Clostridium indolis, Clostridium sticklandii, Actinomyces howellii, Actinomyces gaoshouyii, Azospirillum thiophilum, Azospirillum brasilense, Azotobacter chroococcum, Streptomyces adustus, Streptomyces aegyptia, and/or Streptomyces amphotericinicus. Moreover, certain bacterial species may be unique to the present compositions that are subjected to differing durations of ATAB. For instance, in one embodiment, the liquid biostimulant composition or solid biofertilizer compositions contain one or more bacteria, such as Bacillus polymyxa, Bacillus ligininiphilus, and/or Bacillus mycoides. Alternatively, the liquid biostimulant composition or solid biofertilizer compositions contain one or more bacteria, such as Azotobacter chroococcum, Bacillus cereus C1L, Geobacillus kaustophius, and/or Streptomyces aegyptia.

Therefore, the bionutritional composition described herein will have increased plant nutrients and other beneficial microorganisms. As shown in the examples below, the liquid biostimulant composition exhibits superior bionutritional qualities as compared to the closest existing liquid biostimulant. Importantly, previous methods utilizing ATAB, such as described in WO 2020/028403 A1, the entire contents of which are incorporated by reference herein, were not capable of producing a solid biofertilizer with the levels of organic biomass and macronutrients present in the solid biofertilizer compositions produced by the method described above.

### Uses:

The compositions (i.e., the emulsified biofertilizer, liquid biostimulant, and solid biofertilizer) resulting from the above-described reaction scheme contain all macronutrients and micronutrients required for plant growth. Application of the bionutritional compositions described herein exhibit enhanced effectiveness in increasing plant growth and improving plant health as compared to other fertilizers currently in use. The compositions can be dried to an appropriate moisture content and used as a soil amendment and/or additive for other fertilizer products.

The solid composition can be applied prior to planting, or as a side dressing, in accordance with known practices. The solid composition could also be emulsified into a suspension and injected into the soil, or spray dried and applied as a powder.

The liquid biostimulant compositions can be formulated in a variety of ways known in the industry, as described above and exemplified herein. For instance, they can be formulated for application to dryland crop systems, field irrigation, drip irrigation, hydroponic and/or other soil-free systems, and turf, among others. They can also be formulated for hydroponic, aeroponic and foliar spray application. They are also formulated for use in various soil-less media, including organic media such as peat moss, composted pine bark, coir and the like, and inorganic media such as sand, vermiculite, perlite, rock wool and the like.

The compositions of the instant disclosure are used to advantage on any plant or crop, including but not limited to angiosperms, gymnosperms, ferns and mosses. These include, but are not limited to: cereals, such as wheat, barley, rye, oats, rice, maize and sorghum; legumes, such as beans, lentils, peas, soybeans, clover and alfalfa; oil plants, such as canola, mustard, poppy, olives, sunflowers, coconut, castor beans, cocoa beans and groundnuts; beet including sugar beet and fodder beet; cucurbits, such as zucchini, cucumbers, melons, pumpkins, squash and gourds; fiber plants, such as cotton, flax, hemp and jute; fruit, such as stone fruit and soft fruit, such as apples, pears, plums, peaches, almonds, cherries, grapes (for direct consumption or for wine production) and berries, e.g., strawberries, raspberries and blackberries; citrus fruit, such as oranges, lemons, grapefruit and mandarins; vegetables, such as spinach, lettuce, asparagus, cabbages, carrots, radishes, onions, tomatoes, potatoes and paprika; trees for lumber or forestation, such as oak, maple, pine and cedar; and also tobacco, nuts, coffee, eggplant, sugar cane, tea, pepper, hops, bananas, natural rubber plants, Cannabis, turfgrasses and ornamentals (e.g., woody perennial, foliage and flower ornamentals, and ornamental grasses).

The compositions also will find utility in non-plant crops, for instance in mushroom culture, wherein they are advantageously applied to substrates such as straw (e.g., cereal straw), enriched sawdust, compost, paper and paper products (e.g., shredded cardboard), plant debris and other organic materials such as seed shells, corncobs, and banana fronds. The compositions can also be formulated for use in culture of algae, including cyanobacteria, which are produced commercially for a variety of purposes. For instance, algae are often cultivated for use as nutritional supplements. Additionally, they are used in photobioreactor systems to recycle flue gas emissions (e.g., carbon dioxide) from operations such as power generating plants.

It is noteworthy that the liquid compositions are aqueous and easy to mix with other aqueous materials and to formulate for drip or spray applications. They have been noted in particular for their ease of use for applications involving spraying or liquid injection, because they tend not to clog machinery like certain oil-based compositions.

In some embodiments, the compositions are formulated to grade, e.g., to provide standardized amounts of macronutrients such as nitrogen and potassium. However, due to their biostimulant content, they have been demonstrated to have a beneficial effect on plants and soils even in the absence of added macronutrients. What is more, the beneficial biostimulants in the compositions enhance the effect of the macronutrients, such that less is needed to produce an equivalent plant growth effect observed with traditional fertilizers. As such, these compositions provide numerous advantages when applied to plants and/or soils, to promote plant growth and health, to deter pests and pathogens, and/or to condition the soil. In addition, the compositions provided herein can be used to remediate damaged soil.

Typical application rates for a liquid biostimulant and solid biofertilizer compositions of substantially the content shown in Table 7 below, formulated to grade at 1.5-0-3 (8.6 lbs/gal) or 3-0-3 (with 1% sulfur, 9.6 lbs/gal), will be understood by the skilled person. Thus, another aspect of the invention features a method of improving plant health or productivity through the application of the above-described compositions to plants, plant parts, seeds and/or soils or other media in which plants are grown. The plant or crop selected for such treatment can be any of those listed above, or any other plant or crop known to the skilled person. Depending on the medium in which the plant is grown, the composition may be applied directly to the plant or indirectly through the growth medium, as described above.

The effect of the composition on the health or productivity of the plant can be observed or measured by any means know in the art. For example, plant health or productivity can be observed or measured by one or more parameters of plant health or productivity, including, but not limited to, germination rate, germination percentage, robustness of germination (e.g., hypocotyl, epicotyl, radicle or cotyledon development), root biomass, plant height, root structure and development, total biomass, stem, leaf or flower size, crop yield, structural strength/integrity, photosynthetic capacity, time to crop maturity, yield quality (e.g., dry matter, starch and sugar content, protein content, appearance, Brix value), resistance or tolerance to stress (e.g., heat, cold, drought, hypoxia, salinity); and resistance or tolerance to pests or pathogens, (e.g., insects, nematodes, weeds, fungi, bacteria and/or viruses). In certain embodiments, plants treated with the compositions of the invention are compared with untreated plants. “Untreated” plants can include plants treated with a “control,” such as water, or plants treated with one or more other compositions, or plants not treated with any compositions. In other embodiments, various parameters of treated plants can be compared with historical measurements for that type of plant in other locations or at other times (e.g., past seasons). Thus, in various embodiments, one or more parameters of growth and/or productivity can be measured between or among the same or an equivalent crop: (a) grown in substantially the same location during the same growing season; or (b) grown in the substantially same location during a different growing season; or (c) grown in a different location during the same growing season; or d) grown in a different location during a different growing season. “The same or equivalent crop” is intended to mean the same plant genus or the same plant species or the same plant subspecies or variety. “Substantially the same location” is intended to mean, for instance, in an adjacent or nearby plot, or in an adjacent or nearby field, or within a defined geographical distance, e.g., closer than one mile apart.

For purposes of such comparison, observations or measurements of parameters of plant health and/or productivity can be made by any convenient or available method, or any combination of methods. These can include, but are not limited to, visual observations, field measurements and laboratory measurements, all of which are familiar to the person skilled in the art.

Another aspect of the invention features a method of conditioning soil, i.e., building and/or improving the quality of soil. This method is particularly applicable to soil in which crops are grown, but alternatively can be applied as a remediation to damaged or polluted soils in which crops are not grown presently.

The condition or quality of soil is composed of inherent and dynamic soil properties. Inherent properties, such as texture, type of clay, depth of bedrock, drainage class and the like, are not affected to a great extent by management efforts. In contrast, dynamic properties or use-dependent properties can change over the course of months and years in response to land use or management practice changes. Dynamic properties include organic matter, soil structure, infiltration rate, bulk density, and water and nutrient holding capacity. Changes in dynamic properties depend both on land management practices and the inherent properties of the soil. Some properties, such as bulk density, may be considered inherent properties below 20-50 cm, but are dynamic properties near the surface.

Thus, deficiencies in dynamic properties of soil can be addressed by management efforts and the compositions of the invention may be used to advantage in this regard. Such deficiencies include, but are not limited to, deficiencies in organic matter, chemical/nutrient deficiencies, microbial content and structural parameters such as lack of porosity (compaction). Measurable soil quality indicators and their functions in agricultural settings include, but are not limited to: aggregate stability, available water capacity, bulk density, infiltration capacity, respiration, slaking and soil crusts, soil structure and macropores, presence and/or quantity of macronutrients and/or micronutrients, and biological content, i.e., total biomass and breakdown of biological communities, e.g., quantity and type of bacteria, fungi, protists and other soil dwellers (insects, nematodes, earthworms and the like).

The compositions can be applied to soil before planting a crop, or they can be applied to soil containing crops or other growths of plants, or they can be applied to soil between plantings, i.e., between growing seasons. In certain embodiments, application rates can be the same as those exemplified above for treatment of plants. Indeed, in this regard, treatment of plants via application to soils also comprises a treatment of the soil itself. In other embodiments, application rates are different from those selected for treatment of plants.

In certain embodiments, soil treated with the compositions of the invention is compared with untreated soil. “Untreated” soil can include soil treated with a “control,” such as water, or soil treated with one or more other compositions, or soil not treated with any compositions. In one embodiment, such comparison comprises “before and after” measurements, or sequential periodic measurements of the soil being treat over a selected time period. In other embodiments, various parameters of treated soils can be compared with historical measurements for that type of soil in other locations or at other times. Thus, in various embodiments, one or more parameters of soil conditioning can be measured between or among the same or an equivalent soil type in substantially the same location or in a different location. “The same or equivalent soil” is intended to mean the same or similar soil type, and/or a different soil type with a similar deficiency. “Substantially the same location” is intended to mean, for instance, in an adjacent or nearby plot, or in an adjacent or nearby field, or within a defined geographical distance, e.g., closer than one mile apart.

For purposes of such comparison, observations or measurements of parameters of soil condition or quality can be made by any convenient or available method, or any combination of methods. These can include, but are not limited to, visual observations, field measurements and laboratory measurements, all of which are familiar to the person skilled in the art.

In one embodiment, the compositions described herein are applied to soil at a rate of about 1 gal/ac to about 20 gal/ac, e.g., 1 gal/ac, 2 gal/ac, 3 gal/ac, 4 gal/ac, 5 gal/ac, 6 gal/ac, 7 gal/ac, 8 gal/ac, 9 gal/ac, 10 gal/ac, 11 gal/ac, 12 gal/ac, 13 gal/ac, 14 gal/ac, 15 gal/ac, 16 gal/ac, 17 gal/ac, 18 gal/ac, 19 gal/ac, or 20 gal/ac. In a preferred embodiment, the application rate is between about 5 gal/ac and about 10 gal/ac. Soil and/or plant health is then assessed by measuring one or more of bacterial CFU, acid phosphatase activity, plant growth, or other suitable parameter as will be understood by one having ordinary skill in the art. In a preferred embodiment, the soil or plant health will be improved as compared to equivalent soil or plants that are untreated or treated with another bionutritional composition or fertilizer.

### Exemplary Embodiment

A non-limiting exemplary embodiment of the manufacturing process for producing liquid and solid compositions from chicken manure is depicted in FIG. 1. As shown in FIG. 1, the manufacturing process 10 typically begins with raw animal manure 15 being loaded into a mixing tank 25. In some embodiments, the manure is conveyed from a truck transporting the manure to the manufacturing plant from a farm. In a preferred embodiment, the raw manure is chicken manure, such as egg layer chicken manure.

In some embodiments, it is necessary to adjust/stabilize the pH of the raw manure. In other embodiments, the pH of the slurry is adjusted rather than the raw manure, it being understood that, in some instances, the pH of the raw manure and/or the slurry is already within the desired pH range thereby alleviating the need to adjust the pH. As depicted in FIG. 1, the raw manure 15 may be stabilized to a pH of about 5.5 to about 8 (preferably, to a pH of about 6 to about 7) by spraying with citric acid 20 either prior to or while being conveyed into the mixing tank 25. The citric acid binds the natural organic ammonia in raw manure. In the mixing tank 25, the stabilized manure may be mixed with water 35 adequate to elevate the moisture level of the manure composition and produce an animal waste slurry with about 84 wt % to about 88 wt % moisture. For instance, in some embodiments, the mixing tank is fitted with 2-micron sintered stainless steel spargers for delivering pure oxygen. During mixing, pure oxygen 30 (>96%) is injected into the slurry at a rate of 0.25 CFM per 10,000 gallons of slurry. The slurry can then be heated with steam 40 to about 40-65° C. for a minimum of 15 minutes (preferably at least 1-4 hours) to break down the manure into fine particles and then fully homogenized into a slurry for further processing. Additionally, this step activates native mesophilic bacteria. The temperature of the homogenized slurry is elevated to 65° C. for a minimum of 1 hour to ensure pathogen destruction. A heat exchanger 45 is depicted in FIG. 1 and may be included to provide for consistent temperature control during the mixing step. In particular embodiments, this part of the manufacturing process can be segregated from the rest of the system to reduce the risk that processed fertilizer material could be contaminated by raw manure. However, this heating step is optional and can be removed from other embodiments of the process.

In some embodiments, it may be desirable to include additional grit removal or homogenization steps. In such embodiments, the slurry can be pumped to a degritting system 50 and 60, such as a SLURRYCUP degritting system fitted with a Grit Snail dewatering belt escalator (Hydro International, Hillsboro. Oregon. USA). Briefly, the degritting system 50 used two levels of separation and classification to remove grit as small as 75 microns from the animal waste slurry.

The animal slurry is then pumped to the optional step of particle size reduction. In the particular embodiment depicted in FIG. 1, a particle size reducer 70 is used for particle size reduction to produce a homogenized slurry composition. In some embodiments, the particle size reducer is a macerator, such as the commercially available M MACERATOR pump (SEEPEX GmbH). In others, particle size is reduced by processing the homogenized slurry composition in a colloidal mill, such as a colloidal mill fitted with a stator configured to reduce particle size to less than about 1 micron or less was.

After optional degritting and reducing the particle size, the animal slurry is then fed to the to the aerobic bioreactor 80, where native microorganisms were cultivated under thermophilic and aerobic conditions. In the particular embodiment shown in FIG. 1, there are two aerobic bioreactors in series or parallel (extra bioreactors may be installed to increase the production rate). During the incubation, pure oxygen 90 (>96%) is injected into the animal waste slurry. The microorganisms metabolized the organic components of the animal waste slurry into primary and secondary metabolomic byproducts including, but not limited to, plant growth factors, lipids and fatty acids, phenolics, carboxylic acids/organic acids, nucleosides, amines, sugars, polyols and sugar alcohol, and other compounds. Depending on its age, the animal waste slurry can remain in the aerobic bioreactor 80 under gentle agitation (e.g., full turnover occurs about 10 to about 60 times per hour) for a minimum of about 1 day to a maximum of about 14 days. Once the slurry is subjected to oxygen, mesophilic bacteria begin to replicate and initiate decomposition of organic matter, thereby gradually increasing the slurry temperature is a similar manner to the natural composting process. Once the slurry has achieved autothermal status, after approximately 3 to 12 days a uniform minimum temperature suitable for growth of thermophilic microorganisms is maintained. Moreover, hot air 85 can be provided, if necessary, to maintain the minimum temperature of the aerobic bioreaction. In preferred embodiments, the animal waste slurry is kept in the aerobic bioreactor at a temperature of at least about 55° C. (preferably between about 60° C. and about 65° C.) for at least about 72 hours.

While a separate aerobic bioreactor 80 and mixing tank 25 are shown in FIG. 1, the process can be modified for increased efficiency by adapting the mixing tank as an aerobic bioreactor. Such a modification enables the mixing and ATAB steps to be carried out in the same piece of equipment thereby removing a transport step and reducing expenditure of additional time and energy.

As shown in FIG. 1, product from the aerobic bioreactor can be processed in one of two ways. In the first process, the digested/decomposed animal waste composition for the production of a general-purpose emulsified biofertilizer 95 can be 92 processed through a colloidal emulsifier and cooled with a heat exchanger 100. During the further processing and storage 105, the pH of the cooled emulsified biofertilizer 95 can be lowered to stabilize the composition for storage. In some embodiments, humic acid can be added to ensure stabilization, and organic nutrients can be added as needed. Prior to shipping or packaging 115, the emulsified biofertilizer product is typically subjected to filtration 110.

In the second, more preferred process, the digested/decomposed animal waste composition is pumped through a centrifuge 120 to separate the composition into two streams-a substantially liquid component to produce the specialty liquid biostimulant product 130 and a substantially solid component to produce the solid biofertilizer product 125. In a preferred embodiment, centrifuge 120 is a decanting centrifuge (e.g., PANX clarifying centrifuge, Alfa Laval Corporate AB). By performing the digestion step prior to separation, the solid biofertilizer now has metabolic compounds and enriched beneficial microbial biomass as compared to performing the digestion step only on the liquid component after separation. The solid biofertilizer product 125 can be further processed 105 by adjustment of the pH, supplementation of organic nutrients, and/or stabilization via the addition of humic acid. Cooling and drying are not typically necessary and the product can be packaged and shipped without filtration.

The centrifuged liquid (i.e., for production of the liquid biostimulant) can be cooled with a heat exchanger 135 and the pH adjusted to stabilize the composition. Humic acid can also be added to ensure stabilization, and organic nutrients can be added as needed. Prior to shipping or packaging 115, the specialty liquid biostimulant product 130 is typically subjected to microscreen filtration 140.

The following examples are provided to describe the invention in greater detail. They are intended to illustrate, not to limit, the invention.

### Example 1. Production of the Liquid Biostimulant and Solid Biofertilizer Produced by the Invention

To produce the liquid biotimulant and solid biofertilizer products analyzed in the below examples, the following processes were carried out.

### Gen1 Liquid Biostimulant Composition

For comparison of the compositions of the present disclosure with an existing bionutritional composition produced by a previous process, a liquid biostimulant composition was made according to International Publication No. WO 2020/028403 A1, the contents of which are incorporated by reference herein, and is referred to in the below Examples as “Gen1” or the “Gen1 liquid biostimulant. In this process, a liquid component is first separated from an animal waste slurry and then subjected to ATAB. Briefly, raw chicken manure was transferred to a mixing tank and mixed with citric acid and water to form a homogenous animal waste slurry. After adjustment of the moisture level to about 84%-87%, pure oxygen was delivered at a rate of 0.5 CFM. The animal waste slurry was then separated into a substantially liquid stream and substantially sold fraction, and the substantially liquid stream was then subjected to ATAB for a period of about 80 to 200 hours.

### Gen2 Liquid Biostimulant and Solid Biofertilizer

For certain of the Examples below, the liquid biostimulant and solid biofertilizer was produced according to the following protocol. The liquid biostimulant composition and solid biofertilizer compositions produced according to this process are referred to below as “Gen2”, “Gen2 liquid biostimulant”, or “Gen2 solid biofertilizer”.

First, approximately 20 tons of raw egg layer chicken manure containing 50 wt % moisture was fed into a mixing tank. The raw manure was stabilized to a pH of about 7 by spraying with citric acid. Then, water was added to the raw manure to elevate the moisture level of the manure composition and produce an animal waste slurry at about 88 wt % moisture. The mixing tank was fitted with 2-micron sintered stainless steel spargers for delivering pure oxygen. During mixing, pure oxygen (>96%) was injected into the slurry at a rate of 0.25 CFM per 10,000 gallons of slurry. The slurry was then heated with steam to 45° C. for a minimum of 1 hour to break down the manure into fine particles and was fully homogenized into a slurry for further processing. The mixing tank process parameters for the preparation of feedstock material are shown in Table 4.

TABLE 4
Mixing Tank Process Parameters.

| | Range of Operational | | |
|---|---|---|---|
| Process Parameter | Parameters | | Notes |
| Mixing Tank | 3,000 to 4,000 gallons | | Tank Size 5,000 gallons |
| Axial Turbine Mixer | 45 to 60 HZ | 75 to 100% | Spins clockwise, forces |
| | | | material down turns tank |
| | | | over 1 to 3 times per minute |
| Macerator | 45 to 60 HZ | 75 to 100% | Reduces particle size, |
| | | | homogenizes mix |
| Pump | 45 to 60 HZ | 75 to 100% | Pump Size 3 HP, Positive |
| | | | Displacement |
| Mixing Tank pH | 6.5 to 7.0 | | Citric acid addition varies |
| | | | from patch to patch typically |
| | | | 1 to 2% by weight addition |
| Mixing Tank | 40° C. to 65° C. | | Measured by thermowell via |
| Temperature | 60 minutes | | tank penetration |
| Moisture % | 84 to 90% | | Measured by loss of drying |
| Viscosity | 2000 to 3000 CPS | | |
| Heating Method | Direct Steam Injection 3 | | Direct steam injection to |
| | to 8 PSI | | heat the material |
| Oxygenation Method | Direct Pure Oxygen | | Oxygen delivery via 2- |
| | Injection at 0.25 CFM per | | micron sintered stainless |
| | 10,000 gallons | | steel spargers |

HZ, hertz;
HP, horsepower;
CPS, centipoise;
PSI, pounds per square inch;
CFM, cubic feet per minute

Next, the animal slurry was then fed to the to the aerobic bioreactor, where endogenous microorganisms were cultivated under thermophilic and aerobic conditions. While this exemplary process utilized separate mixing tank and aerobic bioreactor, the aerobic bioreactor and the mixing tank may be the same tank. In other words, the ATAB is carried out in the mixing tank. During the incubation, pure oxygen (>96%) was injected into the animal waste slurry at a rate of 1.0 CFM per 1,000 gallons. The animal waste slurry remained in the aerobic bioreactor under gentle agitation (e.g., full turnover occurs about 10 to about 60 times per hour) for about 1 to about 14 days at a uniform minimum temperature of about 55° C. The aerobic bioreactor process parameters are provided in Table 5.

TABLE 5
Bioreactor process parameters

| | Range of | | | |
|---|---|---|---|---|
| | Operational | | | |
| Process Parameter | Parameters | | | Notes |
| Data collection Record | 1 minute to | | | How frequent the PLC records |
| | 30 minutes | | | data |
| Hydraulic Retention time/ | 1 to 14days | | | How long the material resides |
| Residence time of material in | | | | in the bioreactor |
| reactors | | | | |
| Bioreactor Mixing Pump (Hz) | 0 to 60 HZ | 0-100% | 0-750 GPM | 0-750 GPM pump |
| | | | | 15 HP pump |
| Oxygen Delivery | 1.0 CFM per | | | Injection by 2-micron sintered |
| | 1,000 | | | stainless steel spargers |
| | gallons | | | |
| Bioreactor ORP (mV) | −200 to +50 | | | Analytical tool |
| | mV | | | |
| Bioreactor pH | 6.5 to 7.0 | | | Analytical tool |
| Bioreactor Temperature (° C.) | 30 to 75° C. | | | Analytical tool |
| pH peristaltic pump | 0-8 GPH | | | pH adjustment tool ON/OFF |
| | | | | signal processed via 4-20 ma |
| | | | | signal from Bioreactor pH |
| | | | | probe |
| Influent to Bioreactor Pump PSI | 3 to 5 PSI | | | Pressure into the Pump |

CFM, cubic feet per minute,
GPH, gallons per hour;
PSI, pounds per square inch;
Hz, hertz;
ORP, oxidation reduction potential:
PLC, programmable logic controller

The digested/decomposed animal waste slurry was then pumped through a decanter centrifuge (e.g., PANX clarifying centrifuge, Alfa Laval Corporate AB) at a rate of about 100 gpm to separate the composition into a substantially liquid biostimulant and a substantially solid biofertilizer. Suitable centrifuge parameters for the separation of the solid and liquid fractions are shown in Table 6.

TABLE 6
Centrifuge parameters

| Process | Range of Operational | |
|---|---|---|
| Parameter | Parameters | Notes |
| Decanting | 3250 RPM Max | |
| Centrifuge | | |
| Influent volume | 25-30 gallons per minute | Slurry from ATAB being |
| | | pumped into centrifuge |
| Effluent volume | 25% of input manure by | Liquid fraction exiting |
| | weight is extracted as | the centrifuge |
| | finely suspended solids | |
| Solids separation | 75% of input manure by | Solids fraction discharge |
| | weight | |
| Differential | 7 to 12% | |
| Bowl Speed | 2900 to 3250 RPM | |
| Torque Scroll | 10% or less | |

RPM, revolutions per minute

### Gen2-T113, Gen2-T137, and Gen2-T185 Liquid Biostimulant Compositions

In addition to the above product, analysis was conducted on liquid biostimulant compositions produced by the method described above, except with the following adjustments to the protocol to generate liquid biostimulant compositions subjected to different durations of ATAB. Briefly, 600 liters or 158 gallons of slurry with a starting moisture content of 90% by water (or 10% solids) by weight was pumped into an ATAB bioreactor. Further, no citric acid was added to the animal waste slurry or ATAB bioreactor, and the pH remained between 6.5 (starting pH) and 8.4 (final pH). Moisture analyzers were used for solids value. The ATAB bioreactor was equipped with dual mixing impellers and 3 HP motor, such that the agitation shaft penetrated the liquid at a 15 degree angle. A first impeller was placed at the lowest portion of the shaft directly above the gas diffusion bar to facilitate good liquid to gas diffusion, while a second impeller was placed approximately 12 inches below the liquid level to manage potential foam. A speed of drive motor was set at 200 RPM for the duration of the experiment and monitored by variable frequency drive. The headspace temperature and headspace oxygen concentration was monitored for the duration of the testing. The temperature of the headspace was approximately 5 degrees C. cooler than the temperature of the material being processed over time. Further, oxygen concentration was maintained at ambient+1% to insure aerobic conditions at all times. The oxygen sparge rates were variable between 1L and 5L per minute during the duration of the test. The oxygen source was liquid dewar with a pressure set point 50 PSI. Air was sparged at 1 to 5L per minute as well. The air source was 8 gallon compressor set at 50 PSI. The sparging device was a ½ inch of tube with multiple 1/16th holes and positioned 6 inches below impeller in bioreactor.

The ORP was measured by immersed probe and varied from −400 mV to −150 mV during the process, and pH was measured by immersed probe and varied from 6.5 to 8.5 during the process. The temperature was measured by immersed probe and crossed referenced to ORP and pH probe with values ranging from 30 degrees C. to 59 degrees C. during the process. Temperature control was achieved with an immersion chilling tube positioned in the center of the vessel. Facility water was circulated through the interior chamber of the immersion chilling tube to control temperature within 1C of setpoint value.

Liquid biostimulant compositions were collected after 113 hours, 137 hours, and 185 hours of ATAB via top man-way port using slurry collection liquid sampler. These samples are referred to herein as “Gen2-T113”, “Gen2-T137”, and “Gen2-T185”, respectively. Further, 10 core samples were collected from the ATAB and deposited into a 5 gallon bucket and taken to the lab for homogenization and separations. Six 50 mL centrifuge tubes were placed into a swing arm centrifuge unit and spun at 2500 RPM for 120 seconds. The liquid portion was decanted and pH adjusted to pH value 5.4. Finished material was finally shipped for laboratory evaluation.

### Example 2. Chemical Composition of the Liquid Biostimulant and Solid Biofertilizer Bionutritional Compositions

The chemical composition of the Gen2 liquid biostimulant and solid biofertilizer bionutritional compositions produced by the method described above in Example 1 were determined and compared to a slurry centrate control, the Gen1 liquid biostimulant, and a commercial liquid seaweed fertilizer. The results are shown in Table 7.

TABLE 7
Chemical composition of the liquid biostimulant and solid biofertilizer bionutritional compositions.

| | Slurry | | | | Commercial |
|---|---|---|---|---|---|
| | Centrate | Gen 1 Liquid | Gen 2 Liquid | Gen 2 Solid | Liquid |
| | (Control) | Biostimulant | Biostimulant | Biofertilizer | Seaweed |
| Parameter | (% of total) | (% of total) | (% of total) | (% of total) | (% of total) |
| Total Kjeldahl nitrogen (TKN) AR | 0.33 | 0.42 | 0.54 | 0.52 | 0.17 |
| mg/kg | | | | | |
| Total Kjeldahl nitrogen (TKN) DW | 10.70 | 12.90 | 13.90 | 7.4 | 2.00 |
| mg/kg | | | | | |
| Phosphorus (total) AR mg/kg | 0.08 | 0.14 | 0.08 | 0.25 | n.d. |
| Phosphorus (total) DW mg/kg | 2.59 | 4.26 | 2.15 | 3.48 | n.d. |
| Potassium (total) AR mg/kg | 0.31 | 0.30 | 0.36 | 0.23 | n.d. |
| Potassium (total) DW mg/kg | 10.14 | 9.15 | 9.28 | 3.21 | n.d. |
| Sulfur (total) AR mg/kg | 0.03 | 0.04 | 0.04 | 0.03 | 0.11 |
| Sulfur (total) DW mg/kg | 1.10 | 1.20 | 0.93 | 0.47 | 1.29 |
| Calcium (total) AR mg/kg | 0.13 | 0.25 | 0.13 | 1.04 | 0.03 |
| Calcium (total) DW mg/kg | 4.10 | 7.68 | 3.29 | 14.7 | 0.35 |
| Magnesium (total) AR mg/kg | 0.04 | 0.05 | 0.03 | 0.09 | 0.02 |
| Magnesium (total) DW mg/kg | 1.15 | 1.49 | 0.73 | 1.257 | 0.24 |
| Sodium (total) AR mg/kg | 0.04 | 0.04 | 0.05 | 0.03 | 0.37 |
| Sodium (total) DW mg/kg | 1.46 | 1.37 | 1.23 | 0.40 | 4.35 |
| Iron (total) AR mg/kg | 0.005 | 0.005 | 0.004 | 0.016 | n.d. |
| Iron (total) DW mg/kg | 0.148 | 0.143 | 0.113 | 0.225 | n.d. |
| Manganese (total) AR mg/kg | 0.001 | 0.002 | 0.002 | 0.006 | n.d. |
| Manganese (total) DW mg/kg | 0.044 | 0.074 | 0.040 | 0.078 | n.d. |
| Zinc (total) AR mg/kg | 0.002 | 0.003 | 0.002 | 0.006 | n.d. |
| Zinc (total) DW mg/kg | 0.059 | 0.094 | 0.052 | 0.086 | n.d. |
| Nitrate/Nitrite nitrogen AR mg/kg | n.d. | n.d. | n.d. | n.d. | n.d. |
| Nitrate/Nitrite nitrogen DW mg/kg | n.d. | n.d. | n.d. | n.d. | n.d. |
| Barium (total) AR mg/kg | 0.0001 | 0.0001 | 0.0001 | 0.0004 | n.d. |
| Barium (total) DW mg/kg | 0.0021 | 0.0040 | 0.0017 | 0.0057 | n.d. |
| Cadmium (total) AR mg/kg | n.d. | n.d. | n.d. | n.d. | n.d. |
| Cadmium (total) DW mg/kg | n.d. | n.d. | n.d. | n.d. | n.d. |
| Chromium (total) AR mg/kg | n.d. | n.d. | n.d. | n.d. | n.d. |
| Chromium (total) DW mg/kg | n.d. | n.d. | n.d. | n.d. | n.d. |
| Lead (total) AR mg/kg | n.d. | n.d. | n.d. | n.d. | n.d. |
| Lead (total) DW mg/kg | n.d. | n.d. | n.d. | n.d. | n.d. |
| Mercury (total) AR mg/kg | n.d | n.d. | n.d. | n.d. | n.d. |
| Mercury (total) DW mg/kg | n.d. | n.d. | n.d. | n.d. | n.d. |
| Molybdenum (total) AR mg/kg | n.d. | n.d. | n.d. | n.d. | n.d. |
| Molybdenum (total) DW mg/kg | n.d. | n.d. | n.d. | n.d. | n.d. |
| Percent solids AR % | 3.06 | 3.26 | 3.91 | 7.06 | 8.5 |
| pH AR S.U. | 6.2 | 6.7 | 6.3 | 6.1 | 9.8 |
| Phosphate P2O5 (calculated) AR | 0.18 | 0.32 | 0.19 | 0.56 | n.d. |
| mg/kg | | | | | |
| Phosphate P2O5 (calculated) DW | 5.95 | 9.75 | 4.91 | 7.97 | n.d. |
| mg/kg | | | | | |
| Potash K2O (calculated) AR mg/kg | 0.37 | 0.36 | 0.44 | 0.27 | 1.42 |
| Potash K2O (calculated) DW mg/kg | 12.20 | 11.00 | 11.20 | 3.87 | 16.71 |
| Copper (total) AR mg/kg | 0.0004 | 0.0004 | 0.0004 | 7.2000 | n.d. |
| Copper (total) DW mg/kg | 0.0118 | 0.0123 | 0.0090 | 0.0102 | n.d. |
| Arsenic (total) AR mg/kg | n.d. | n.d. | n.d. | n.d. | n.d. |
| Arsenic (total) DW mg/kg | n.d. | n.d. | n.d. | n.d | n.d. |
| Selenium (total) AR mg/kg | n.d. | n.d. | n.d. | n.d. | n.d. |
| Selenium (total) DW mg/kg | n.d. | n.d. | n.d. | n.d. | n.d. |
| Silver (total) AR mg/kg | n.d. | n.d. | n.d. | n.d. | n.d. |
| Silver (total) DW mg/kg | n.d. | n.d. | n.d. | n.d. | n.d. |
| Nickel (total) AR mg/kg | n.d. | n.d. | n.d. | n.d | n.d. |
| Nickel (total) DW mg/kg | n.d. | n.d. | n.d. | n.d. | n.d. |
| Ammoniacal Nitrogen AR mg/kg | 0.179 | 0.308 | 0.362 | 0.336 | n.d. |
| Ammoniacal Nitrogen DW mg/kg | 5.85 | 9.45 | 9.26 | 4.76 | n.d. |
| Organic nitrogen AR % | 0.149 | 0.112 | 0.182 | 0.187 | 0.17 |
| Organic nitrogen DW % | 4.87 | 3.44 | 4.65 | 2.65 | 2 |

AR, as received
DW, dry weight
n.d., not detected

As shown in Table 7, the instant method produces liquid biostimulant and solid biofertilizer bionutritional compositions with increased plant nutrients as compared to the Gen 1 liquid biostimulant and organic seaweed fertilizer. In particular, the present liquid biostimulant composition exhibits a 62% increase in organic matter over the Gen 1 liquid biostimulant. This is important as soil organic matter serves as a reservoir of nutrients for crops, provides soil aggregation, increases nutrient exchange, retains moisture, reduces compaction, reduces surface crusting, and increases water infiltration into soil. Moreover, the liquid biostimulant composition of the present disclosure exhibited a 104% increase in total carbon over the Gen 1 liquid biostimulant. As noted by Judith Schwartz, “[t]he importance of soil carbon—how it is leached from the earth and how that process can be reversed—is the subject of intensifying scientific investigation, with important implications for the effort to slow the rapid rise of carbon dioxide in the atmosphere. Through photosynthesis, a plant draws carbon out of the air to form carbon compounds. What the plant doesn't need for growth is exuded through the roots to feed soil organisms, whereby the carbon is humified, or rendered stable. Carbon is the main component of soil organic matter and helps give soil its water-retention capacity, its structure, and its fertility” [Schwartz, “Soil as Carbon Storehouse: New Weapon in Climate Fight?” in

YaleEnvironment360 available at https://e360.yale.edu/features/soil_as carbon_storehouse_new_weapon_in_climate_fight (Mar. 4, 2014)]. The liquid biostimulant composition also contains increased TKN as compared to the Gen 1 product, and nearly seven times the TKN as compared to the seaweed fertilizer (dry weight). TKN, or total Kjeldahl Nitrogen, is the sum of nitrogen bound in organic substances-nitrogen in ammonia and nitrogen in ammonium. The liquid biostimulant composition exhibited increased organic nitrogen as compared to both the Gen 1 product and the seaweed fertilizer. Therefore, the liquid biostimulant composition produced by the instant method has increased plant nutrients as compared to the closest products in the art.

The solid biofertilizer composition also exhibits large concentrations of TKN, organic nitrogen, total carbon, and other nutrients. As noted above, it was not possible to produce a solid biofertilizer according to the method of WO 2020/028403 A1. Contrary to prior manufacturing processes, the present method subjects a homogenized, emulsified slurry to ATAB prior to separation. Thus, the process described herein produces a solid biofertilizer composition in addition to the liquid biostimulant composition.

Finally, both the liquid biostimulant composition and solid biofertilizer composition contain micronutrients, such as iron, manganese, zinc, copper, and others that are not detectable in the organic seaweed fertilizer. As such, the instant processes are capable of producing an emulsified biofertilizer composition (no separation), a liquid biostimulant composition, and a solid biofertilizer composition suitable for use under the National Organic Program or the FDA Produce Food Safety requirements.

### Example 3. Metabolomic Composition of the Liquid Biostimulant Bionutritional Composition

The metabolomic content of the liquid biostimulant compositions taken after 113 hours of ATAB (“Gen2-T113”), 137 hours of ATAB (“Gen2-T137”), and 185 hours of ATAB (“Gen2-T185”) was determined by Hydrophilic interaction liquid chromatography (HILIC) followed by mass spectrometry and compared to the Gen1 liquid biostimulant. HILIC is the chromatographic method for mostly polar hydrophilic compounds to separate them before analysis. For measuring the metabolomic compositions, the peak area percentage in both positive mode and negative mode were calculated. The phytohormone/secondary metabolite classes listed in Table 3 were discovered in Gen2-T113 liquid biostimulant composition. Additional results are shown in Tables 8a and 8b.

TABLE 8a
Positive mode metabolomic compounds.

| | | | Peak Area | |
|---|---|---|---|---|
| | Gen 2 - | | % Gen2 v | |
| Name | T113 | Gen 1 | Gen1 | Role in Plant Health |
| N-Acetylhistamine | 6.3E+08 | 1.8E+08 | 255.5% | Histamine derivative metabolite. Naturally found |
| | | | | in spinach and related plants and some insects. |
| | | | | Some bacteria also synthesize it. Can act as |
| | | | | auxins. |
| L-(+)-Valine | 2.7E+08 | 5.8E+07 | 371.9% | Amino acid and signal molecule |
| Tetramethyl-2,5-dihydro-1H- | 2.0E+08 | 1.6E+08 | 22.2% | May have a role in free radical chain reactions |
| pyrrole-3-carboxamide | | | | |
| 1-(4-Aminobutyl)urea | 1.8E+08 | 5.8E+07 | 207.5% | A putrescene derivative that can enhance plant |
| | | | | recovery from stress. |
| Isopelletierine | 1.3E+08 | 9.0E+07 | 45.3% | Alkaloid with protective properties |
| 1-(4-Aminobutyl)urea | 1.8E+08 | 5.8E+07 | 207.5% | A putrescene derivative that can enhance plant |
| | | | | recovery from stress. |
| Isopelletierine | 1.3E+08 | 9.0E+07 | 45.3% | Alkaloid with protective properties |
| 3-Amino-2-piperidinone | 1.2E+08 | 5.6E+07 | 107.4% | Alpha amino acid derivative found in bacteria |
| | | | | and other living organisms. |
| Acetophenone | 8.3E+07 | 4.4E+07 | 88.3% | It is the simplest aromatic ketone. Colorless, |
| | | | | viscous liquid is a precursor to useful resins and |
| | | | | fragrances. Signalin moleules |
| L-Alany1-L-proline | 3.4E+07 | 1.4E+07 | 144.4% | Dipeptide with signaling properties and involved |
| | | | | in anaplerotic reactions |
| ALA-PRO | 3.1E+07 | 3.0E+07 | 2.7% | Dipeptide with signaling properties and involved |
| | | | | in anaplerotic reactions |
| Pro-Pro | 3.0E+07 | 2.2E+07 | 38.0% | Dipeptide with signaling properties and involved |
| | | | | in anaplerotic reactions |
| Uric acid | 3.6E+06 | 9.3E+04 | 3712.0% | Source of N and is a heterocyclic compound. |
| | | | | Involved in antioxidant protection and for amino |
| | | | | acid synthesis. |
| Methylguanidine | 1.2E+08 | 1.7E+08 | −30.4% | Methylguanidine is a guanidine compound |
| | | | | deriving from protein catabolismputrefaction. |
| | | | | Methylguanidine has a role as a metabolite |
| 3-Hydroxy-2-methylpyridine | 9.9E+07 | 2.2E+08 | −54.4% | Vit B6 precursor |
| 8-Valerolactam | 8.9E+07 | 1.3E+08 | −33.4% | A lactam compound and an intermediate in |
| | | | | preparation of many bioplastics. Probably of |
| | | | | bacterial origin. |
| O-ureido-D-serine | 8.1E+07 | 1.2E+08 | −32.6% | D-Serine derivative and has a role in signaling. |
| Nicotinyl alcohol | 5.5E+07 | 5.8E+07 | −5.4% | could be an intermediate in microbial |
| | | | | metabolism. |
| (R,S)-Anatabine | 4.3E+07 | 6.8E+07 | −37.0% | Alkaloid with protective properties |
| DL-Carnitine | 4.2E+07 | 4.8E+07 | −13.5% | Carnitine is a quaternary ammonium compound |
| | | | | involved in metabolism in most mammals, |
| | | | | plants, and some bacteria |
| 10-Nitrolinoleate | 3.3E+07 | 1.0E+08 | −66.4% | A linoleic acid derivative and could be involved |
| | | | | in stress signaling. May be involved in nitric |
| | | | | oxide signaling. |
| N-Methylhexanamide | 2.3E+07 | 1.7E+08 | −86.8% | Hexanoamide is the most rapidly hydrolysed |
| | | | | substrate for amidase from Aspergillus nidulans |
| N6-METHYLLYSINE | 1.2E+07 | 4.8E+07 | −74.5% | Ethyl substituted L-Lysine. It is a natural product |
| | | | | from some unicellular eukaryotes from |
| | | | | Euglenozoa. |

TABLE 8b
Negative mode metabolomic compounds.

| | | | Peak | |
|---|---|---|---|---|
| | | | Area % | |
| | Gen 2 - | | Gen2 v | |
| Name | T113 | Gen 1 | Gen1 | Role in Plant Health |
| DEHYDROASCORBIC | 7.1E+07 | 4.4E+05 | 16102% | Oxidized from of vitamin C. Makes the oxidized |
| ACID | | | | form easier to transport through the membrane |
| | | | | into the ER. Antioxidant, antiviral and antifungal |
| | | | | properties too. Through interconversion to |
| | | | | ascorbic acid, it has a role in the photoprotection |
| | | | | of the photosynthetic apparatus in woody plants, |
| | | | | proper seed production and drought, salinity, |
| | | | | temperature, light stress, and biotic stress. May |
| | | | | have a tole in nutrition recycling due to leaf |
| | | | | senescence. The molecule is possibly involved in |
| | | | | P mobilization. |
| DL-Glutamic acid | 5.9E+07 | 3.2E+06 | 1721% | Alpha amino acid which also acts as a signaling |
| | | | | molecule. Glutamic acid acts as a biostimulant to |
| | | | | help modulate the composition of the microbiota |
| | | | | and also help nutrient uptake. Has also been |
| | | | | shown to suppress fungal mold diseases. |
| (+)-Malic Acid | 3.7E+07 | 1.2E+07 | 199% | Important signal elicitor and bacterial response |
| | | | | compound and phosphate mineralizer. |
| N-Acetyl-L-glutamic acid | 4.3E+07 | 4.3E+06 | 903% | amino acid derivative and signal elicitor |
| Ser-Ser | 4.6E+07 | 7.3E+05 | 6224% | amino acid derivative and signal elicitor |
| Moniliformin | 8.9E+06 | 9.8E+05 | 806% | Fusarium toxin lethal for poultry but can induce |
| | | | | plant immune response |
| Cinnamic acid | 2.12E+08 | 1.35E+06 | 15530% | Enhances heat tolerance of cucumber leaves; |
| | | | | modulates antioxidant enzyme activity |
| Citric Acid | 1.11E+07 | 9.20E+06 | 21% | Stimulates soil microbial activity; enhances crop |
| | | | | yield |
| Nicotinamide | 2.15E+06 | 2.66E+05 | 708% | Nicotinamide is a stress-associated compound. It |
| | | | | can induce and regulate secondary metabolic |
| | | | | accumulation and/or the manifestation of defense |
| | | | | metabolism in plants. (1) |
| Chrysin | 1.29E+08 | 1.34E+07 | 867% | Increased number of entry points and the degree |
| | | | | of colonization by arbuscular mycorrhizal fungi |
| | | | | (AMF) of tomato plants.(2) |
| Juvabione | 5.2E+06 | 1.3E+06 | 301.2% | Insect juvenile hormone analog that can |
| | | | | negatively impact insect reproduction |
| Orotic acid | 2.6E+06 | 5.5E+05 | 368.6% | mineral carrier |
| Resolvin D1 | 8.3E+05 | 2.6E+05 | 223.6% | Promotes cellular function and cellular |
| | | | | restoration |
| Diprogulic Acid | 8.2E+05 | 2.1E+05 | 298.6% | ascorbic acid precursor |
| (+)-Curacin A | 3.3E+05 | 2.3E+05 | 46.6% | Cytotoxic compound from Cyanobacterium |
| Putrescine | 6.11E+05 | 3.13E+05 | 95% | A polyamine, role in plant growth and |
| | | | | developmental process and environmental stress |
| | | | | responses. |
| (+)-Abscisic acid | 9.95E+06 | 3.19E+07 | −69% | Plant Hormone with negative responses |
| dihydroxyphenylalanine | 5.46E+06 | 1.44E+07 | −62% | amino acid derivative |
| anticapsin | 5.46E+06 | 1.44E+07 | −62% | antibiotic from B subtilis |
| prohydrojasmon | 5.46E+06 | 1.44E+07 | −62% | Jasmonic acid derivative |
| 2-methylcitric acid | 5.46E+06 | 1.44E+07 | −62% | Natural compound in some plants |
| 1,3-Nonanediol acetate | 5.46E+06 | 1.44E+07 | −62% | jasmonic acid like compound |
| 2-O-ETHYL ASCORBIC | 5.46E+06 | 1.44E+07 | −62% | Vitamin C |
| ACID | | | | |
| Leu-Leu | 5.46E+06 | 1.44E+07 | −62% | Diaminoacid with signaling properties |
| Vitamin C | 5.46E+06 | 1.44E+07 | −62% | amino acid signal elicitor |
| 3-sulfolactic acid | 5.46E+06 | 1.44E+07 | −62% | antioxidant and growth promoter |
| 4-nitrocatechol | 5.30E+05 | 8.37E+07 | −99% | Pest control |
| Itaconic acid | 4.25E+05 | 7.87E+07 | −99% | Fermentation product from aspergillus with |
| | | | | antibacterial properties |

As shown in Tables 8a and 8b above, the present process produces a liquid biostimulant composition with high concentrations of plant-beneficial metabolic compounds, including Ala-Pro and Pro-Pro dipeptides, carnitine, and putrescine. Moreover, the Gen2-T113 liquid biostimulant composition contains certain metabolic compounds that are upregulated as compared to the Gen1 liquid biostimulant composition. For instance, the Gen2-T113 liquid biostimulant composition exhibit a large fold increase in compounds such as dehydroascorbic acid, juvabione, cinnamic acid, and uric acid.

FIG. 3 depicts a PCA plot comparing the metabolic compounds present in Gen2-T113 liquid biostimulant composition as compared to the Gen1 liquid biostimulant composition. The PCA plot showed clusters of samples based on their similarity, and used the loading plot to identify which variables had the largest effect on each component. As one having ordinary skill in the art would appreciate, loadings can range from −1 to 1 with loadings close to −1 or 1 indicating a variable that strongly influences the component. Loadings close to 0 indicate that the variable has a weak influence on the component. As shown in FIG. 3, the PCA plot reveals significant differences between the metabolic composition of the Gen2-T113 liquid biostimulant composition as compared to the Gen2 liquid biostimulant composition. Moreover, heat map analysis of the Gen2-T112, Gen2-T135, and Gen2-T185 liquid biostimulant compositions highlight differences in metabolite concentrations over time (data not shown). As such, the method described above enables the production of liquid biostimulant products that can be optimized for particular applications depending on the desired levels of metabolic compounds.

### Example 4. Microbial Composition of the Liquid Biostimulant Composition

In addition to the chemical and metabolomic composition, the microbial content of the liquid biostimulant composition was measured. The Gen2 liquid biostimulant composition was produced according to Example 1 and compared to the Gen1 liquid biostimulant composition produced according to the method of WO 2020/028403 A1. The microbial content was measured by phospholipid fatty acid (PLFA) analysis (Ward Laboratories, Inc., Kearney, Nebraska). The results of the PLFA analysis of the Gen2 liquid biostimulant composition of the as compared to the Gen 1 liquid biostimulant are provided in Table 9a and Table 9b. The slurry centrate prior to ATAB was analyzed as a control.

TABLE 9a
PLFA analysis of the Gen2 liquid biostimulant
compared to the Gen 1 liquid biostimulant

| | Slurry Centrate | Gen 1 Liquid | Gen 2 Liquid |
|---|---|---|---|
| | (Control; pre-ATAB) | Biostimulant | Biostimulant |
| Total Biomass ng/g | 4521.75 | 5922.31 | 9760.07 |
| Bacteria % | 27.13 | 25.32 | 37.27 |
| Total Bacteria Biomass ng/g | 1226.87 | 1499.64 | 3637.91 |
| Actinomycetes % | 0 | 0 | 0 |
| Actinomycetes Biomass ng/g | 0 | 0 | 0 |
| Gram (−) % | 14.74 | 5.56 | 2.22 |
| Gram (−) Biomass ng/g | 666.43 | 329.35 | 217.03 |
| Rhizobia % | 0 | 0 | 0 |
| Rhizobia Biomass ng/g | 0 | 0 | 0 |
| Total Fungi % | 42.07 | 11.16 | 23.6 |
| Total Fungi Biomass ng/g | 1902.35 | 661.14 | 2303.55 |
| Arbusular Mycorrhizal % | 39.31 | 9.52 | 6.7 |
| Arbuscular Mycorrhizal | 1777.36 | 564.01 | 653.71 |
| Biomass ng/g | | | |
| Saprophytic % | 2.76 | 1.64 | 16.9 |
| Saprophytes Biomass ng/g | 124.99 | 97.13 | 1649.84 |
| Protozoan % | 0 | 0 | 0 |
| Protozoa Biomass ng/g | 0 | 0 | 0 |
| Gram (+) Biomass ng/g | 560.44 | 1170.29 | 3420.88 |
| Gram (+) % | 12.39 | 19.76 | 35.05 |
| Undifferentiated % | 30.8 | 63.51 | 39.12 |
| Undifferentiated Biomass ng/g | 1392.55 | 3761.54 | 3818.61 |
| Fungi:Bacteria | 1.5506 | 0.4409 | 0.6332 |
| Predator:Prey | ALL PREY | ALL PREY | ALL PREY |
| Gram(+):Gram(−) | 0.841 | 3.5533 | 15.7622 |
| Sat:Unsat | 2.4815 | 15.0334 | 4.0588 |
| Mono:Poly | 6.1497 | ALL MONO | ALL MONO |
| Pre 16:1w7c:cy17:0 | NONE FOUND | ALL PRE 16:1 | ALL PRE 16:1 |
| Pre 18:1w7c:cy 19:0 | ALL PRE 18:1 | NONE FOUND | NONE FOUND |

TABLE 9b
Biomass analysis of the Gen2 liquid biostimulant compared to the Gen 1 liquid biostimulant

| | | Total | | | | Total | |
|---|---|---|---|---|---|---|---|
| | Total | Bacteria | Gram (−) | Gram (−) | Total | Fungi | Gram (+) |
| | Biomass | Biomass | % | Biomass | Fungi % | Biomass | Biomass |
| Control | 4521.75 | 1226.87 | 14.74 | 666.43 | 42.07 | 1902.35 | 560.44 |
| Gen 1 Liquid | 5922.31 | 1499.64 | 5.56 | 329.35 | 11.16 | 661.14 | 1170.29 |
| Biostimulant | | | | | | | |
| Gen 2 Liquid | 9760.07 | 3637.91 | 2.22 | 217.03 | 23.6 | 2303.55 | 3420.88 |
| Biostimulant | | | | | | | |

Percentages calculated by Total Living Microbial Biomass, Phospholipid Fatty Acid (PLFA) ng/g values.
Diversity Index is a measure of the biomass diversity.

Microbes in the soil are directly tied to nutrient recycling, especially carbon, nitrogen, phosphorus and sulfur. Bacteria are a major class of microorganisms that keep soils healthy and productive. Bacteria perform many important ecosystem services in the soil, including improved soil structure and soil aggregation, recycling of soil nutrients, and water recycling. Soil bacteria form microaggregates in the soil by binding soil particles together with their secretions. These microaggregates are akin to building blocks for improving soil structure. In turn, improved soil structure increases water infiltration and increases water holding capacity of the soil (Ingham, 2009).

Many soil bacteria process nitrogen in organic substrates, but only nitrogen fixing bacteria can process the nitrogen in the atmosphere into a form (fixed nitrogen) that plants can use. Nitrogen fixation occurs because these specific bacteria produce the nitrogenase enzyme. Nitrogen fixing bacteria are generally widely available in most soil types (both free living soil species and bacteria species dependent on a plant host). Free living species generally only comprise a very small percentage of the total microbial population and are often bacteria strains with low nitrogen fixing ability (Dick, W., 2009). Many bacteria produce a layer of polysaccharides or glycoproteins that coats the surface of soil particles. These substances play an important role in cementing sand, silt and clay soil particles into stable microaggregates that improve soil structure. Bacteria live around the edges of soil mineral particles, especially clay and associated organic residues. Bacteria are important in producing polysaccharides that cement sand, silt and clay particles together to form microaggregates and improve soil structure (Hoorman, 2011).

As shown in Tables 9a and 9b, the Gen2 liquid biostimulant composition of the present invention has a 192% increase in Gram positive bacteria as compared to the Gen 1 liquid biostimulant composition. As noted above, Gram-positive bacteria are important in such activities as bioremediation, biocontrol, plant growth, symbiotic-mutualistic, commensalistic, trophobiotic interactions, control of soil-borne pathogens, and support of host plant defense against environmental stress (Ryan et al., 2008). Additionally, the Gen2 liquid biostimulant composition shows a 143% increase in total bacteria biomass over Gen 1 liquid biostimulant composition, and a 34% reduction in Gram negative microbes as compared to the Gen 1 liquid biostimulant composition. Gram negative bacteria are generally the smallest bacteria and are sensitive to drought and water stress. The enhanced production method of Gen2 liquid biostimulant composition culls these smaller more irritable and sensitive microbes.

In addition to certain bacterial biomass, fungi have an important role in plant and soil health. Fungi are microscopic cells that usually grow as long threads or strands called hyphae, which push their way between soil particles, roots, and rocks. Hyphae are usually only several thousandths of an inch (a few micrometers) in diameter. A single hyphae can span in length from a few cells to many yards. A few fungi, such as yeast, are single cells. Fungi perform important services related to water dynamics, nutrient cycling, and disease suppression. Along with bacteria, fungi are important as decomposers in the soil food web. They convert hard-to-digest organic material into forms that other organisms can use. Fungal hyphae physically bind soil particles together, creating stable aggregates that help increase water infiltration and soil water holding capacity.

Decomposers—saprophytic fungi—convert dead organic material into fungal biomass, carbon dioxide (CO₂), and small molecules, such as organic acids. These fungi generally use complex substrates, such as the cellulose and lignin, in wood, and are essential in decomposing the carbon ring structures in some pollutants.

Like bacteria, fungi are important for immobilizing, or retaining, nutrients in the soil. In addition, many of the secondary metabolites of fungi are organic acids, so they help increase the accumulation of humic-acid rich organic matter that is resistant to degradation and may stay in the soil for hundreds of years.

Mutualists—the mycorrhizal fungi—colonize plant roots. In exchange for carbon from the plant, mycorrhizal fungi help solubilize phosphorus and bring soil nutrients (phosphorus, nitrogen, micronutrients, and perhaps water) to the plant. One major group of mycorrhizae, the ectomycorrhizae grow on the surface layers of the roots and are commonly associated with trees. The second major group of mycorrhizae are the endomycorrhizae that grow within the root cells and are commonly associated with grasses, row crops, vegetables, and shrubs. Arbuscular mycorrhizal (AM) fungi are a type of endomycorrhizal fungi.

As shown in Tables 9a and 9b, the Gen2 liquid biostimulant composition displays an increase of 248% of total fungi biomass with an increase of 1599% saprophytles fungi over the Gen1 liquid biostimulant composition. Furthermore, there is an increase of 16% arbuscular mycorrhizal biomass in the Gen2 liquid biostimulant product over the Gen1 liquid biostimulant composition.

Therefore, the Gen2 liquid biostimulant composition produced by the instant method exhibits increased beneficial microbial biomass as compared to other liquid biostimulant products existing in the art. This was a surprising result given the assumption that subjecting an emulsified animal waste slurry to ATAB prior to separation would decrease decomposition efficiency. Thus, not only does the present method enable the production of a solid biofertilizer produced from subjecting animal waste to ATAB, but it further produces a superior liquid biostimulant composition.

Microbial analysis was also carried out on the Gen2-T113, Gen2-T135, and Gen2-T185 liquid biostimulant compositions as compared to the Gen1 liquid biostimulant composition. First, total DNA was used as a measure for total biomass according to standard genomics techniques. The results are summarized in FIG. 3, which reveals an increase of about 12% of total DNA in the Gen2-T113 liquid biostimulant composition as compared to the Gen1 liquid composition. This increase in biomass was unexpected, and the application of such liquid biostimulant compositions imparts soil resiliency on multiple levels.

The Gen2-T113 liquid biostimulant composition and the Gen1 liquid biostimulant composition were then assessed for the identification of particular plant-beneficial bacterial families and phyla. Bacterial families were measured based on OTUs from metagenomic data in combination with amplification using primers specific for Clostridium, Bacillus, Rhizobium, Azobacter, and Azospirillium bacterial families. Similarly, bacterial phyla beneficial to soil and plants were quantified. Table 10 is a summary of the known soil and plant beneficial bacterial genera detected in the Gen1, Gen2-T113, Gen2-T135, and Gen2-T185 liquid biostimulant compositions. Tables 11a and 11b quantify bacterial families and phyla as percent total biomass and compares the Gen2-T113 and Gen1 liquid biostimulant compositions.

TABLE 10
Bacteria detected in the liquid biostimulant compositions by genus.

Bacillus
Geobacillus
Streptomyces
Azobacter
Clostridium
Actinomyces
Azosprillum
Psuedomonas

TABLE 11a
Bacteria families detected in the Gen1
versus Gen2-T113 liquid compositions.

| Families | Raw | Gen 2 -T113 | Generation 1 |
|---|---|---|---|
| Bacillus | 41.74 | 44.99 | 33.76 |
| Clostridium | 34.66 | 41.73 | 59.55 |
| Thermoanaerobacter | 7.85 | 7.20 | 2.92 |
| Pseudomonas | 2.50 | 0.30 | 0.41 |
| Acidobacterium | 1.16 | 0.19 | 0.20 |
| Actinomyces | 7.87 | 4.18 | 2.13 |
| Enterobacteriaceae | 4.23 | 1.41 | 1.03 |

TABLE 11b
Bacteria phyla detected in the Gen1
versus Gen2-T113 liquid compositions.

| Phyla | Raw | Gen 2 - T113 | Generation 1 |
|---|---|---|---|
| Actinomycetota | 6.8% | 6.4% | 2.9% |
| Bacteroidetes | 2.4% | 1.8% | 0.0% |
| Firmiicutes | 50.6% | 62.2% | 92.1% |
| Proteobacteria | 20.9% | 18.2% | 1.3% |
| Gammaproteobacteria | 4.4% | 3.6% | 1.3% |
| Thermotogae | 7.5% | 2.7% | 0.3% |
| Spirochaetes | 2.7% | 1.3% | 0.0% |
| Verrucomicrobia | 2.2% | 0.9% | 0.0% |
| Deinococcus | 0.2% | 0.0% | 0.0% |
| Others | 2.3% | 2.8% | 2.1% |

As shown in the above tables, the Gen2-T113 liquid biostimulant composition contained different concentrations of soil and plant beneficial bacteria as compared to the Gen1 liquid biostimulant composition highlighting the advantages of subjecting the animal waste slurry to ATAB prior to separation. The different bacterium were detected using the Albacore metagenomics platform after processing the samples via the NanoPore Tech platform.

Real time bacterial species identification was carried out by extracting DNA using commercially available DNA soil DNA extraction kits followed by quantification and analysis using NCBI and EMBL datasets. The bacterial species detected in the Gen1 liquid biostimulant composition was compared to the Gen2-T113 and Gen2-T185 liquid biostimulant compositions. A subset of the data is summarized in Table 12.

TABLE 12
Bacterial Species detected in the Gen1 versus Gen2-T113 and Gen2-T185 liquid compositions.

| Gen 1-specific | Gen2-Specific | Gen2-T113 specific | Gen2-T185 |
|---|---|---|---|
| Bacillus altitudinis | Bacillus butanolivorans | Bacillus polymyxa | Azotobacter chroococcum |
| Bacillus asahii | Bacillus cellulosilyticus | Bacillus ligininiphilus | Bacillus cereus CIL |
| Bacillus Cytotoxicus | Bacilus coagulans | Bacillus mycoides | Geobacillus kaustophius |
| Bacillus sp 275 | Bacillus foraminis | | Streptomyces aegyptia |
| Bacillus horikoshi | Bacillus thuringiensis | | |
| Bacillus paralicheniformis | Bacillus polymyxa | | |
| Geobacillus genomo sp 3 | Bacillus sp Pc3 | | |
| Clostridium baratii | Bacillus cereus CIL | | |
| Clostridium estertheticum | Bacillus ligininiphilus | | |
| subsp. estertheticum | | | |
| Clostridium septicum | Bacillus aryabhattai | | |
| | Bacillus glycinifermentans | | |
| | Bacillus mycoides | | |
| | Geobacillus kaustophius | | |
| | Clostridium novyi NT | | |
| | Clostridium tyrobutyricum | | |
| | Clostridium indolis | | |
| | Clostridium sticklandii | | |
| | Actinomyces howellii | | |
| | Actinomyces gaoshouyii | | |
| | Azospirillum thiophilum | | |
| | Azospirillum brasilense | | |
| | Azotobacter chroococcum | | |
| | Streptomyces adustus | | |
| | Streptomyces aegyptia | | |
| | Streptomyces amphotericinicus | | |

As shown in Table 12, the Gen2 production process generated liquid biostimulant compositions with a unique subpopulation of soil and plant beneficial bacteria as compared to previous processes (compared Gen1 versus Gen2 specific bacterial species columns above). While only a subset of data is shown, it illustrates the novel and innovative properties of the present compositions. Further, by subjecting the animal waste slurry to varying ATAB incubation times, the Gen2-T185 liquid biostimulant composition contained certain bacterial species that were unique to that composition. Likewise, the Gen2-T113 liquid biostimulant composition contained bacterial species not found in either the Gen1 or the Gen2-T185 liquid biostimulant compositions.

### Example 5. Application of the Liquid Biostimulant Compositions to Plants and Soil

Treatment of Soil with the Liquid Biostimulant Enhances the Microbiome

In order to assess the benefits imparted to soil by the liquid biostimulant, the Gen2-T113 liquid biostimulant composition was applied by backpack sprayer to soil plots in an open farmland in Platte County, Missouri, United States. Briefly, plots were treated with the Gen2-T113 liquid biostimulant composition, water, no treatment (“control”), or a 1M glucose solution (“Glu1M”) at a rate of 1, 3, 5, 7, or 10 gallons per acre. The soil plots were then assessed for bacterial growth as a measure of the soil microbiome.

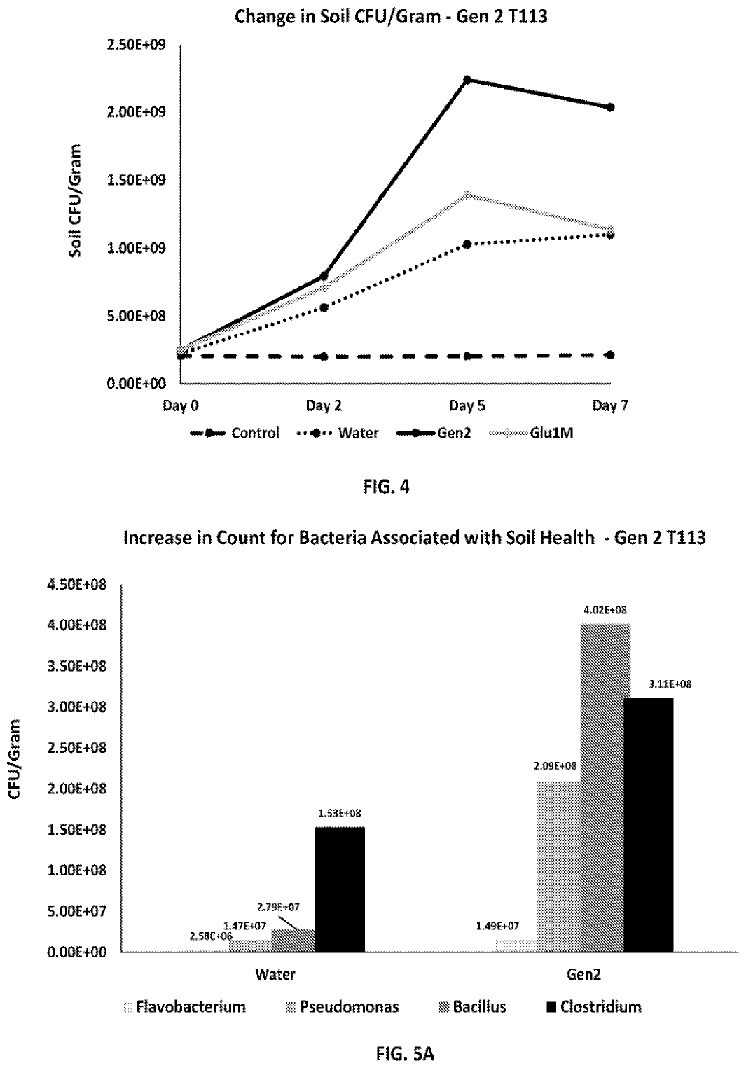

Soil samples at day 0, 2, 5, and 7 were collected using soil probes per standard techniques. Each soil sample is a collection from 10 different locations within each experimental plot. The samples were mixed, and a smaller sample was collected aseptically for further analysis. Serial dilutions were carried out, and then 1 gram of each soil sample was added to 10 ml of TMY medium in a 50 ml ventilated reaction tube with a 0.22 micron filter cap. Next, 100 ml of each sample was transferred onto TMY agar plates and incubated at 29 degrees C. The sample tubes with the remaining sample were shaken in an orbital shaker for 48 hours at 29 degrees C. Bacterial CFU was calculated based on growth in tubes and assessing the plate for the corresponding tube with highest dilution that showed growth. As shown in FIG. 4, the Gen2-T113 liquid biostimulant significantly increased the total bacterial growth as compared to even the Glu1M positive control.

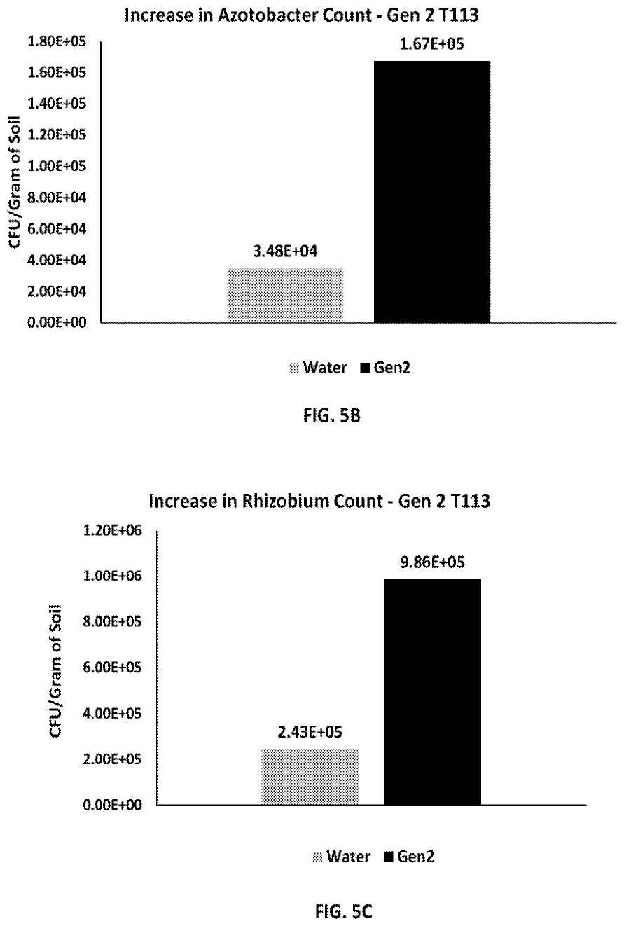

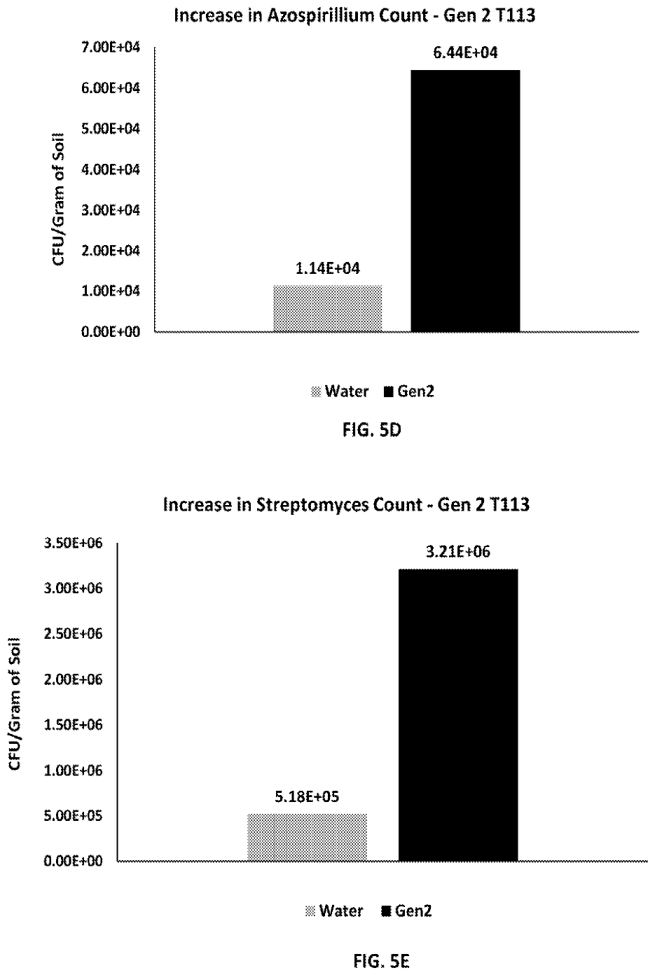

In addition, different microbial genera in the soil samples were identified using a combination of metagenomics data and nested PCR amplification. As shown in FIGS. 5A-5E, the Gen2-T113 liquid biostimulant composition significantly enhanced the growth of several plant and soil-beneficial bacterial genera, including Flavobacterium, Pseudomonas, Bacillus, Clostridium, Rhizobium, Streptomyces, Azotobacter, and Azospirillium. Table 13 is a summary of the increase in growth of these bacterial genera.

TABLE 13
Gen2 liquid biostimulant composition impact on soil bacteria

| Bacteria (Family) | Gen 2 T113 % increase vs water |
|---|---|
| Flavobacterium | 476% |
| Pseudomonas | 1322% |
| Bacillus | 1339% |
| Clostridium | 103% |
| Rhizobium | 306% |
| Streptomyces | 520% |
| Azotobacter | 227% |
| Azospirillium | 621% |

For instance, application of the Gen2 liquid biostimulant composition to soil increased the soil population of Azotobacter by well over 200%. This bacterial genera includes the best-known nitrogen-fixing bacteria and has been used by famers for over 100 years. Therefore, the Gen2 liquid biostimulant composition can provide to soil the equivalent of 11-12 pounds of nitrogen per acre of soil. Other bacterial genera that were significantly increased in the soil due to the application of the Gen2 liquid biostimulant composition include Rhizobium (over 300% increase), which colonize the root sells of plants to form nodules where they convert atmospheric nitrogen into ammonia, which is the most critical phase of nitrogen cycling in most plants. Rhizobium also improve nutrient cycling and plant nutrient acquisition, and reduce stress impact. Azospirillium (over 620% increase) are known for their nitrogen fixing properties and impact on plant growth, and have a particularly important, positive impact on corn and wheat crops. Further, this genus improves plant resiliency to abiotic stress and soil water retention capacity. Indeed, the application of the instant compositions to soil significantly improves the soil microbiome to surprising levels.

Treatment of Soil with the Liquid Biostimulant Composition Increases Acid Phosphatase Activity

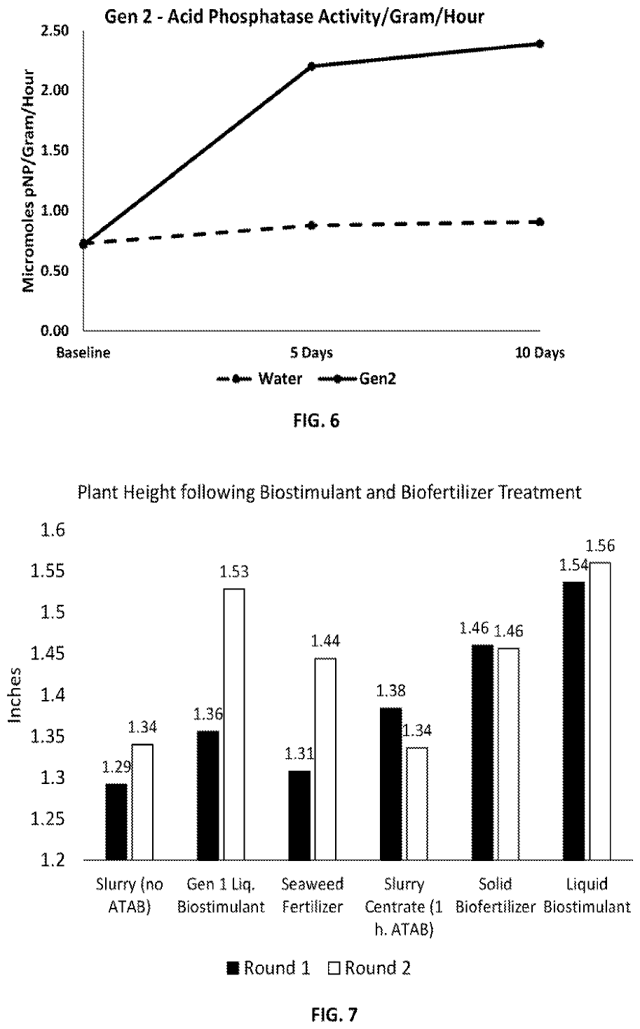

Acid phosphatase activity in soil was also tested on the above soil samples. The active acid phosphatase enzyme was measured on a para nitrophenol phosphate (pNPP) chromogenic substrate. In the presence of acid phosphatase, the colorless pNPP is converted to para-nitrophenol (pNP), which turns bright yellow. The amount of pNP produced was then measured using a spectrophotometer (435 nm to 440 nm), and the amount of enzyme activity was calculated by creating standards. Activity at 0 days, 5 days, and 10 days were measured. Shown in FIG. 6 is a comparison between water and the Gen2-T113 liquid biostimulant composition (application rate 5 gallons per acre) at 0, 5, and 10 days following application. The application of Gen2-T113 liquid biostimulant composition significantly increased the available pNP in the soil samples thereby indicating an increase in acid phosphatase activity. Phosphatases and phytases are enzymes that release phosphorus from bound phosphates in soil, which is then available for further enhancing the soil microbiome. As such, the present compositions improve soil conditions for plant growth and health.

Treatment of Radish Plants with Gen2 Liquid Biostimulant and Solid Biofertilizer Compositions Increases Plant Height

The ability of the liquid biostimulant and solid biofertilizer compositions of the present invention to enhance plant growth was compared to the Gen 1 liquid biostimulant composition (prepared according to WO 2020/028403 A1) and a seaweed fertilizer. Briefly, sifted typical farm soil was added to each of six sets of twenty-five 10 mL sterile centrifuge tubes and planted with one radish seed at a depth of 0.25 inches (150 total tubes). The tubes were placed on heating mats at about 20° C. with 8 hours light and 16 hours of darkness. For each of the six sets of tubes (n=25 each), the following compositions were prepared:

| | |
|---|---|
| 1 | Slurry (no ATAB) |
| 2 | Gen 1 Biostim ~90 hrs ATAB |
| 3 | Commercial Seaweed Fertilizer |
| 4 | Slurry ~1 hr ATAB |
| 5 | Gen 2 Solid Biofertilizer ~90 hrs ATAB |
| 6 | Gen 2 Liquid Biostimulant ~90 hrs ATAB |

For each study group, a 3 mL of solution (diluted 14:1) was applied immediately at planting. The height of each radish plant was measured at 4 days post-emergence with a micrometer. The entire experimental procedure was then repeated to give data for two rounds. The data for each round was recorded and statistically analyzed by two-tailed student t-test and analysis of variance (ANOVA). The data for rounds 1 and 2 are summarized in FIG. 7.

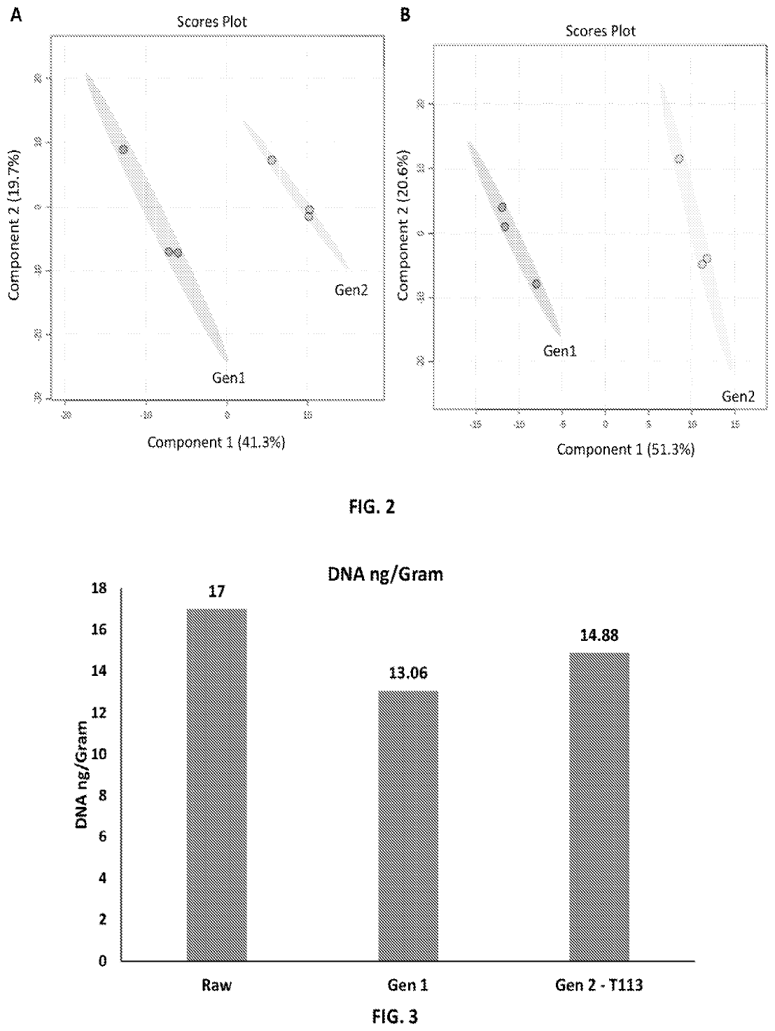

The first round showed a statistically-significant increase in plant height following four days of treatment for both the liquid biostimulant and solid biofertilizer compositions as compared to either the Gen 1 liquid biostimulant composition and the seaweed fertilizer (see FIG. 2, black bars). Data was analyzed with a pairwise comparison with p value less than 0.01. The Tukey's honestly significant difference test (Tukey's HSD) was used to test differences among sample means for significance. In the ANOVA test, the variable of interest after calculations have been run was F, which is the found variation of the averages of all of the pairs, or groups, divided by the expected variation of these averages. While round 2 revealed an increase in plant height for the liquid biostimulant-treated plants as compared to the Gen 1 liquid biostimulant, the results did not reach statistical significance. This was likely due to the short duration of the experiment (i.e., only 4 days growth). A longer timeline or an analysis of root health and/or plant vigor over time will likely reveal an improvement in plants treated with the liquid biostimulant or solid biofertilizer compositions as compared to plants treated with the Gen 1 product or the seaweed product.

The results demonstrate that the bionutritional compositions of the instant invention improve plant health as compared to existing bionutritional and organic fertilizer compositions. Therefore, the liquid biostimulant and solid biofertilizer compositions described herein are biologically-derived products that can provide superior plant nutrition, biostimulation, soil conditioning, and improve soil biodiversity while at the same time being safe, easy to use and cost-effective.

The present invention is not limited to the embodiments described and exemplified herein. It is capable of variation and modification within the scope of the appended claims.

1. A composition for application to plants and soils, comprising an autothermal thermophilic aerobic bioreaction product from a solid or liquid fraction of poultry manure, wherein the composition endogenously comprises at least one plant growth-promoting microorganism and a total microbial biomass comprising at least about 20% Gram positive bacteria.

2. The composition of claim 1, comprising a ratio of Gram positive to Gram negative bacteria of about 10:1.

3. The composition of claim 1, wherein the total microbial biomass additionally comprises at least about 20% fungi.

4. The composition of claim 3, wherein the total microbial biomass comprises at least about 20% fungi and at least about 30% gram positive bacteria.

5. The composition of claim 3, wherein the total microbial biomass comprises at least about 10% saprophytic fungi.

6. The composition of claim 1, wherein the composition is a liquid biostimulant composition, endogenously comprising:
(i) at least about 12% dry wt Total Kjeldahl nitrogen and at least about 2% by wt carbon; or
(ii) at least about 4% dry wt organic nitrogen and at least about 10% dry wt potash; or
(iii) less than about 5% dry wt P₂O₅; or
(iv) any combination of (i), (ii), and (iii).

7-9. (canceled)

10. The composition of claim 1, wherein the composition is a solid biofertilizer composition, endogenously comprising:
(i) at least about 7% dry wt Total Kjeldahl nitrogen and at least about 2% by wt carbon; or
(ii) at least about 2% dry wt organic nitrogen and at least about 3% dry wt potash;
(iii) less than about 8% dry wt P₂O₅; or
(iv) any combination of (i), (ii), and (iii).

11-13. (canceled)

14. The composition of claim 1, wherein the at least one plant growth-promoting microorganism is selected from the group consisting of Actinomycetota, Bacteroidetes, Firmiicutes, Proteobacteria, Gammaproteobacteria, Thermotogae, Spirochaetes, Verrucomicrobia, Deinococcus, and any combination thereof.

15. The composition of claim 14, wherein the at least one plant growth-promoting microorganism is selected from the group consisting of:
Actinomycetota bacteria in a concentration of at least about 1% by wt;
Bacteriodetes bacteria in a concentration of at least about 0.5% by wt;
Firmiicutes bacteria in a concentration of at least about 30% by wt;
Proteobacteria bacteria in a concentration of at least about 1% by wt;
Gammaproteobacteria bacteria in a concentration of at least about 1% by wt;
Thermotogae bacteria in a concentration of at least about 0.5% by wt;
Spirochaetes bacteria in a concentration of at least about 0.25% by wt;
Verrucomicrobia bacteria in a concentration of at least about 0.25%; and
any combination thereof.

16. The composition of claim 1, wherein the at least one plant growth-promoting microorganism is selected from the group consisting of Bacillus, Clostridium, Thermoanaerobacter, Pseudomonas, Acidobacterium, Actinomyces, Enterobacteriaceae, and any combination thereof.

17. The composition of claim 16, wherein the at least one plant growth-promoting microorganism is selected from the group consisting of:
Bacillus bacteria in a concentration of at least about 25% by wt;
Clostridium bacteria in a concentration of at least about 25% by wt;
Thermoanaerobacter bacteria in a concentration of at least about 1% by wt;
Pseudomonas bacteria in a concentration of at least about 0.1% by wt;
Acidobacterium bacteria in a concentration of at least about 0.05% by wt;
Actinomyces bacteria in a concentration of at least about 1% by wt;
Enterobacteriaceae bacteria in a concentration of at least about 0.5% by wt; and
any combination thereof.

18. The composition of claim 1, wherein the at least one plant growth-promoting microorganism is selected from the group consisting of Bacillus butanolivorans, Bacillus cellulosilyticus, Bacilus coagulans, Bacillus foraminis, Bacillus thuringiensis, Bacillus polymyxa, Bacillus sp Pc3, Bacillus cereus C1L, Bacillus ligininiphilus, Bacillus aryabhattai, Bacillus glycinifermentans, Bacillus mycoides, Geobacillus kaustophius, Clostridium novyi NT, Clostridium tyrobutyricum, Clostridium indolis, Clostridium sticklandii, Actinomyces howellii, Actinomyces gaoshouyii, Azospirillum thiophilum, Azospirillum brasilense, Azotobacter chroococcum, Streptomyces adustus, Streptomyces aegyptia, and/or Streptomyces amphotericinicus, and any combination thereof.

19. The composition of claim 1, further comprising one or more compounds selected from the group consisting of N-acetylhistamine, L-Valine, tetramethyl-2,5-dihydro-1H-pyrrole-3-carboxamide, 1-(4-aminobutyl) urea, isopelletierine, 1-(4-aminobutyl) urea, 3-amino-2-piperidinone, acetophenone, L-alanyl-L-proline, Alanine-Proline dipeptide, Proline-Proline dipeptide, uric acid, methylguanidine, 3-hydroxy-2-methylpyridine, δ-valerolactam, O-ureido-D-serine, nicotinyl alcohol, (R,S)-anatabine, carnitine, 10-nitrolinoleate, N-methylhexanamide, N6-methyl lysine, dehydroascorbic acid, glutamic acid, malic acid, N-acetyl-L-glutamic acid, Serine-Serine dipeptide, moniliformin, cinnamic acid, citric acid, nicotinamide, chrysin, juvabione, orotic acid, resolvin D1, diprogulic acid, curacin A, putrescine, abscisic acid, dihydroxyphenylalanine, anticapsin, prohydrojasmon, 2-methylcitric acid, 1,3-nonanediol acetate, 2-O-ethyl ascorbic acid, Leucine-Leucine dipeptide, vitamin C, 3-sulfolactic acid, 4-nitrocatechol, itaconic acid, and any combination thereof, wherein the compound is present in the composition at a peak area of at least about 1×10³ as measured by hydrophilic interaction liquid chromatography followed by mass spectroscopy.

20. (canceled)

21. A composition for application to plants and soils, comprising an autothermal thermophilic aerobic bioreaction product from a solid or liquid fraction of poultry manure, wherein the composition endogenously comprises at least one plant growth-promoting microorganism selected from the group consisting of Bacillus butanolivorans, Bacillus cellulosilyticus, Bacilus coagulans, Bacillus foraminis, Bacillus thuringiensis, Bacillus polymyxa, Bacillus sp Pc3, Bacillus cereus C1L, Bacillus ligininiphilus, Bacillus aryabhattai, Bacillus glycinifermentans, Bacillus mycoides, Geobacillus kaustophius, Clostridium novyi NT, Clostridium tyrobutyricum, Clostridium indolis, Clostridium sticklandii, Actinomyces howellii, Actinomyces gaoshouyii, Azospirillum thiophilum, Azospirillum brasilense, Azotobacter chroococcum, Streptomyces adustus, Streptomyces aegyptia, and/or Streptomyces amphotericinicus, and any combination thereof, and wherein the total microbial biomass additionally comprises:
(i) at least about 20% fungi; or
(ii) at least about 30% gram positive bacteria; or
(iii) at least about 10% saprophytic fungi; or
(iv) any combination of (i), (ii), or (iii).

22. The composition of claim 21, further comprising one or more compounds selected from the group consisting of N-acetylhistamine, L-Valine, tetramethyl-2,5-dihydro-1H-pyrrole-3-carboxamide, 1-(4-aminobutyl) urea, isopelletierine, 1-(4-aminobutyl) urea, 3-amino-2-piperidinone, acetophenone, L-alanyl-L-proline, Alanine-Proline dipeptide, Proline-Proline dipeptide, uric acid, methylguanidine, 3-hydroxy-2-methylpyridine, δ-valerolactam, O-ureido-D-serine, nicotinyl alcohol, (R,S)-anatabine, carnitine, 10-nitrolinoleate, N-methylhexanamide, N6-methyl lysine, dehydroascorbic acid, glutamic acid, malic acid, N-acetyl-L-glutamic acid, Serine-Serine dipeptide, moniliformin, cinnamic acid, citric acid, nicotinamide, chrysin, juvabione, orotic acid, resolvin D1, diprogulic acid, curacin A, putrescine, abscisic acid, dihydroxyphenylalanine, anticapsin, prohydrojasmon, 2-methylcitric acid, 1,3-nonanediol acetate, 2-O-ethyl ascorbic acid, Leucine-Leucine dipeptide, vitamin C, 3-sulfolactic acid, 4-nitrocatechol, itaconic acid, and any combination thereof.

23. The composition of claim 22, wherein the compound is present in the composition at a peak area of at least about 1×10³ as measured by hydrophilic interaction liquid chromatography followed by mass spectroscopy.

24. The composition of claim 1, comprising a ratio of Gram positive to Gram negative bacteria of about 10:1.

25-27. (canceled)

28. The composition of claim 1, wherein the composition is a liquid biostimulant composition.

29. A method of improving health or productivity of a selected plant or crop, comprising:
a) selecting a plant or crop for which improved health or productivity is sought;
b) treating the plant or crop with the composition of claim 1;
c) measuring at least one parameter of health or productivity in the treated plant or crop; and
d) comparing the at least one measured parameter of health or productivity in the treated plant or crop with an equivalent measurement in an equivalent plant or crop not treated with the composition;
wherein an improvement in the at least one measured parameter in the treated, as compared to the untreated, plant or crop is indicative of improving the health or productivity of the selected plant or crop.

30. The method of claim 29, wherein the at least one parameter of health or productivity in the plant or crop is selected from germination rate, germination percentage, robustness of germination, root biomass, root structure, root development, total biomass, stem size, plant height, leaf size, flower size, crop yield, structural strength/integrity, photosynthetic capacity, time to crop maturity, yield quality, resistance or tolerance to stress, resistance or tolerance to pests or pathogens, and any combination thereof.

31-33. (canceled)
